(19) United States
(12) Patent Application Publication
(10) Pub. No.: US 2002/0046072 A1
(43) Pub. Date: Apr. 18, 2002

(54) WORKFLOW SYSTEM

(76) Inventors: TOSHIKATSU ARAI, TOKYO (JP); NARUYA TAKASAKI, TOKYO (JP); MANABU SATO, KITAKYUSHU-CITY (JP); MASANAO YUFU, KITAKYUSHU-CITY (JP); ICHIROU KODAMA, KITAKYUSHU-CITY (JP)

Correspondence Address: RABIN & CHAMPAGNE, PC, 1101 14TH STREET, NW, SUITE 500, WASHINGTON, DC, 20005, US

(21) Appl. No.: 08/876,486

(22) Filed: Jun. 16, 1997

(30) Foreign Application Priority Data
Jun. 18, 1996 (JP) 156602
Aug. 13, 1996 (JP) 212925
Oct. 17, 1996 (JP) 275085
Oct. 17, 1996 (JP) 275086
Oct. 18, 1996 (JP) 276581
Oct. 21, 1996 (JP) 278369
Oct. 22, 1996 (JP) 279716
Oct. 22, 1996 (JP) 279717

(51) Int. Cl. G06F 17/60

(52) U.S. Cl. 705/8; 702/182

(57) ABSTRACT

A workflow system includes a sub-workflow define means for defining a sub-workflow which determines a work flow within a section and a sub-workflow interface part disposed at every section, the sub-workflow interface part having a definition of a correspondence of sub-workflow used according to said data. Data is transferred via the sub-workflow interface part disposed at the section units. When the sub-workflow interface part receives data, a sub-workflow corresponding to the received data is activated so that a route can be defined at every section, thereby making it easy to define a route. Therefore, when a change occurs in a section or a route is changed in somewhere of the section, the route may be defined again within that section, and the route can be changed easily. Also, data sequentially flows among the respective sections via the sub-workflow interface part so that a continuity of a work processing among the sections can be maintained.

### FIELD OF THE INVENTION

The present invention relates to a workflow system and a workflow processing method in which a plurality of system users in a plurality of sections in a company, for example, can execute a work by transferring data among them in a predetermined order by using computer terminals.

### DESCRIPTION OF THE RELATED ART

Heretofore, there is a workflow system in which when documents, drawings, various data have to be reliably circulated or processed to a number of system users in an organization such as a company, paper documents and the like are not directly transferred between the system users but system users create electronic data by word processors and the electronic data thus created are transferred among the system users via a computer network, thereby to carry out a predetermined work processing. In such workflow system, when a document is sent to a plurality of system users, the system users to which the document is to be sent and the order in which the document is sent to the system users are determined previously according to the contents of matters to be processed and data is transferred in accordance with the order thus determined. When the system users finish their work, the workflow system automatically judges the later interchange of data and executes the same. For example, when a system user finishes his work, the workflow system automatically determines the next system user who must receive the work finished and process it. Thus, a work can be connected to the next work automatically, and hence it is possible to remove a useless time which is required to transfer documents and to take over a work. Moreover, this workflow system has a function to manage a progress of work so that a progress of a work processing can be managed at every matter.

A first problem will be described below. In the system according to the related art, when a plurality of system users in a plurality of sections execute a work processing, the orders in which data are transferred in respective sections have to be connected such that one order in which data are transferred has to be defined in advance in order to keep a continuity of work processing among respective sections. For example, if the number of routes in which data are sent in respective sections are n₁, n₂, n₃, . . . , then there are n₁×n₂×n₃× . . . routes. Therefore, many patterns of orders for transferring data must be created, which requires a lot of time and labor. In addition, when a route in a certain section is varied, the whole route must be defined again. Furthermore, when a route in somewhere of the section is changed, the content defined with respect to the whole route has to be varied. Even though such change of the route in a certain section is trivial, a work for changing the route is not so easy.

A second problem will be described below. In the system according to the prior art, when a workflow is defined, it is necessary to consider not only a fundamental workflow which defines a route in which data is normally transferred among respective system users but also all sort of patterns. For example, it is customary that when an approval of a certain system user is not obtained, data is returned to a person who transmitted the data. However, if a particular system user does not approve the data, then data is returned to other system user than the system user who transmitted the data. Further, when a work processing is stopped in somewhere of the processing, data is returned to a predetermined system user. Furthermore, after a certain system user finishes processing data, the data will be transferred to a plurality of system users. Since the workflow must contain in advance all sorts of patterns, there are a large number of routes for transferring data among system users in the designated sequential orders. There is then presented the problem that a work for making a workflow requires plenty of time and labor.

Moreover, in the system according to the related art, since data is automatically transferred among the system users, it is impossible for each system user to change the next system user to which data is transferred during data is being transferred. However, in actual practice, it is frequently observed that, depending on the contents of the matter processed by each system user, data is transferred to other system user than the system user determined by the workflow or data is transferred to other system user in addition to the next system user. Therefore, there is an increasing demand of realizing a workflow system in which a system user can select the next system user each time the system user executes the processing.

A third problem will be described below. In the system according to the related art, when there occurs a new matter needing processing, a system user has to create a document concerning such new matter and a title of the new matter. When the title is determined, a workflow corresponding to the title is accessed, and data will be automatically transmitted among the system users. In other words, according to the above system, although data is automatically transferred among the system users, the system has to be activated by the system user in a manual fashion.

A fourth problem will be described below. In the related-art system, a document that was created by the preceding system user is sent to each system user as it is. Inasmuch as the contents of the work processing are different depending upon the system user, the system user has to create a document in the different form suitable for his own work processing. In such case, the system user reads out the document of the different form and imports necessary original data to such document or processes the original data in a predetermine manner. Then, the system user creates a new document by importing data of the processed result to the document. As described above, according to the related-art system, since the document that was created by the preceding system user is sent to each system user, it takes a lot of time and labor for each system user to create anew document, and as a consequence, a work processing cannot be executed efficiently.

### SUMMARY OF THE INVENTION

In view of the aforesaid aspect, it is an object of the present invention to provide a workflow system in which a route can be varied with ease and in which a continuity of work processing among respective sections can be maintained.

It is another object of the present invention to provide a workflow system in which a workflow can be created with ease and in which a system user can select the next system user each time the system user executes the processing.

It is still another object of the present invention to provide a workflow system which can be activated automatically.

It is a further object of the present invention to provide a workflow system in which documents of different formats can be transmitted according to the contents of the work processing of each system user so that the work processing can be simplified.

In order to attain the above-mentioned objets, according to the present invention, there is provided a workflow system having a network connected with a plurality of computer terminals and in which a work processing is executed by transferring data among a plurality of system users in a plurality of sections through said network. This workflow system comprises main workflow defining means for defining a main workflow which determines a section or sections for executing a work processing, sub-workflow defining means for defining a sub-workflow which determines a work flow within a section, memory means for memorizing the workflow and the sub-workflow, section management means for transferring the data among the system users in accordance with the sub-workflow, sub-workflow interface parts disposed at each section and having a definition of a correspondence of sub-workflow used according to the data, and entire management means for transferring the data between the sub-workflow interface parts in accordance with the main workflow, wherein a sub-workflow is activated when the sub-workflow interface part receives the data.

To attain the above-mentioned objects, according to the present invention, there is provided a workflow processing method having a network connected with a plurality of computer terminals and in which a work processing is executed by transferring data among a plurality of system users in a plurality of sections through the network. The workflow processing method comprises a main workflow defining means for defining a main workflow which determines sections for executing a work processing, a sub-workflow defining means for defining a sub-workflow which determines a flow of work processing within a section, a section management means for transferring the data in accordance with the sub-workflow, and sub-workflow interface parts disposed at each section and having a work processing identifier and data/object pointer, wherein when a processing of the sub-workflow is ended, the work processing identifier and data/object pointer are transferred to the sub-workflow interface step to thereby activate the next sub-workflow.

The present invention includes the sub-workflow defining means for defining a sub-workflow which determines a work flow within a section, and the sub-workflow interface parts disposed at every section and which has a correspondence of a sub-workflow used according to the data, in which data is transferred via the sub-workflow interface parts disposed at the section units. When the sub-workflow interface part receives data, the sub-workflow corresponding to the received data is activated. Thus, a route can be defined to every section in advance, and the route can be defined with ease. Therefore, when a change occurs in one section or a route is changed in somewhere of the section, the route may be defined again within the section, and hence the route can be changed with ease. Also, since the data flow among the respective sections via the sub-workflow interface parts sequentially, it is possible to maintain a continuity of work processing between the sections.

To attain the above-mentioned objects, according to the present invention, there is provided a workflow system having a network connected with a plurality of computer terminals and in which a work processing is executed by transferring data among a plurality of system users through the network. The workflow system comprises selecting means capable of selecting the next system user to receive the data from each system user from a plurality of selection items displayed on a screen, and management means for transferring the data to a system user corresponding to the contents of the selected selection item when the said selection item is selected by the selecting means, and transferring the data to a predetermined system user in accordance with the workflow when said selection means is not used.

According to the present invention, when each system user selects a predetermined selection item by the selecting means after a work processing is ended, the management means transfers data to the system user corresponding to the selected selection item so that each system user can transmit data to system users other than the next system user determined by the workflow according to the situations. Also, if the selection item includes entries such as “REJECT PROCESSING”, “SKIP PROCESSING”, “BRANCH PROCESSING”, “TRANSFER PROCESSING” or “STOP PROCESSING”, then the patterns for transferring data by these processing need not be arranged within the workflow. Therefore, only a fundamental workflow for transferring data when each system user normally executes a work processing might be defined, and hence a workflow can be created with ease.

To attain the above-mentioned objects, according to the present invention, there is provided a workflow system having a network connected with a plurality of computer terminals, workflow defining means for defining a flow of a work processing, and first memory means for memorizing the workflow and in which a work processing is executed by transferring data among a plurality of system users via the network. This workflow system comprises second memory means for storing external data transmitted thereto from the outside, detecting means for generating a detection signal by detecting that the external data is stored in the second memory means, and management means for executing the workflow by reading out the workflow from the first memory means based on the external data stored in the second memory means according to the detection signal from the detecting means.

To attain the above-mentioned objects, according to the present invention, there is provided a workflow system having a network connected with a plurality of computer terminals, workflow defining means for defining a flow of a work processing corresponding to job type information and first memory means for storing the workflow, and in which a work processing is executed by transferring data among a plurality of system users via the network. This workflow system comprises second memory means for storing image data transmitted thereto from the outside, judgment means for reading out job type information from the image data stored in the second memory means, and management means for executing the workflow by reading out the workflow corresponding to the job type information judged by the judgment means from the first memory means.

According to the present invention, when external data such as image data is transmitted, if the detecting means detects that the external data is stored in the second memory means, then the detecting means sends the detection signal to the management means. Then, the management means receives such detection signal, the management means reads out a predetermined workflow from the first memory means based on the external data for execution. Therefore, when the system receives the external data, the system can be automatically activated, and operated.

To attain the above-mentioned objects, there is provided a workflow system having a network connected with a plurality of computer terminals, and in which a work processing is executed by transferring data among a plurality of system users via the network in accordance with a workflow which determines a flow of work processing. This workflow system comprises first memory means for memorizing document format data required according to the contents of a work processing at every work processing, second memory means for memorizing a procedure defined in association with the document format data, the procedure being used to effect a predetermined processing on the data, and management means for reading out the document format data corresponding to the contents of a work processing of the next system user and the procedure related to the document format in accordance with the workflow, processing the data in accordance with the procedure thus read out, and transferring data of processed result and the document format data thus read out to the next system user.

According to the present invention, when the management means transfers data to the next system user in accordance with a workflow, the management means reads out document format data corresponding to the contents of the work processing of the next system user and the procedure related to the document format data, and processes data in accordance with the procedure thus read out. Then, the management means transfers data of the processed result and the document format data thus read out to the next system user. Thus, documents of different formats can be transmitted to the system users according to the contents of the work processing, and also data of the result processed in accordance with the procedure can be imported to the document. As described above, since the system automatically processes data and the system users need not to create a new document by processing data created by the preceding system user, it is possible to simplify the work processing of each system user.

### BRIEF DESCRIPTION OF THE DRAWINGS

FIG. 1A is a schematic diagram showing a workflow system according to a first embodiment of the present invention;

FIG. 1B is a schematic diagram showing an example of a flow of data processing in respective sections in the workflow system shown in FIG. 1A;

FIG. 2 is a schematic diagram showing a server in the workflow system according to the first embodiment;

FIG. 3 is a memory map of post office;

FIG. 4 is a diagram showing an example of a main workflow;

FIG. 5 is a diagram showing examples of sub-workflow;

FIG. 6 is a diagram showing a flow of data processing;

FIG. 7 is a flowchart showing a flow of a certain job;

FIG. 8 is a diagram used to explain the manner in which a manager processes a job;

FIG. 9 is a flowchart showing a processing of a section management part;

FIG. 10 is a flowchart showing contents of processing done by a entire management part;

FIG. 11 is a flowchart showing contents of processing done by a entire management part;

FIG. 12 is a schematic diagram showing a server in a workflow system according to a second embodiment of the present invention;

FIGS. 13A and 13B are diagrams showing examples of selection items displayed on a screen of a computer terminal, respectively;

FIG. 14 is a flowchart to which reference will be made in explaining the manner in which the workflow system is operated when a processing selection command is inputted;

FIG. 15 is a schematic diagram showing an example of a flow of a work processing in a certain section;

FIG. 16A is a schematic diagram showing a workflow system according to a third embodiment of the present invention;

FIG. 16B is a schematic diagram showing an example of a flow of a data processing in each section in the workflow system shown in FIG. 16A;

FIG. 17 is a schematic block diagram showing a server in the workflow system according to a third embodiment;

FIG. 18 is a schematic functional block diagram of the server shown in FIG. 17;

FIG. 19 is a diagram showing an example of a front page of a fax document;

FIG. 20 is a flowchart to which reference will be made in explaining the manner in which the workflow system is operated when fax data is transmitted to the workflow system from the outside;

FIG. 21 is a schematic diagram of a system configuration of a server in a workflow system according to a fourth embodiment of the present invention;

FIGS. 22A and 22B are diagrams showing examples of document forms, respectively;

FIG. 23A is a memory map of a third memory part;

FIG. 23B is a memory map of a fourth memory part;

FIG. 23C is a memory map of a second memory part;

FIG. 24 is a diagram showing a flow of data processing;

FIG. 25 is a schematic diagram of a system configuration of a server in a workflow system according to a fifth embodiment of the present invention;

FIG. 26 is a diagram showing an example of a destination list memorized in the second memory part;

FIG. 27 is a flowchart to which reference will be made in explaining the manner in which a document with “reference” is delivered;

FIG. 28 is a flowchart to which reference will be made in explaining the manner in which a document with “void” is delivered;

FIG. 29 is a schematic functional block diagram of a server in a workflow system according to a sixth embodiment of the present invention;

FIGS. 30A and 30B are diagrams showing examples of pictures displayed on a screen of a computer terminal when a retrieval is executed, respectively;

FIG. 31 is a diagram showing an example of a picture displayed on a screen of a computer terminal when a retrieval is executed;

FIG. 32 is a diagram showing an example of a picture displayed on a screen of a computer terminal when a retrieval is executed;

FIG. 33 is a diagram showing a flow of work processing;

FIG. 34 is a flowchart used to explain a processing executed when a retrieval is executed;

FIG. 35 is a schematic diagram of a system configuration of a server in a workflow system according to a seventh embodiment of the present invention;

FIGS. 36A and 36B are diagrams showing examples of document forms, respectively;

FIG. 37A is a memory map of a third memory part;

FIG. 37B is a memory map of a fourth memory part;

FIG. 37C is a memory map of a second memory part FIG. 38 is a diagram showing a flow of data processing;

FIG. 39 is a flowchart showing a flow of data processing executed when a document is saved;

FIG. 40 is a schematic diagram used to explain an entirety of a work executed when documents are saved;

FIG. 41 is a diagram showing examples of pictures used to confirm the document saving;

FIG. 42 is a schematic diagram showing a document transfer system according to an eighth embodiment of the present invention;

FIG. 43 is a diagram showing an example of a sequential order in which a document is transmitted;

FIG. 44 is a diagram showing an example of a table in which transfer destinations are described when a document is transmitted in the sequential order shown in FIG. 43;

FIG. 45 is a flowchart to which reference will be made in explaining the manner in which document data is transferred in a section X; and

FIG. 46 is a flowchart to which reference will be made in explaining the manner in which document data is transferred in the section X.

### DETAILED DESCRIPTION OF THE PREFERRED EMBODIMENTS

The present invention will hereinafter be described with reference to the drawings.

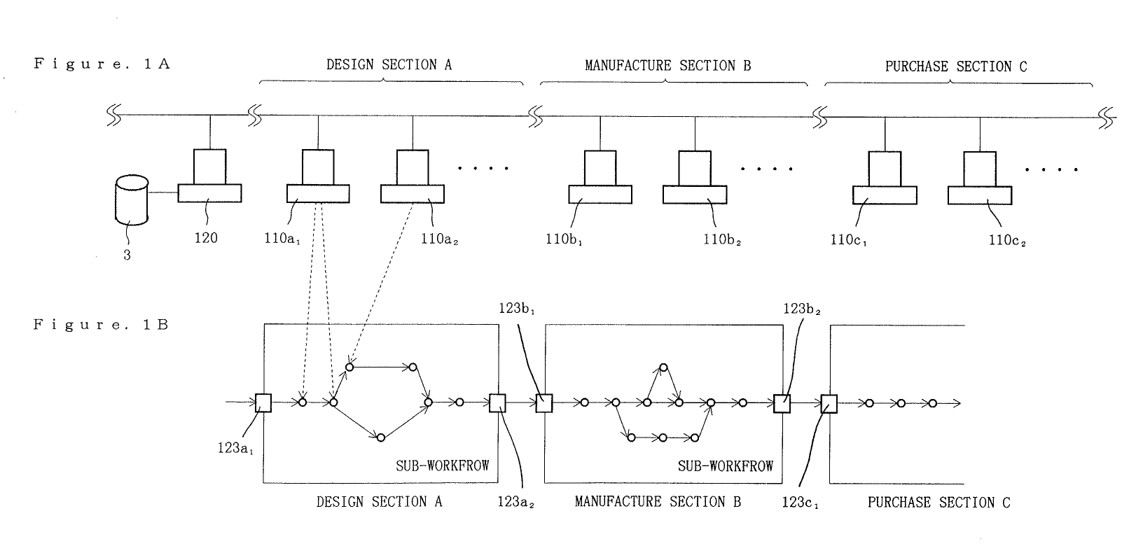

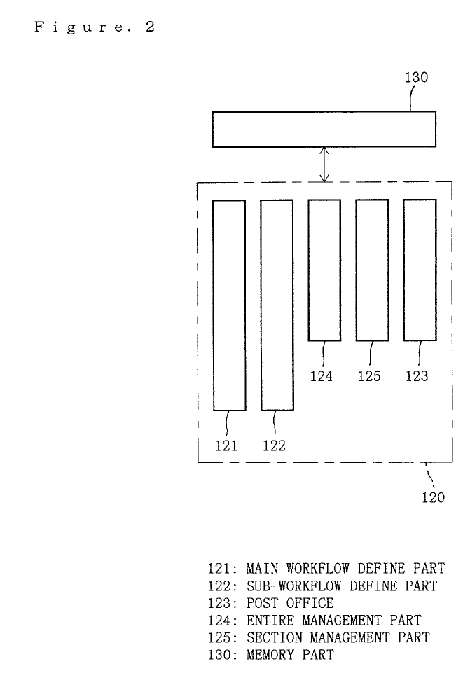

FIG. 1A is a schematic diagram showing a workflow system according to a first embodiment of the present invention, FIG. 1B is a schematic diagram showing an example of a flow of data processing in respective sections in the workflow system shown in FIG. 1A, and FIG. 2 is a schematic diagram showing a server in the workflow system. In this embodiment, let us consider the case in which document data is transferred among a plurality of system users in a plurality of sections within a certain company and a work processing such as signing or sanction is executed.

As shown in FIG. 1A, the workflow system includes a plurality of computer terminals 110a₁, 110a₂, . . . , 110b₁, 110b₂, . . . , 110c₁, 110c₂, . . . , a server 120 and a memory 3. The server 120 is connected to a plurality of computer terminals 110a₁, . . . , 110b₁, . . . , 110c₁, . . . , thereby a network being configured. A plurality of computer terminals 110a₁, . . . , 110b₁, . . . , 110c₁, . . . , are located at respective sections each of which executes a predetermined work. As shown in FIGS. 1A and 1B, the computer terminals 110a₁, 110a₂, . . . , are located at a design section A, the computer terminals 110b₁, 110b₂, . . . , are located at a manufacture section B, and the computer terminals 110c₁, 110c₂, . . . , are located at a purchase section C.

Each system user enters his own ID NO. to create a new document by using a predetermined computer terminal of his own section, or displays a document sent thereto and executes a predetermined processing on the document thus displayed. In this embodiment, as shown in FIG. 1B, each system user of every section executes a work processing, and then sends data to other system user. In FIG. 1B, an open circle represents a cell, i.e. a processing at that time, and an arrow represents a node, i.e. a connection between the processings. Data is interchanged between the two sections via a post office, i.e. sub-workflow interface part 123 which will be described later on.

Not substantial document data but data including, for example, job name (work processing identifier), job type information, destination name, status information or object information are sent to each system user. Document data is memorized in the memory 3, for example, and managed by the server 120. Only document data address is sent between the computer terminals, and in the work processing, necessary document data is read out from the memory 3. Thus, it seems for the system user that his own computer terminal has document data. Of information included in the data interchanged between the computer terminals, the job name is a serial number given to a matter when the matter needing processing takes place. In general, a company has a predetermined rule for giving the serial number to the matter so that the system user can learn which section to send the matter from the serial number. The job type information represents the content of the matter in each section. The job type information enables the system to identify the route for transferring data to which section and which system user in which sequential order. The destination name represents a section to which data is sent. The status information reveals whether or not the work processing is executed correctly. The object information represents appended materials included in the document or the like.

As shown in FIG. 2, the server 120 includes a main workflow define part 122, a sub-workflow define part 122, the post office 123, an entire management part 124 and a section management part 125. The main workflow define part 121 is adapted to define a main workflow which determines the sections to execute the work processing. The sub-workflow define part 122 is adapted to define the flow of work processing in each business section. The main workflow and the sub-workflow are memorized in the memory 130 in the memory 3. Incidentally, the two define parts 121, 122, the post office 123 and the two management parts 124, 125 may be memorized in the memory 130, and read out to the server 120 from the memory 130.

In this embodiment, the post office, i.e. sub-workflow interface define part 123 is located at every section. Such post office 123 functions as an I/O interface, and is a data memory part serving as a gate to and from which data is sent and received between the sections.

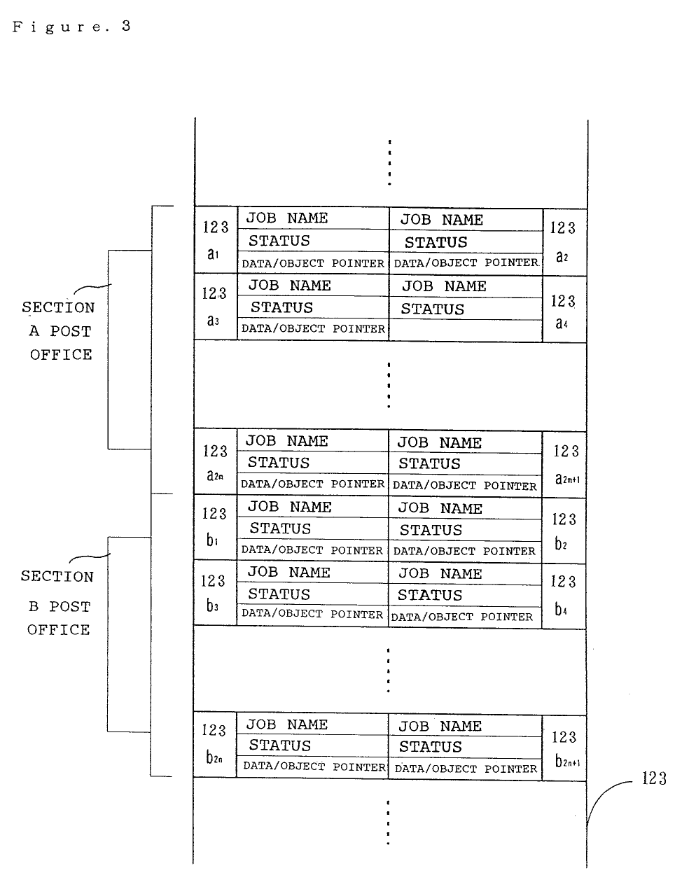

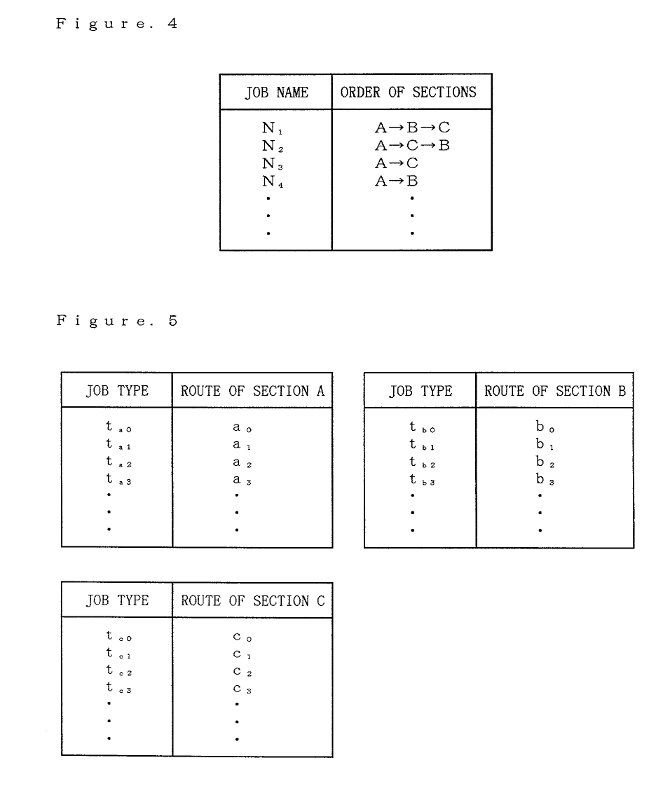

As shown in FIG. 3, the post office 123 includes a post office prepared to every section, and each post office includes a plurality of sub-post offices.

Data memorized in the sub-post offices 123a₁, 123a₂, . . . , 123b₁, 123b₂, . . . , contain job name, status and data/object pointer at every sub-post offices 123a₁, 123a₂, . . . , 123b₁, 123b₂, . . . . The sub-post offices 123a₁, 123a₃, . . . , 123b₁, 123b₃ are available as two kinds of input side and output side sub-post offices at every job. The sub-post offices 123a₁, 123a₃, . . . , 123b₁, 123b₃, . . . are those on the input side, and the sub-post offices 123a₂, 123a₄, . . . , 123b₂, 123b₄ are those on the output side. The sub-post office 123a₁ and the sub-post office 123a₂, the sub-post office 123a₃ and the sub-post office 123a₄, the sub-post office 123b₁ and the sub-post office 123b₂ and the sub-post office 123b₃ and the sub-post office 123b₄ are each paired, and attached with the same job name.

The status may take three states, i.e. “END” indicative of the end of the processing, “NOT YET PROCESSED” indicating that the processing is not yet finished, or the section does not yet receive data and “BEING PROCESSED” indicating that data is being processed. Also, the data or object pointer shows an object needing processing, and there may be provided a plurality of data or object pointers.

Incidentally, the post office 123 has a post office per a certain job, and each post office may have a sub-post office at every section defined to the flow of the job.

The entire management part 124 is adapted to interchange data between the post offices in accordance with the main workflow. The section management part 125 is adapted to interchange data between the system users in accordance with a sub-workflow.

Data, main workflow, sub-workflow, etc. are memorized in the memory 130. The main workflow is adapted to determine the sequential order of transferring data between the sections in accordance with the job names contained in the data. FIG. 4 shows examples of the main workflow. When the job name is N₁, the main workflow designates the sequential order of transferring data among the sections such that data is transferred in the order of the design section A, the manufacture section B and the purchase section C. When the job name is N₂, the main workflow designates the sequential order of transferring data among the sections such that data is transferred in the sequential order of the design section A, the purchase section C and the manufacture section B. When the job name is N₃, the main workflow designates the sequential order of transferring data among the sections such that data is transferred in the sequential order of the design section A and the purchase section C. Also, when the job name is N₄, the main workflow designates the sequential order of transferring data among the sections such that data is transferred in the sequential order of the design section A and the manufacture section B.

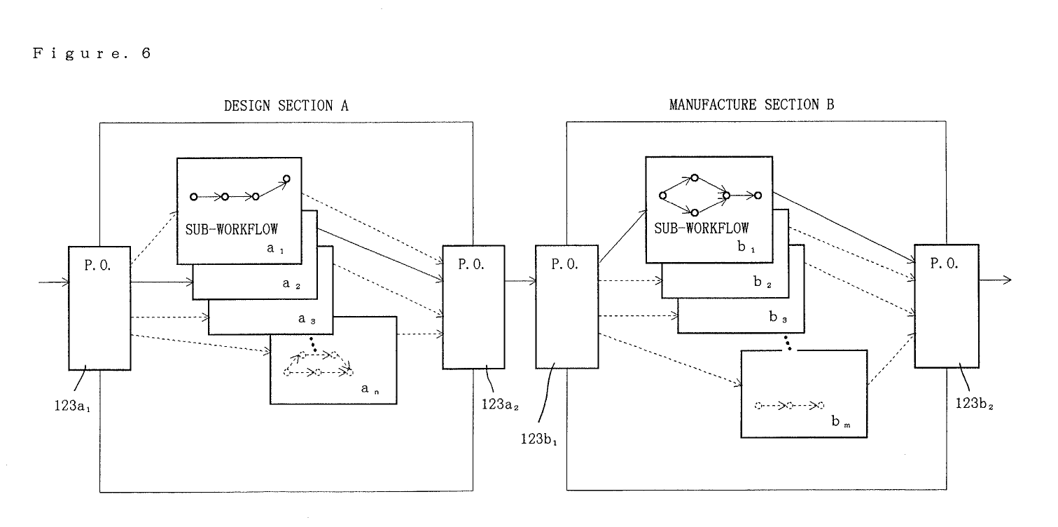

The sub-workflow is adapted to designate the route of transferring data within the section to the system user in accordance with job type information at every section. FIG. 5 shows examples of the sub-workflow. In the design section A, for example, the sub-workflow designates a route a₁ for job type information tₐ₁ indicative of executing a new design, and also designates a route a₂ for job type information tₐ₂ indicative of varying a design. In the manufacture section B, the sub-workflow designates a route b₁ for job type information t_{b1} indicative of an experimental production, and also designates a route b₂ for job type information t_{b2} indicative of a mass-production. Also, in the manufacture section B, the sub-workflow designates a route b₃ for job type information t_{b3} indicative of a production to order. In the purchase section C, the sub-workflow designates a route c₁ for job type information t_{c1} indicative of a lease, and designates a route c₂ for job type information t_{c2} indicative of a purchase. Also, in the purchase section C, the sub-workflow designates a route c₃ for job type information t_{c3} indicative of an advance.

Further, the sub-workflow possesses routes a₀, b₀ and c₀ for the respective sections A, B and C to send data to managers of the sections A, B, C. When the route a₀, for example, is selected, the manager in the design section A determines the system user of his own section to carry out a work processing according to data supplied thereto. In this case, the manager may either determine a new route or select any one of other previously-determined routes a₁, a₂, . . . . The reason that the sub-workflow possesses the routes for sending data to the manager as described above is as follows. The first reason is to respect an intention of each section. The second reason is that, if routes with respect to all sections are selected when a new matter takes place, then the system user who executes the first work processing is well acquainted with routes with respect to his own section but is not well-informed about the real state of other sections. Incidentally, the routes a₀, b₀, c₀ for sending data to the manager are selected based on predetermined job type information tₐ₀, t_{b0}, t_{c0}, and may also be selected when any job type information is not designated.

The server 120 transfers data among the sections in accordance with the main workflow, and transfers data to each system user within each section in accordance with the sub-workflow. If the system user enters a command indicative of the end of work processing when the system user finishes his own work processing, without any instruction, the server 120 determines the end of the work processing, and transfers data to the next system user. Moreover, the server 120 has a function to manage a progress of a work processing, and is able to manage a latest situation of a progress with respect to every matter.

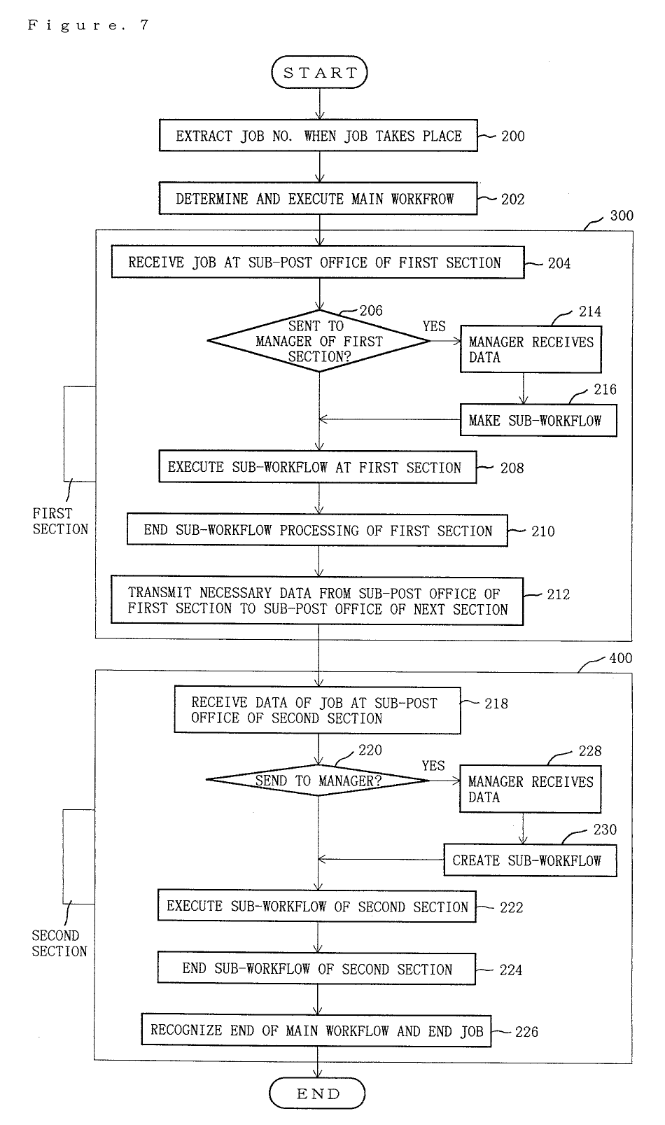

An operation of the workflow system according to this embodiment will be described below. FIG. 6 is a schematic diagram showing the flow of data processing. For simplicity, FIG. 6 shows only the sub-post offices 123a₁ and 123a₂ with respect to the design section A, and sub-post offices 123b₁ and 123b₂ with respect to the manufacture section B. Sub-post offices 123a₃, 123a₄, . . . , and 123b₃, 123b₄, . . . , that are existing in actual practice are not shown.

Let it now be assumed that, when a certain matter needing processing takes place, a system user X₀ in the design section A creates a document concerning a new matter by entering his own ID NO. through his own computer terminal 110a₁. At that time, a job name is determined when a document is created. When the job name is selected, the main workflow, i.e. the sequential order in which data is transferred among the respective sections is determined. Here, let it be assumed that the main workflow in the sequential order of the design section A, the manufacture section B and the purchase section C is selected. If the system user X₀ is able to learn in advance the route for transferring data in other sections from the contents of the matter, then job type information may be determined. To be more concrete, if the system user X₀ knows that the contents of this matter is to make a trial manufacture by modifying a design and to lease a trial product, then the system user X₀ may select the route in the design section A as the route a₂, the route in the manufacture section B as the route b₁ and the route in the purchase section C as the route c₁ by designating the job type information tₐ₂, t_{b1}, t_{c1}. It is assumed herein that the system user X₀ determines the job type information tₐ₂, t_{b1}, t_{c1}.

When the system user X₀ finishes creating the new document and enters a command indicative of the end of the work processing, the server 120 extracts a job name and job type information or the like from the document data. Then, the server 120 reads out a predetermined sub-workflow from the memory 130 based on the job type information tₐ₂ and transfers the data to the next system user X₁ in the design section A in accordance with the route a₂. The system user X₁ enters his own ID NO. from his own computer terminal 110a₂ and effects a predetermined work processing on the data supplied thereto. When the server 20 monitors a progress of such a work processing and confirms that a command indicative of the end of the work processing is entered by the system user X₁, the sever 120 sends the data to the next system user X₂ in accordance with the route a₂. In this way, the data is sequentially transferred to the system users within the design section A in accordance with the route a₂, and the work processing is executed one after another as shown in FIG. 6.

In the design section A, when the last system user completes a predetermined work processing, data in the sub-post office 123a₂ at the output side is sent to the manufacture section B. Then, the sub-post office 123b₁ at the input side confirms the job name, and determines whether or not the destination name is his own section. As a result of such confirmation, it is determined whether or not there occurs an abnormality. If there occurs an abnormality, then data is returned to the last system user in the preceding section A or the server 120. If on the other hand there occurs no abnormality, then a sub-workflow concerning the manufacture section B is read out from the memory 130 based on job type information and the sub-workflow thus read out is executed by the section management part 125. In this manner, data is transferred to the respective system users within the manufacture section B in accordance with the route b₁, and the work processing is executed one after another as shown in FIG. 6. Thereafter, a similar processing is executed, and data is transferred from the manufacture section B to the purchase section C in accordance with the main workflow.

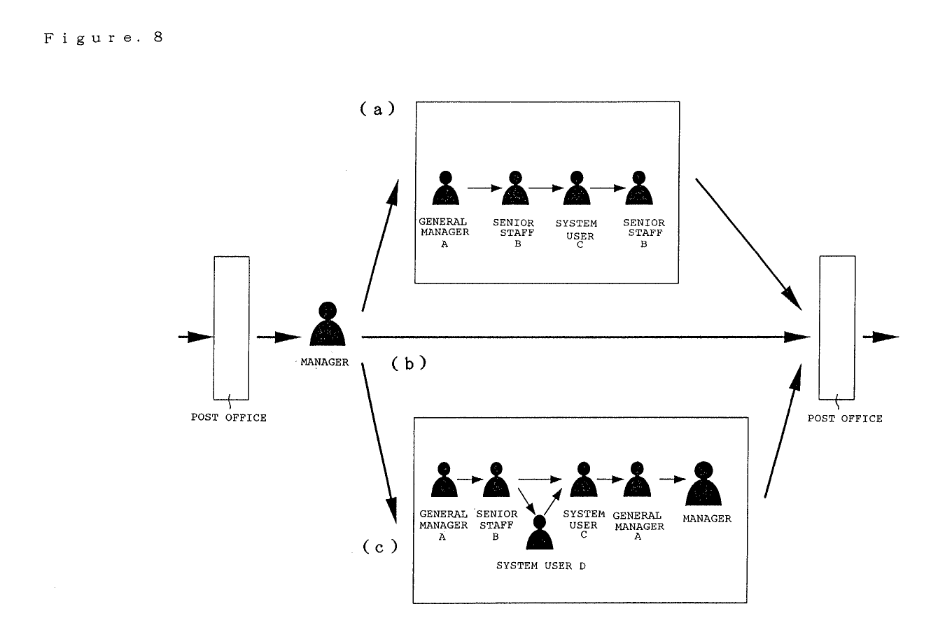

The flow of a job on the work flow will be described more fully with reference to FIGS. 7, 8, 9, 10 and 11.

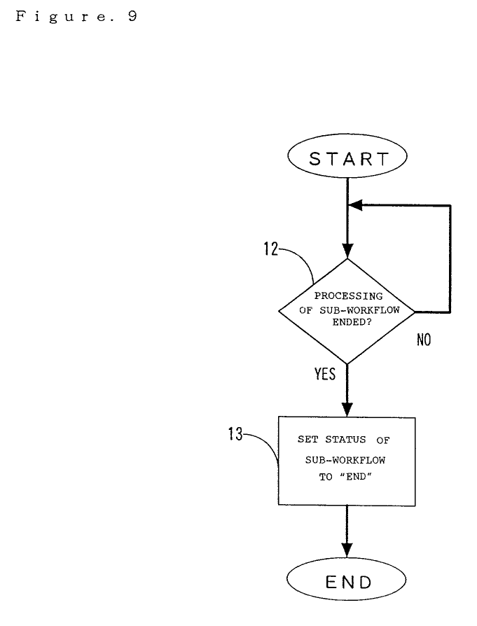

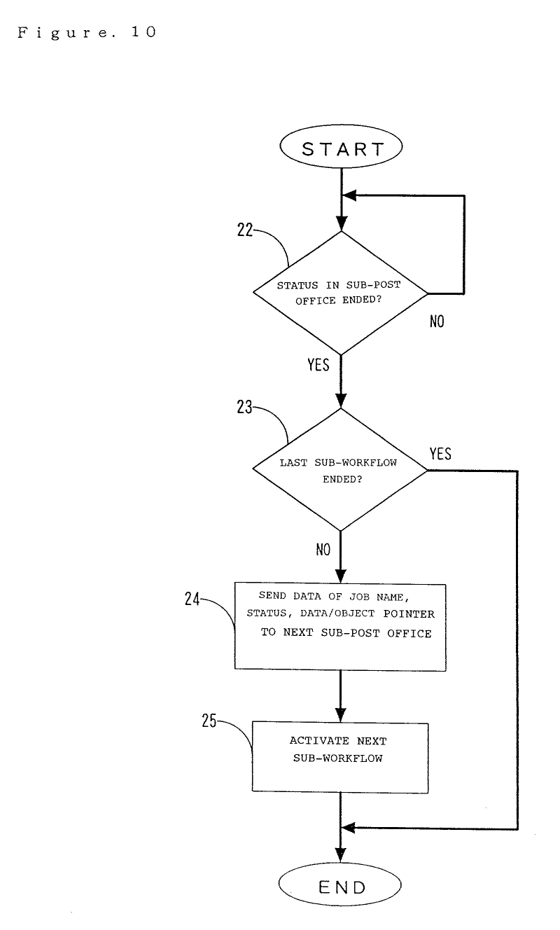

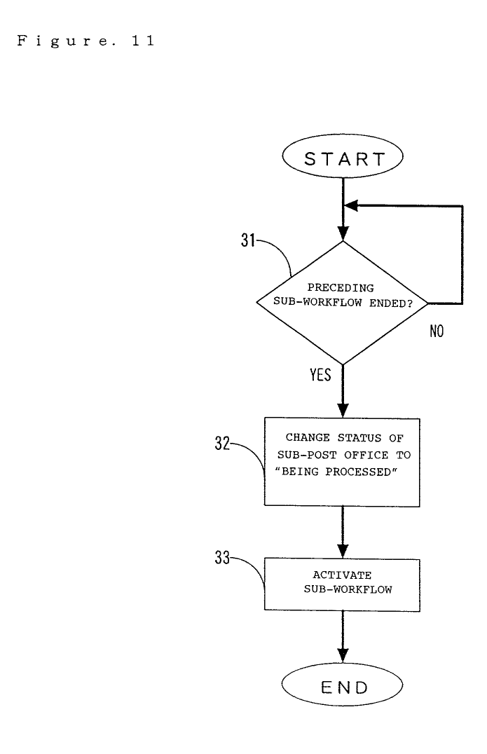

FIG. 7 is a flowchart illustrating the whole of flow of a certain job. The job on this flow is executed by two sections of first and second sections. FIG. 8 is a diagram showing the manner in which the manager processes a job. FIG. 9 is a flowchart showing the processing done by the section management part 25, and FIGS. 10 and 11 are flowcharts showing the contents of the processing done by the entire management part 24, respectively.

Referring to the drawings in detail, and initially to FIG. 7, following the start of operation, control goes to a step 200, whereat a job NO. is extracted when a job takes place. In this case, the job NO. may be extracted either automatically or the system user may decide and enter the job NO. Control goes to the next step 202, wherein a main workflow for defining the sections, the system user and the sequential order in which the job is processed are determined at every extracted job NO., and the entire management part 124 will hereinafter execute the main workflow thus determined.

According to this main workflow, the job is executed by the first section. When a sub-post office in the present job at the post office of the first section receives the job at a step 204, control goes to the next decision step 206, whereat it is determined by the section management part 125 whether or not this job should be sent to the manager of the first section. If the sub-workflow at the first section is already defined as represented by a NO at the decision step 206, then control goes to a step 208, wherein the job is not transmitted to the manager of the first section, and the sub-workflow at the first section is executed. Although the sub-post offices exist conceptually just like gates for respective sections, if the sub-post office receive data, the section management part 125 executes the sub-workflow at the step 208. When the processing of the last cell is ended, data is transmitted to a predetermined sub-post office, and the sub-workflow processing of the first section is ended at a step 210.

If the sub-workflow at the first section is not defined as represented by a YES at the decision step 206, then control goes to a step 214, whereat the manager receives the data.

The manner in which the manager executes the sub-workflow when the manger receives the job will be described with reference to FIG. 8. In FIG. 8, the manager who received the job judges the content of the received job and the person in his own section to handle the job, and can make a sub-workflow at a step 216. As shown by (a) in FIG. 8, the manager makes the sub-workflow in which the job is executed by the general manager A, the senior staff B, the system user C and the senior staff B in that order, and executes this sub-workflow at the step 208. The sub-post office recognizes the completion of the sub-workflow, and transmits necessary data to the next section defined in the main workflow at a step 212. Also, as shown by (b) in FIG. 8, the manager may make a sub-workflow in which the manager processes the received job, and execute the sub-workflow thus made. Furthermore, as shown by (c) in FIG. 8, the manager may make a sub-workflow in which the received job is processed by the general manger A, the senior staff B, the system user C (via system user D), the general manager A and the manager, in that order, and execute the sub-workflow thus made.

As described above, even when the sections and the sequential order of the processing are defined in the main workflow but the sub-workflow for executing the processing at each section is not defined, the manager at the corresponding section is able to define the sub-workflow within the section regardless of the main workflow. All of the processing can be executed based on the previously-defined sub-workflow or the sub-workflow defined by the manager at the step 210.

The manner in which the section management part 125 executes the processing when the sub-workflow is executed and ended will be described with reference to the flowchart of FIG. 9.

Referring to FIG. 9, and following the start of operation, it is determined at a decision step 12 by the section management part 125 whether or not the processing in all cells of the sub-workflow is ended. If the processing in all cells of the sub-workflow is ended as represented by a YES at the decision step 12, then control goes to a step 13, whereat the status of the sub-workflow is set to “END”,and the status of the sub-post offices 123a₂, 123b₂ or the like is changed from “BEING PROCESSED” to “END”. The status of sub-post offices may be varied by the entire management part 124, and the status of sub-post offices may be varied with reference to “STATUS” of the internal sub-workflow of the section management part 125.

On the other hand, the entire management part 124 monitors the status of sub-post offices as shown in a flowchart of FIG. 10, and the status of sub-post offices is illustrated in FIG. 3. Referring to FIG. 10, and following the start of operation, control goes to the next decision step 22, wherein it is determined whether or not the status of the sub-post office is set to “END”. If the status of the sub-post office is set to “END” as represented by a YES at the decision step 22, then control goes to the next decision step 23, wherein it is determined whether or not the above sub-workflow is the last sub-workflow in the main workflow. If the above sub-workflow is the last one in the main workflow as represented by a YES at the decision step 23, then control is ended. If the above sub-workflow is not the last one as represented by a NO at the decision step 23, then control goes to a step 24, whereat job name and data/object pointer are sent to the next post office 123b₁ or the like. Then, control goes to the next step 25, whereat the next sub-workflow is activated. While the next sub-workflow may be directly activated, the present invention is not limited thereto, and the processing shown in a flowchart of FIG. 11 is executed when the above-mentioned data is transmitted to the next sub-post office 123b₁.

Referring to Figure. 11, and following the start of operation, the entire management part 124 is monitoring the end of the sub-workflow, and control goes to the next decision step 31. In the decision step 31, it is determined by the entire management part 124 whether or not the preceding sub-workflow is ended. If the preceding sub-workflow is ended as represented by a YES at the decision step 31, then control goes to a step 32, whereat the status of the sub-post office 123b₁ with respect to the next sub-workflow is changed from “NOT YET PROCESSED” to “BEING PROCESSED”. Then, control goes to the next step 33, wherein the sub-workflow is activated, i.e. the first cell within the sub-workflow is executed.

After the sub-workflow of the first section is ended at the step 210, control goes to the next step 212, whereat the entire management part 124 transmits data of the first section, i.e. contents of the job name and data/object pointer from the sub-post office of the first section to the sub-post office of the second section, which is the next section, in accordance with the main workflow.

In a step 218, when the above-mentioned data are transmitted, the second section that is the next section receives information indicating the arrival of job. Then, control goes to the next decision step 220, whereat it is determined whether or not the present job should be transmitted to the manager. If the present job is the job that should be transmitted to the manager as represented by a YES at the decision step 220, then control goes to a step 228, whereat the manager receives the present job. Then, control goes to a step 230, whereat the manager makes a sub-workflow. In the next step 222, the manager then executes the sub-workflow thus made. If the sub-workflow of the second section is defined previously as represented by a NO at the decision step 220, then control goes to the step 222, wherein the sub-workflow of the second section is executed. According to this embodiment, after the sub-workflow of the second section is ended at the step 222, then control goes to a step 224, whereat the main workflow is ended. Then, in the next step 226, the sub-post office in the post office of the second section for the present job recognizes the end of the main workflow, and the job is ended.

Incidentally, the number of the sections needing processing changes depending on the job. While the main workflow is defined such that the processing is executed in two sections as described above, the present invention is not limited thereto, and the number of the sections may be changed freely. However, it is to be appreciated that the job is completed after the sub-post office of the section defined last by the main workflow recognizes that the main workflow is ended.

While the sub-post offices 123a₁, 123b₁, . . . , are disposed at the input side of the respective sections and the sub-post offices 123a₂, 123b₂, . . . , are disposed at the output side of the respective sections as shown in FIGS. 1 and 6, if the next sub-workflow is activated directly after the preceding sub-workflow is ended as described above, then the sub-post offices 123a₁, 123b₁, . . . , disposed at the input side of the respective sections may be omitted. Also, the post office may be defined as an interface at every sub-workflow. Furthermore, the post office itself may have a function to activate the sub-workflow, and the sub-workflow may be activated by the function of the post office.

Since the workflow system according to this embodiment includes the sub-workflow define part for defining the sub-workflow which determines the flow of the work processing within the section and the post office having the sub-post offices disposed at every section to read out the sub-workflow of the correspondence of data and which enables the section management section to execute the sub-workflow thus read out when each section receives the data, data is transferred through the post offices located in section units, and the sub-post office of the post office reads out and executes the corresponding sub-workflow of the data each time the sub-post office receives the data. Therefore, the route can be previously defined at every section, and it becomes easy to define the route. Accordingly, when the system user in a certain section, for example, is changed or the route is changed in somewhere of the section, the route may be defined again within the section. Thus, the route may be varied easily compared with the existing system. Furthermore, since data is sequentially transferred between the sections through the sub-post offices, it is possible to maintain a continuity of work processing among the sections.

The program which executes the operation described in this embodiment is wholly or partly recorded or memorized in a portable medium such as a floppy disk or a memory apparatus such as a hard disk. The program thereof is read out by the computer and the whole of or a part of the operation is executed.

As described above, according to this embodiment, since the workflow system includes the sub-workflow define part for defining the sub-workflow which defines the flow of the work processing within the section and the sub-workflow interface part disposed at every section and having a definition corresponding to a sub-workflow used according to the data, data is transferred in the units of section via the sub-workflow interface part, and the sub-workflow interface part activates the corresponding sub-workflow of the data each time the sub-workflow interface part receives the data. Therefore, a continuity of work processing between the sections can be maintained, and the route can be defined at every section in advance, thereby making it easy to defined a route. Thus, when some change occurs in a certain section or a route is change in somewhere of the section, the route may be defined again within the section, and the route may be changed with ease.

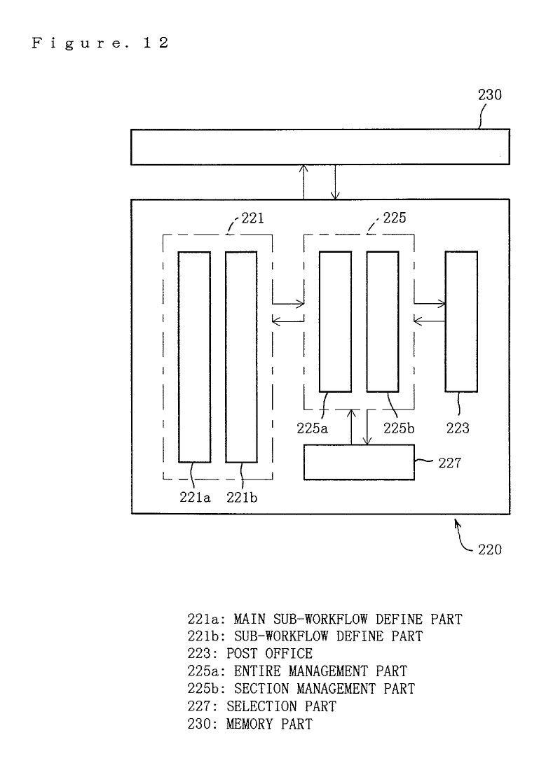

A second embodiment of the present invention will hereinafter be described with reference to the drawings. FIG. 12 is a schematic diagram showing a server of a workflow system according to this embodiment. In this embodiment, let us consider the case in which document data is transferred among a plurality of system users over a plurality of sections in a certain company to thereby execute a work processing such as signing and sanction.

Elements and parts shown in FIG. 1 and FIGS. 3 through 11 of the first embodiment are the same as those of the second embodiment, and these sheets of drawings and their detailed description will be omitted. If necessary, with respect to these omitted sheets of drawings, the sheets of drawings in the first embodiment will be referred to.

Furthermore, in this embodiment, elements and parts having functions similar to those of the first embodiment are marked with the same references and therefore need not be described.

As shown in FIG. 12, the server 220 includes a workflow define part 221, the post office 223, a management part 225 and a selection part 227. The workflow define part 221 includes a main workflow define part 221a and a sub-workflow define part 221b. The management part 225 includes an entire management part 225a and a section management part 225b. The main workflow define part 221a is adapted to define a main workflow which determines a section for executing a work processing at every business or according to the contents of business. The sub-workflow define part 221b is adapted to define a sub-workflow which determines a flow of a work processing within each business section. A main workflow and a sub-workflow are memorized in the memory part 230 disposed in the memory 3 shown in FIG. 1. The define parts 221a, 221b, the post office 223 and the management parts 225a, 225b may be memorized in the memory part 230, and read out from the memory part 230 to the server 220 when they are executed.

The entire management part 225a is adapted to transfer data between the post offices 223 in accordance with the main workflow. The section management part 225b is adapted to transfer data between system users in accordance with the sub-workflow. Also, when a certain system user selects the next system user to whom data is transferred as will be described later on, the section management part 225b transfers data to the system user who corresponds to the selected contents.

In this embodiment, as a sub-workflow, there is defined a fundamental sub-workflow which determines the manner in which data is transferred when each system user executes a work processing normally. Specifically, it becomes unnecessary to define a sub-workflow taking every possible patterns into consideration, such as to return data to other system user than the system user who transmits data when a particular system user, for example, does not approve such transmission of data, or to return data to a predetermined system user when work processing is canceled in somewhere of the processing. Therefore, the number of sub-workflow that should be defined can be reduced considerably compared with the related art, and hence the sub-workflow can be made very easily. In particular, according to this embodiment, only the fundamental sub-workflow is defined, and each system user can learn in advance the next system user to whom data is transferred.

When only the fundamental sub-workflow is defined as the sub-workflow, a degree of freedom with which a route for transferring data between system users is selected decreases, which as a result decreases a flexibility of the workflow system. Therefore, this embodiment enables each system user to select the next system user to whom data is transferred each time a work processing is completed. Specifically, when a command indicative of selecting a processing is inputted from the computer terminal, the selection part 227 sets a screen of computer terminal to a selection screen such that the system user can designate the next system user receiving data from a plurality of selection items displayed on the selection screen. When the next system user to whom data is transferred is designated, the selection part 227 transmits such information to the section management part 225b. Then, when receiving such information, the section management part 225b sends data to the designated system user, and data transferred after the next system user will be sent in accordance with the sub-workflow.

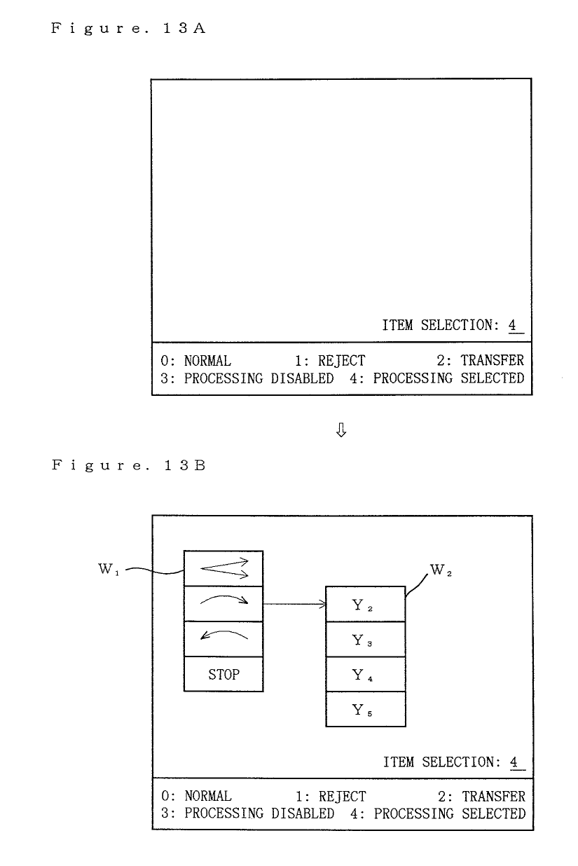

FIGS. 13A and 13B are diagrams showing examples of selection items displayed on a screen of a computer terminal. As shown in FIG. 13A, five selection items of “0: NORMAL”, “1: REJECT”, “2: TRANSFER”, “3: PROCESSING DISABLED”, and “4: PROCESSING SELECTED” are displayed on the lower side of the screen of the computer terminal. When a system user enters each number by using a suitable means such as a keyboard or a mouse, an item corresponding to the selected number is selected. The selection item “NORMAL” means the processing for transferring data to the next system user that is determined by the sub-workflow. If a selection item different from the selection item “NORMAL” is selected, then there is executed a special processing that is not defined in the sub-workflow. The selection item “REJECT” means a reject processing in which data is returned to the system user who transmits the data because the system user, for example, cannot approve the contents of business. The selection item “TRANSFER” means the processing in which a system user cannot judge a matter, for example, transmitted thereto and transfers a right of executing a work processing on that matter to other system user. When the selection item “TRANSFER” is selected, a list of all system users participating in this workflow is displayed on the screen of the computer terminal, and the system user may select a system user to whom the right is transferred from the above-mentioned list. The selection item “PROCESSING DISABLED” means the processing for informing a particular system user or the server 220 that the system user cannot execute the work processing because the system user, for example, is busy or due to a long time business trip.

When the selection item “PROCESSING SELECTED” is selected, as shown in FIG. 13B, a window W₁ is displayed on the left-hand side of the screen of the computer terminal and on which there are displayed detailed items of the contents needing processing. Of these detailed items, the first item from above represents a branch processing in which data is transferred to a plurality of system users. The second item represents a forward-skip processing in which data is transferred to a system user placed forward by two or more system users in the processing order determined by the sub-workflow. The third item represents a backward-skip processing in which data is transferred to a system user placed backward by two or more system users in the processing order determined by the sub-workflow. When any one item of “BRANCH PROCESSING”, “FORWARD-SKIP PROCESSING” and “BACKWARD-SKIP PROCESSING” is selected, as shown in FIG. 13B, a window W₂ is displayed on the right-hand side of the screen of the computer terminal and on which there is displayed a list of system users to whom data can be transferred based on the sub-workflow. Here, the selection part 227 reads out a sub-workflow from the memory part 230 and creates a list of system users. The list also consists of system users, or a person who approves a job, and user groups to which job belongs. Then, the system user selects from this list a system user to whom data should be sent. The bottom item of the window W₁ represents a stop processing in which a stop of a work processing is informed to all system users of work processing in accordance with the sub-workflow when the work processing has to be stopped because a matter needing processing is canceled.

It is customary that items displayed on the window W₁ are different depending on system users. For example, “BACKWARD-SKIP PROCESSING” item is not displayed on the window W₁ for the first system user who executes first the work processing in a certain section. “BRANCH PROCESSING” and “BACKWARD-SKIP PROCESSING” items are not displayed on the window W₁ for the last system user who executes a work processing last because the status is already completed.

If the system user enters a command indicative of selecting the processing when his own work processing is completed, then a plurality of selection items are displayed on the screen of the computer terminal as described above. Then, if the system user selects a predetermined item to designate the next system user to whom data is sent, then the section management part 225b transfers data to the designated system user. If on the other hand the system user does not enter the command indicative of selecting the processing but enters a command indicative of the end of the work processing, then the section management part 225b transfers data to the next system user in accordance with the sub-workflow. Also, the server 220 has a function to manage a progress situation of a work processing, and is able to manage the progress of the work processing up to the present time at every matter.

On the other hand, the entire management part 225a monitors the status of the sub-post office as shown in a flowchart of FIG. 10, and the status is shown in FIG. 3. Referring to FIG. 10, and following the start of operation, control goes to the next decision step 22, whereat it is determined whether or not the status of the sub-post office is ended. If the status of the sub-post office is ended as represented by a YES at the decision step 22, then control goes to the next decision step 23. In the decision step 23, it is determined whether or not the sub-workflow in the main workflow is ended. If the sub-workflow in the main workflow is ended as represented by a YES at the decision step 23, then control is ended. If on the other hand the sub-workflow in the main workflow is not ended as represented by a NO at the decision step 23, then control goes to the next step 24, whereat job name, status and data/object pointer are sent to the next post office 223b₁. Then, the next sub-workflow is activated at a step 25. In this activation of the sub-workflow, the next sub-workflow may be activated directly or if the above-mentioned data are sent to the next sub-post office 223b₁, then the processing shown in FIGURE. 11 is executed.

In the flowchart of FIG. 11, the entire management part 225a monitors the end of the sub-workflow. Referring to FIG. 11, and following the start of operation, control goes to the next decision step 31, whereat it is determined whether or not the preceding sub-workflow is ended. If the sub-workflow is ended as represented by a YES at the decision step 31, then control goes to a step 32, wherein the status of the sub-post office 223b₁ concerning the next sub-workflow is changed from “NOT YET PROCESSED” to “BEING PROCESSED”. Then, control goes to a step 33, whereat the sub-workflow is activated, i.e. the first cell within the sub-workflow is executed.

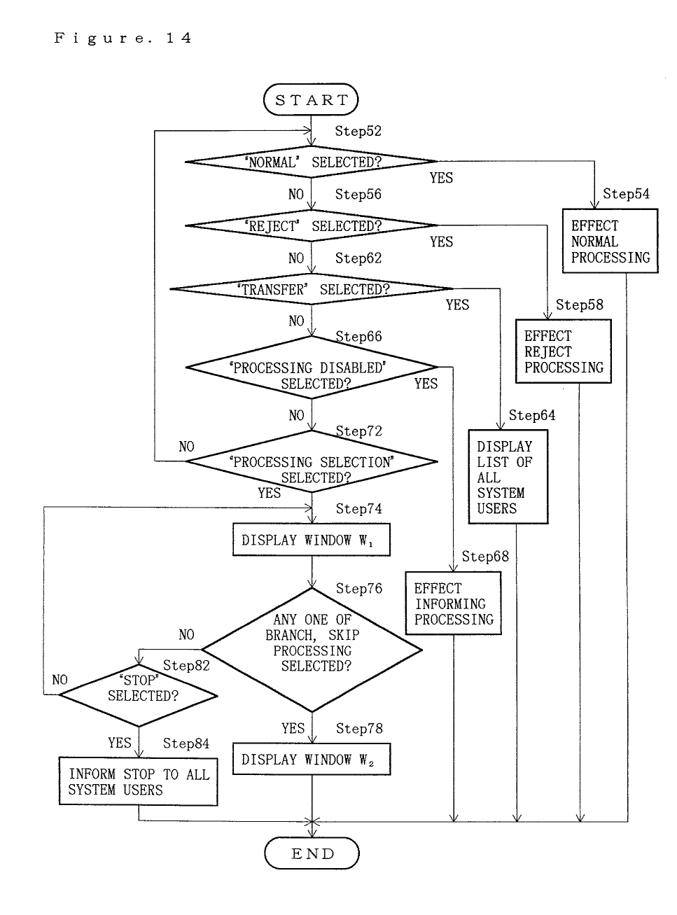

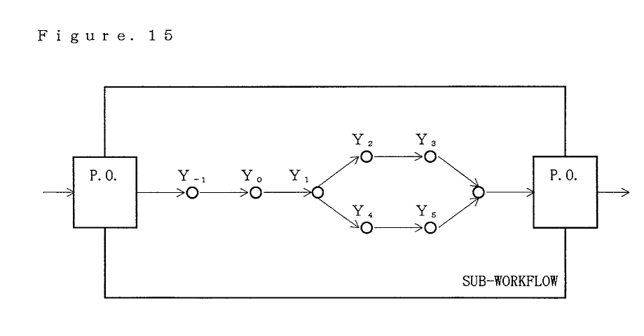

Subsequently, the manner in which the workflow system is operated when a certain system user enters a processing selection command after the system user finished his own work processing will be described below. FIG. 14 is a flowchart to which reference will be made in explaining the processing executed when the system user enters the processing selection command. FIG. 15 is a diagram showing an example of a flow of a work processing in a certain section.

Let it now be considered that data is transferred in a certain section in accordance with the sub-workflow shown in FIG. 15. Here, let us pay attention to a system user Y₀ of this section.

When the system user Y₀ enters the processing selection command after the system user Y₀ finished his own work processing, the selection part 227 displays the five selection items on the lower side of the screen of the computer terminal as shown in FIG. 13A. Referring to FIG. 14, and following the start of operation, control goes to the next decision step 52, whereat it is determined whether or not the item “NORMAL” is selected. If the item “NORMAL” is selected as represented by a YES at the decision step 52, then control goes to a step 54, whereat the selection part 227 sends information indicative of the selection of the item “NORMAL” to the section management part 225b, and the section management part 225b transfers data to the next system user Y₁ in accordance with the sub-workflow. If on the other hand the item “NORMAL” is not selected as represented by a NO at the decision step 52, then control goes to the next decision step 56, whereat it is determined by the selection part 227 whether or not the item “REJECT” is selected. If the item “REJECT” is selected as represented by a YES at the decision step 56, then control goes to a step 58, whereat the selection part 227 sends information indicative of the selection of the item “REJECT” to the section management part 225b, and the section management part 225b returns data to a preceding system user Y₋₁ based on the sub-work flow. If on the other hand the item “REJECT” is not selected as represented by a NO at the decision step 56, then control goes to the next decision step 62, whereat it is determined by the selection part 227 whether or not the item “TRANSFER” is selected. If the item “TRANSFER” is selected as represented by a YES at the decision step 62, then control goes to a step 64, wherein a list of all system users is displayed on the screen of the computer terminal. Then, when the system user Y₀ selects a predetermined system user from the list, the selection part sends information indicative of the selection of the predetermined system user to the section management part 225b, and the section management part 225b transfers data to the selected system user. If on the other hand the item “TRANSFER” is not selected as represented by a NO at the decision step 62, then control goes to the next decision step 66, whereat it is determined by the selection part 227 whether or not the item “PROCESSING DISABLED” is selected. If the item “PROCESSING DISABLED” is selected as represented by a YES at the decision step 66, then control goes to a step 68, wherein the selection part 227 sends information indicative of the selection of the item “PROCESSING DISABLED” to the section management part 225b, and the section management part 225b sends such information to the predetermined system user.

If on the other hand the item “PROCESSING DISABLED” is not selected as represented by a NO at the decision step 66, then control goes to the next decision step 72, whereat it is determined by the selection part 227 whether or not the item “PROCESSING SELECTION” is selected. If the item “PROCESSING SELECTION” is selected as represented by a YES at the decision step 72, then control goes to a step 74, whereat the window W₁ is displayed on the left-hand side of the screen as shown in FIG. 13B. Then, control goes to the next decision step 76, whereat it is determined by the selection part 227 whether or not any one of the items of “BRANCH PROCESSING”, “FORWARD-SKIP PROCESSING” and “BACKWARD-SKIP PROCESSING” in the detailed items displayed on the window W₁ is selected. If any one of the aforementioned items is selected as represented by a YES at the decision step 76, then control goes to a step 78, wherein the selection part 227 displays the window W₂ on the right-hand side of the screen according to the selected detailed item.

FIG. 13B shows an example of the window W₂ displayed when the item “FORWARD-SKIP PROCESSING” is selected. In this case, on the window W₂ is displayed a list of system users placed forward by two or more system users to which data can be transmitted in the processing order determined by the sub-workflow, i.e. system users Y₂, Y₃, Y₄, Y₅, for example. Then, when the system user Y₀ selects a predetermined system user from the above list, the selection part 227 sends information indicative of such selected predetermined system user to the section management part 225b, and the section management part 225b transfers the data to the selected system user. In this embodiment, when the system user Y₀ selects the system user Y₂, if the system user Y₂ enters a work processing end command after the system user Y₂ executed his own work processing, the section management part 225b transmits data to the next system user Y₃ in accordance with the sub-workflow as is usual. As described above, when the selection part 227 is not in use, the section management part 225b transmits data in accordance with the sub-workflow.

If the item “BACKWARD-SKIP PROCESSING” is selected at the decision step 76, then the selection part 227 displays on the window W₂ a list of previous system users skipped by more than 1 system user to which data can be transmitted next in the processing order determined by the sub-workflow. If the item “BRANCH PROCESSING” is selected at the decision step 76, then the selection part 227 displays on the window W₂ a list of system users to which data can be transferred based on the sub-workflow.

If neither of the detailed items of “BRANCH PROCESSING”, “FORWARD-SKIP PROCESSING” and “BACKWARD-SKIP PROCESSING” is selected as represented by a NO at the decision step 76, then control goes to the next decision step 82, whereat it is determined by the selection part 27 whether or not the item of “STOP” is selected. If the item “STOP” is selected as represented by a YES at the decision step 82, then control goes to a step 84, whereat the selection part 227 sends information indicative of the selection of such item “STOP” to the section management part 225b, and the section management part 225b informs all system users concerning this data that the processing of this matter is stopped.

The workflow system according to this embodiment includes the selection part which can select the next system user to which data can be transferred from each system user from a plurality of selection items displayed on the screen and the section management part which transfers data to the system user corresponding to the contents of the selection item when the selection item is selected. Thus, each system user can transmit data to the system user different from the next system user determined based on the sub-workflow only by selecting the predetermined selection item. Moreover, if the selection item includes items such as “REJECT”, “TRANSFER”, “PROCESSING DISABLED”, “BRANCH PROCESSING”, “FORWARD-SKIP PROCESSING”, “BACKWARD-SKIP PROCESSING” or “STOP”, the patterns in which data is transferred by these processing need not be included in the sub-workflow in advance. Therefore, since only the fundamental sub-workflow for transferring data when each system user normally executes a work processing is defined as the sub-workflow, it becomes very easy to create the sub-workflow.

According to this embodiment, as shown in FIG. 13B, when “FORWARD-SKIP PROCESSING” displayed on the window W₁ is selected, only the system user of the corresponding section is displayed on the window W₂ as described above, the present invention is not limited thereto, and the following variant also is possible. That is, when “BRANCH PROCESSING”, “FORWARD-SKIP PROCESSING”, “BACKWARD-SKIP PROCESSIN” are selected, the system users to which data can be transmitted can be displayed regardless of the section.

While the workflow system includes the post office and data is transferred to the post office at the section units as described above, the present invention is not limited thereto, and the following variant is also possible. That is, the post office may not be provided, and one workflow may be defined to all section on the whole, whereby data may be transferred among respective system users.

The program which executes the operation described in this embodiment is wholly or partly recorded or memorized in a portable medium such as a floppy disk or a memory apparatus such as a hard disk. The program thereof is read out by the computer and the whole of or a part of operation is executed.

As described above, according to this embodiment, since the workflow system includes the selection means for selecting the next system user to which each system user can transmit data from a plurality of selection items displayed on the screen and the management means for transferring data to the system user corresponding to the contents of the selected selection item when the selection item is selected by the selection means, each system user is able to transmit data to the system users other than the next system user determined by the workflow according to the situations. In addition, if the selection items include items such as “REJECT PROCESSING”, “SKIP PROCESSING”, “BRANCH PROCESSING”, “TRANSFER PROCESSING” or “STOP PROCESSING”, then the pattern for transferring data by these processing need not be included in the workflow in advance. Therefore, it is possible to provide the workflow system in which only the fundamental workflow may be defined as the workflow and in which the workflow can be made with ease.

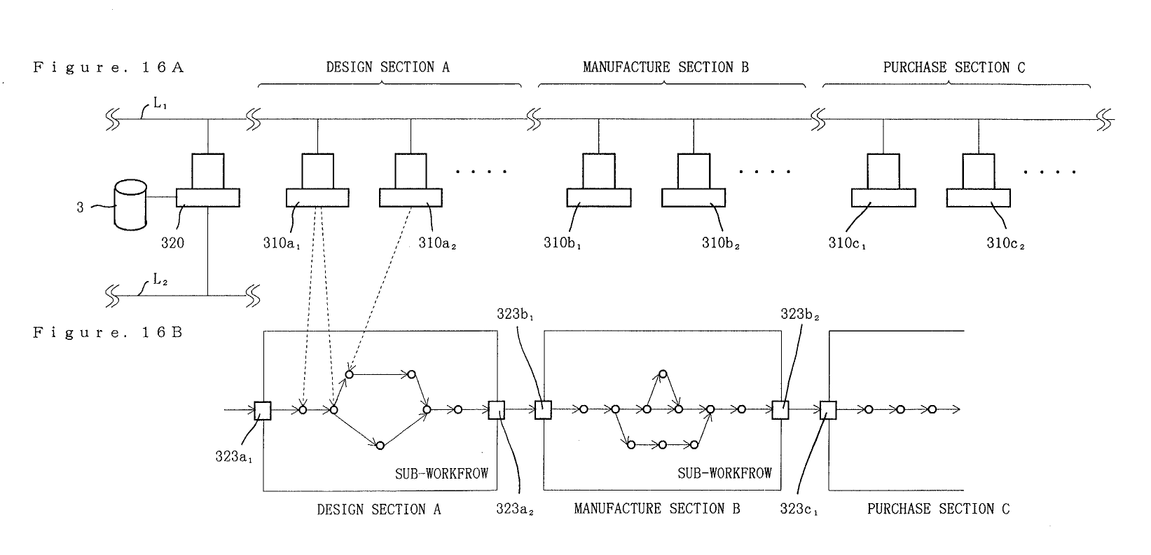

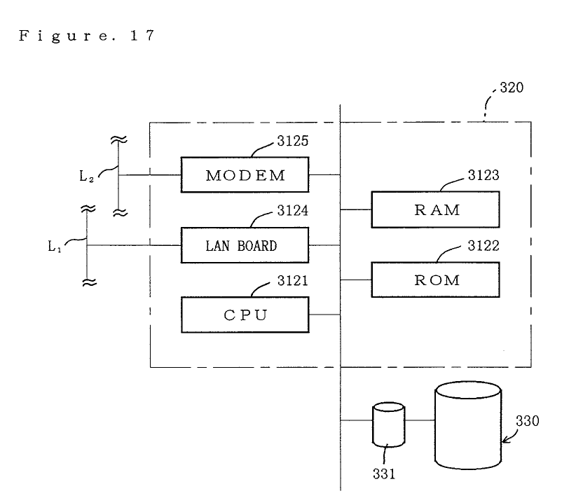

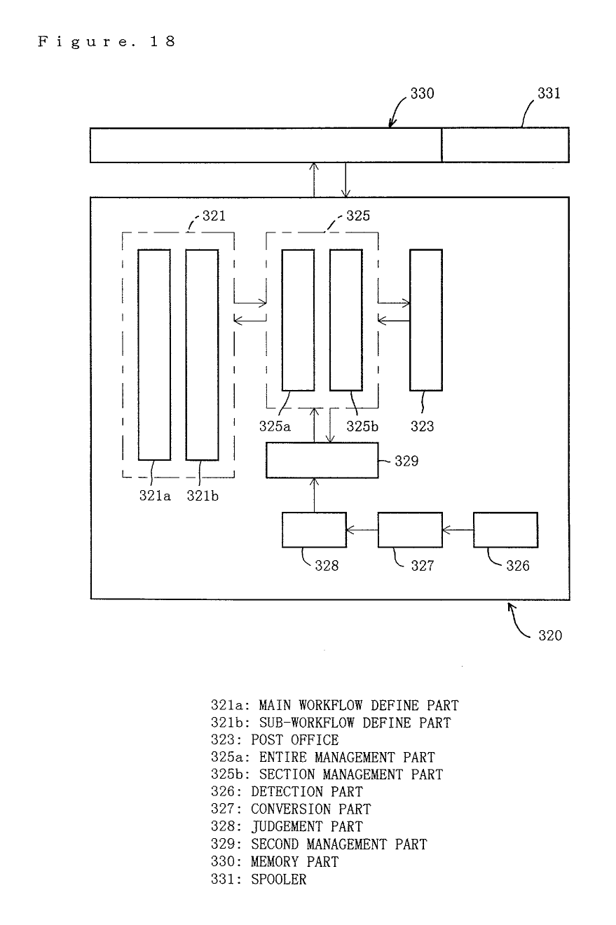

A third embodiment of the present invention will hereinafter be described with reference to the drawings. FIG. 16A is a diagram showing a configuration of a workflow system according to this embodiment. FIG. 16B is a schematic diagram showing a flow of data processing executed in each section in the workflow system shown in FIG. 16A. FIG. 17 is a schematic block diagram showing a server in the workflow system according to this embodiment. FIG. 18 is a schematic functional block diagram showing the server shown in FIG. 17. In this embodiment, let us consider the case in which when a certain company receives an order from a customer, a work processing such as ordering or making an estimation is executed by transferring document data among a plurality of system users over a plurality of sections in the company.

A memory part 330 in FIGS. 17 and 18 is disposed within the memory 3 shown in FIG. 16A. In FIG. 16A, reference numeral L₁ denotes a communication line network, and reference numeral L₂ denotes a telephone line network. A rest of arrangements in FIG. 16 is the same as that of FIG. 1.

Incidentally, elements and parts of FIG. 1 and FIGS. 3 through 11 of the first embodiment are the same as those of the third embodiment and therefore these sheets of drawings and their detailed description will be omitted. However, if necessary, with respect to these omitted sheets of drawings, the sheets of drawings of the first and second embodiments will be referred to properly.

Furthermore, in this embodiment, elements and parts having functions similar to those of the first and second embodiments are marked with corresponding reference numerals and therefore need not be described in detail.

As shown in FIG. 17, the server 320 includes a CPU (central processing unit) 3121, a ROM (read-only memory) 3122, a RAM (random-access memory) 3123, a LAN (local area network) board 3124 and a modem 3125. The ROM 3122 is adapted to store therein a variety of programs necessary for the processing done by the CPU 3121. The RAM 3123 is adapted to temporarily store therein data. The server 320 is connected through the LAN board 3124 to the communication line network L₁, and is also connected through the modem 3125 to the telephone line network L₂. The server 320 is connected to a plurality of computer terminals 310a₁, . . . , 310b₁, . . . , 310c₁, . . . through the communication line network L₁, thereby a network being configured. Also, the computer terminals 310a₁, . . . , 310b₁, . . . , 310c₁, . . . are disposed at respective sections each of which executes a predetermined work. As shown in FIG. 1B, for example, the computer terminals 310a₁, 310a₂, . . . are disposed at the design section A, the computer terminals 310b₁, 310b₂, . . . are disposed at the manufacture section B, and the computer terminals 310c₁, 310c₂, . . . are disposed at the purchase section C.

As shown in FIG. 18, the server 320 includes the workflow define part 321, the post office 323, a first management part 325, a detection part 326, a conversion part 327, a judgment part 328, and a second management part 329. The workflow define part 321 includes a main workflow define part 321a and a sub-workflow define part 321b, and the first management part 325 includes an entire management part 325a and a section management part 325b. The main workflow define part 321a is adapted to define a main workflow which determines the section for executing a work processing at every work or according to the contents of work. The sub-workflow define part 21b is adapted to define a sub-workflow which determines a flow of a work processing within a section of each work. The main workflow and the sub-workflow are memorized in the memory part 330 disposed within the memory 3 shown in FIG. 16. Incidentally, the define parts 321a, 321b, the post office 323 and the management parts 325a, 325b may be memorized in the memory part 330, and read out to the server 320 from the memory part 330 when a work processing is executed.

The entire management part 325a is adapted to transfer data among the post offices in accordance with the main workflow, and the section management part 325b is adapted to transfer data among the system users in accordance with the sub-workflow.

If the system user enters a work processing end command into the workflow system when the system user's own work processing is ended, then the section management part 325b transfers data to the next system user in accordance with the sub-workflow. The entire management part 325a is adapted to transfer data among the sections in accordance with the main workflow. The server 320 has a function to manage the progress situation of the work processing, and is able to manage the progress of the work processing that has been executed so far at every matter.

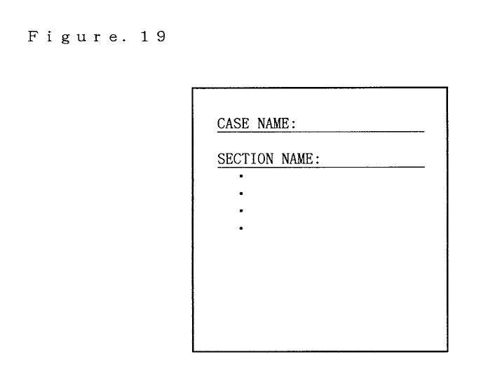

In this embodiment, when the company receives an order from other company via facsimile, the company automatically receives such order of work and enables each system user to execute a work processing. Fax data transmitted from the outside is received at the server 320 through the telephone line network L₂, and then stored in a spooler 331 which is a part of the memory area of the memory part 330 as shown in FIG. 17. Here, a fax document that is transmitted via facsimile requires a predetermined format. FIG. 19 shows an example of a front page of a fax document. As shown in FIG. 19, “title” and “section name” have to be written at predetermined positions of this front page. The most important item is “title”, and “section name” or the like need not be written so long as the sender side does not know it. Moreover, “title” requires a predetermined format. Specifically, “title” should be written in such a manner that the system users in the company can see which section to transfer the matter of the fax data. Therefore, information corresponding to a job name is obtained from the written contents of “title”, whereby a main workflow can be specified. Incidentally, on the column of “title” may be written items which reveals the type of necessary processing in each section, i.e. items corresponding to job type information.

Referring back to FIG. 18, the detection part 326 is adapted to detect that fax data is stored in the spooler 331. As the detection part 326, there can be used a kind of monitor program which is referred to as “spool daemon”. Having detected that the fax data is stored in the spooler 331, the detection part 326 supplies a signal indicative of the fact that the fax data is stored in the spooler 331 to the conversion part 327. When receiving the detection signal from the detection part 326, the conversion part 327 converts the fax data, which is a kind of image data stored in the spooler 331, into text data. To be more concrete, the conversion part 327 extracts characteristics from the fax data, effects a character recognition on the extracted characteristics by pattern matching, and then converts the fax data into the text data. The judgment part 328 is adapted to judge the contents of the matter from the title included in the text data. The second management part 329 reads out the main workflow from the memory part 330 based on the contents of the matter which has been judged by the judgment part 328, and causes the entire management part 325a to execute the main workflow thus read out. When the column of “SECTION NAME” is written, the entire management part 325a initially sends data to the section written in the column, and then sequentially transfers data from the written section to other sections in accordance with the main workflow.

An operation of the workflow system according to this embodiment will be described next.

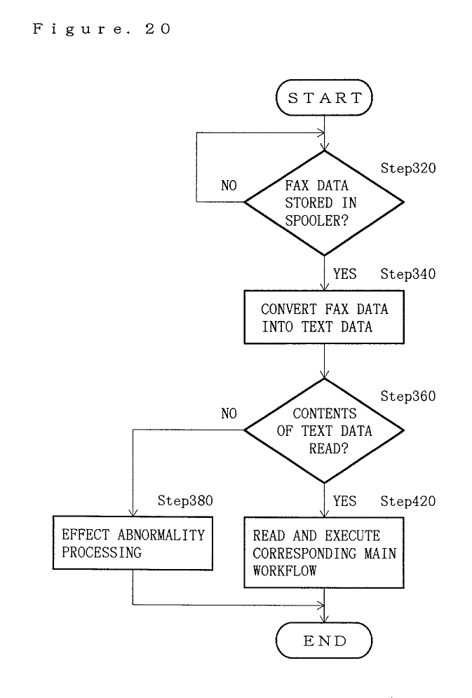

The manner in which the workflow system according to this embodiment is operated when fax data is transmitted from the outside will be described below with reference to FIG. 20. FIG. 20 is a flowchart to which reference will be made in explaining the manner in which the main workflow is operated when fax data is transmitted from the outside.

The detection part 326 is constantly monitoring the spooler 331. Referring to FIG. 20, and following the start of operation, control goes to the next decision step 320, whereat it is determined by the detection part 326 whether or not fax data is stored in the spooler 331. If the fax data is stored in the spooler 331 as represented by a YES at the decision step 320, then control goes to a step 340, whereat the detection part 326 supplies a signal indicative of the fact that the fax data is stored in the spooler 331 to the conversion part 327, and the conversion part 327 converts the fax data in to text data. Control goes to the next decision step 360, whereat the judgment part 328 deciphers the contents of the text data, and it is determined by the judgment part 328 whether or not the contents of the text data can be read. If the contents of the text data cannot be read as represented by a NO at the decision step 380, then the judgment part 328 supplies information indicative of the fact that the contents of the text data cannot be read to the second management part 329. Since it is determined at the decision step 360 that the contents of the text data cannot be read as described above, the contents of the text data cannot be read at all. In this case, the following cases also are regarded as a negative answer: the contents of “TITLE” cannot be read although a part of the contents can be read; and the contents of other portions cannot be read although the contents of “TITLE” can be read. When receiving information indicative of the fact that the contents of the text data cannot be read, the second management part 329 executes an abnormality processing at a step 380. In this case, the text data is stored in other memory means, and the server 320 displays on his screen information indicating that the received fax data is stored in a predetermined memory means because the contents of the fax data cannot be read. The reason that the text data whose contents cannot be read is stored in other memory means is that, if such text data is kept stored in the spooler 331, then the detection part 326 always detects such text data in the spooler 331, resulting in an error. If on the other hand it is determined at the decision step 360 by the judgment part 328 that the contents of the text data can be read perfectly, then the judgment part 328 supplies information indicating that the contents of the text data can be read perfectly to the second management part 329. Then, the second management part 329 reads out the predetermined main workflow from the memory part 330 based on the contents of “TITLE” deciphered at the judgment part 328, and causes the entire management part 325a to execute the predetermined main workflow (step 420).

Then, the entire management part 325a sends data to a predetermined section, e.g. design section A in accordance with the main workflow. The sub-post office 323a₁located at the input side of the design section A enters the data into the design section A. At that time, if information corresponding to the job type information is not contained in the contents of “TITLE”, then a sub-workflow defining that data is sent to the manager of the design section A is read out, and the sub-workflow thus read out is executed by the section management part 325b. If on the other hand the information corresponding to the job type information is contained in the contents of “TITLE”, then a sub-workflow corresponding to the above information is read out, and then executed by the section management part 325b. As described above, within the design section A, data is transferred to each system user in accordance with a predetermined route, and a work processing is executed. Thereafter, data is sent to other sections in accordance with the main workflow and a similar processing is executed.

In the workflow system according to this embodiment, when the fax data is sent, the fax data is stored in the spooler. If the detection part detects that the fax data is stored in the spooler, then the detection part supplies the detection signal to the conversion part, whereby the conversion part converts the fax data into the text data. Then, after the judgment part judges the contents of “TITLE” from the text data, the second management part reads out the predetermined workflow based on the contents of “TITLE”, and causes the entire management part to execute the predetermined workflow thus read out. Therefore, since the workflow system is automatically activated and operated when the workflow system receives the fax data, orders can be handled efficiently. Furthermore, since the workflow can be executed reliably without manpower, it becomes possible to reduce the number of persons.

In the above-mentioned embodiment, the workflow system can be operated by sending fax data from one section to other section in the company. In this case, since the person who transmits the fax data is the person in the company executing the same job name or the same title, the job name may be written in the column of “TITLE” on the front page of the fax document shown in FIG. 19. Also, if a data transfer route is known in advance, then job type information may be written in the column of “TITLE”.

While the workflow system is operated in response to the fax data sent thereto from the outside as described above, the present invention is not limited thereto, and the workflow system may be operated when data, e.g. electronic mail is transmitted from the outside. In the case of the electronic mail, it is possible to omit the conversion part from the workflow system.

Furthermore, while the workflow system includes the post office in which data is transferred to the post office in the section units as described above, the present invention is not limited thereto, and the post office may not be provided and one workflow may be defined on the whole to thereby transfer data among the system users. In this case, it is possible to access the workflow only by the title.

The program which executes the operation described in this embodiment is wholly or partly recorded or memorized in a portable medium such as a floppy disk or a memory apparatus such as a hard disk. The program thereof is read out by the computer and the whole of or a part of operation is executed.

As described above, according to this embodiment, when external data such as image data is sent, if the detection means detects that the external data is stored in the second memory means, then the detection means supplies the detection signal to the management means, and the management means reads out the predetermined workflow from the first memory means based on the external data thereby to cause the predetermined workflow to be executed. Thus, it is possible to provide a workflow system in which the system can automatically be activated and operated when receiving the external data. Furthermore, since the workflow can be executed reliably without manpower, it is possible to reduce the number of persons.

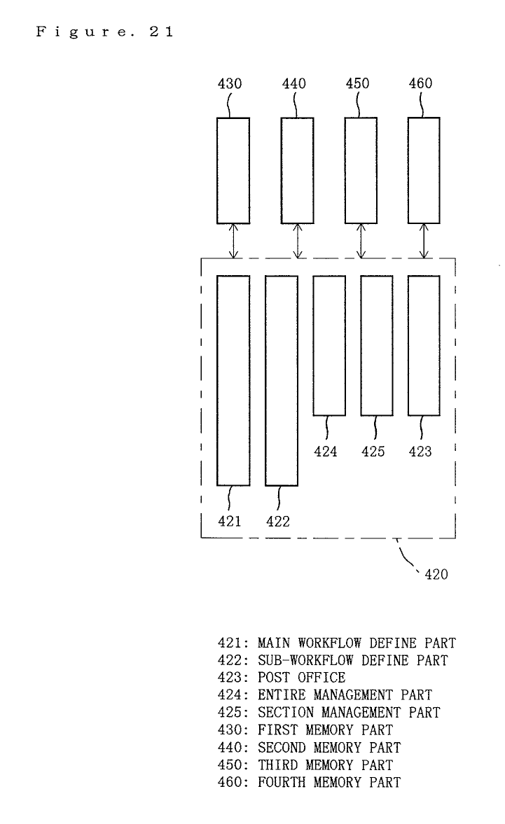

Subsequently, a fourth embodiment of the present invention will be described with reference to the drawings. FIG. 21 is a schematic block diagram of a server in a workflow system according to this embodiment. In this embodiment, let us consider the case in which document data is transferred among a plurality of system users over a plurality of sections in a certain company and a work processing such as making a written estimate is executed.

Incidentally, like elements and parts shown in FIG. 1 and FIGS. 3 through 11 of the first embodiment are the same as those of the fourth embodiment, and hence these sheets of drawings and their detailed description will be omitted. If necessary, with respect to these omitted sheets of drawings, the sheets of drawings of the aforementioned embodiments will be referred to properly.

Furthermore, in this embodiment, elements and parts having functions similar to those of the first to third embodiments are marked with corresponding reference numerals, and therefore need not be described in detail.

In FIG. 21, a first memory part 430, a second memory part 440, a third memory part 450, and a fourth memory part 460 are disposed within the memory 3 shown in FIG. 1.

A main workflow, a sub-workflow or the like are stored in the first memory part 430. The main workflow is adapted to determine the order of transferring data among the sections according to job names contained in data.

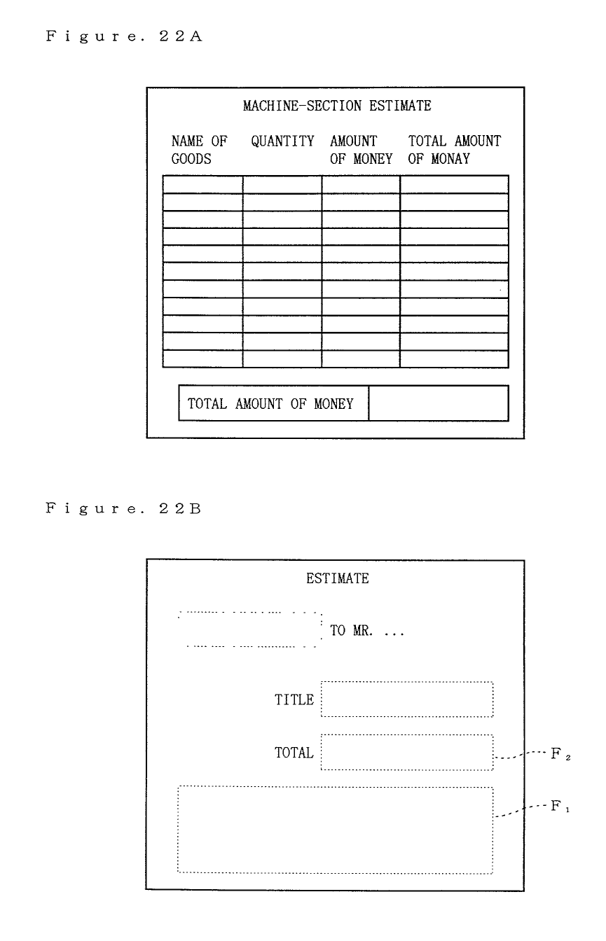

The second memory part 440 is adapted to store a variety of document forms (document format data) required according to the contents of work processing at every work processing in the form of database. For example, when a work processing of creating a written estimate is executed, formats of written estimates such as machine-section, electricity section or civil engineering-section estimates and a format of an total written estimates of machine-section, electricity section and civil engineering-section are defined in advance as document forms. FIGS. 22A, 22B illustrate examples of such document forms. The document form shown in FIG. 22A is a format of a written estimate concerning machine field. This written estimate of machine field has columns (i.e. fields) in which there are written name of goods, amount of goods, unit cost, amount of money of each of goods and total amount of money. The formats of written estimates concerning electricity field and civil engineering field are similar to that of the written estimate of machine field. The document form shown in FIG. 22B is a format of an total written estimate in which the respective written estimates such as machine-section estimate are collected. This total written estimate has a column (field) F₁ in which a sum amount of money obtained from the respective written estimates such as machine or electricity is written, and a column (field) F₂ in which a total of sum amounts of money is written. Incidentally, a cover of a written estimate may be defined as a document form.

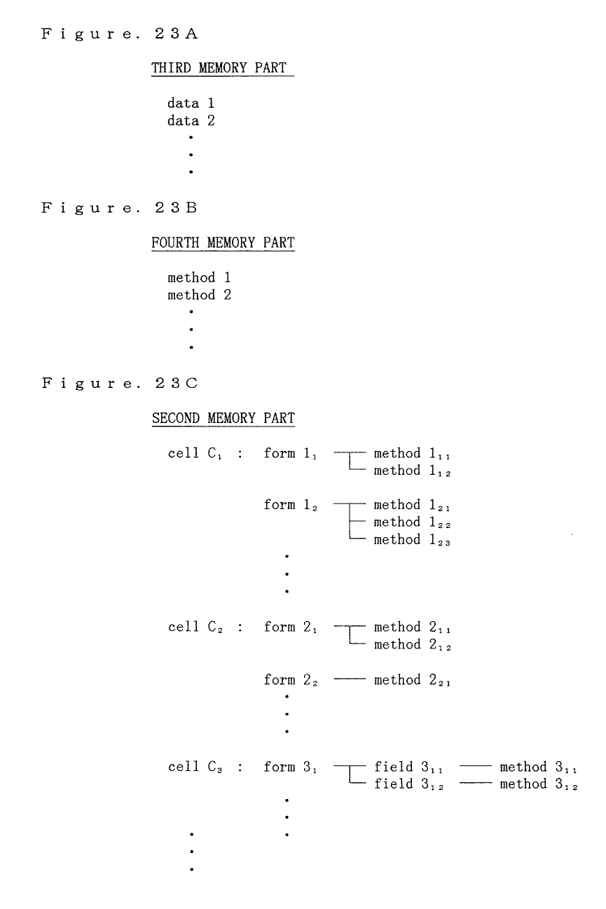

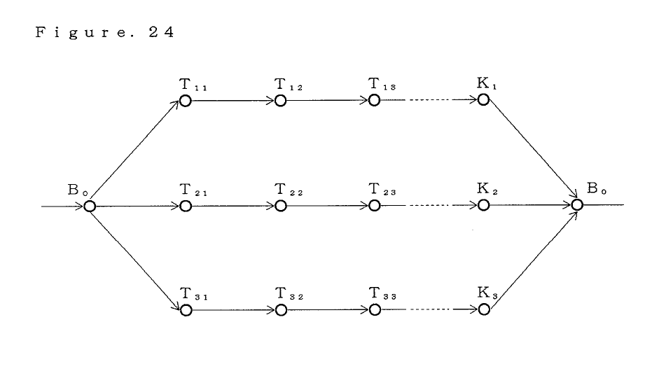

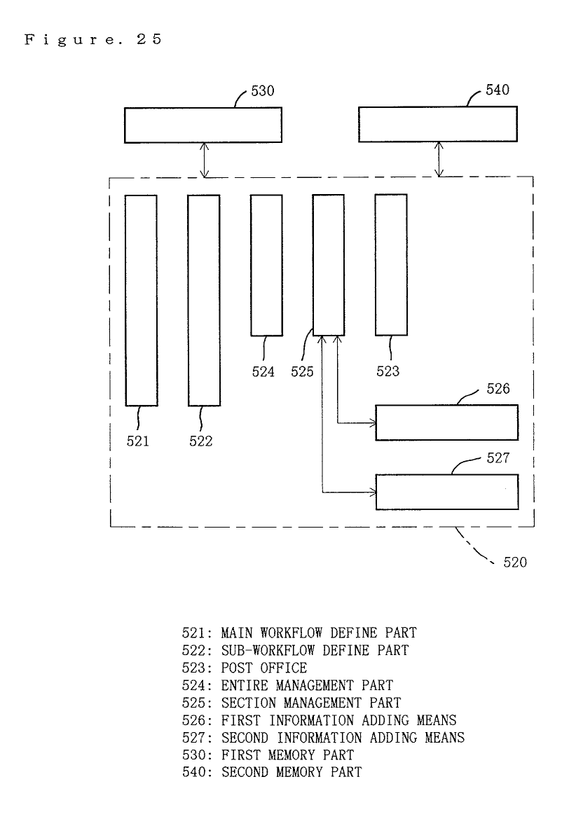

The third memory part 450 is adapted to memorize data entered by respective system users when the system users execute their work processing. These data are name of good, amount of goods, amount of money, etc., and stored in the third memory part 450 as data 1, data 2, . . . as shown in FIG. 23A. The fourth memory part 460 is adapted to store therein processing procedures (methods) which effect a predetermined processing on the data in the form of database. These methods are stored in the fourth memory parts 460 as method 1, method 2, . . . as shown in FIG. 23B. The methods are programs by which a predetermined processing is effected on the data data 1, data 2, . . . stored in predetermined addresses of the third memory part 450.

The method may describe the type of the processing that will be executed in the document form, and the method is defined at every document form or at every field in the document form. FIG. 23C shows a memory map of the second memory part 440. At every cell Cₖ (k=1, 2, . . . ), a plurality of document forms form kₙ (n=1, 2, . . . ) are memorized in the second memory part 440. The type of document form that is sent to the system user is selected according to the contents of each work processing. Then, respective document forms form kₙ are related to one or a plurality of methods methods kₙₘ (m=1, 2, . . . ). In a cell C₃, a field field 3ₙₘ in the document form form 3ₙ is related to one method method 3ₙₘ. Methods such as method kₙₘ are pointers which designate methods which are memorized in the fourth memory part 460. As this pointer, there can be used the address of the fourth memory part 460 in which that pointer is memorized.

Contents of methods will be described concretely. For example, as the method related to the machine-section estimate shown in FIG. 22A, there is a method in which data entered by the same document form by the preceding system user is written in the same column of the above document form. Moreover, there is a method in which one or a plurality of data are computed and the computed results are written in a predetermined column of the above document form. To be more concrete, an amount of money of goods is calculated by multiplying the number of goods and the unit price of goods inputted into the estimate by the preceding system user or a total amount of money concerning the machine is calculated by adding all of calculated amounts of money of each of goods. As the methods related to the total estimate shown in FIG. 22B, there are a method in which a total amount of money written in the respective estimates concerning goods such as machine is calculated and the total amount of money is written in the field F₁ of the total estimate in the form of “A SET OF MACHINE: ***”. “A SET OF ELECTRICITY: ***” or “A SET OF CIVIL ENGINEERING: ***”, and a method in which total amounts of money are added and the sum total thereof is written in the field F₂.

The section management part 425 transfers data to each system user in accordance with the sub-workflow, the section management part 425 reads out a document form corresponding to the contents of the work processing of the next system user and the method related to the foregoing document form. Then, the section management part 425 processes data in accordance with the method thus read out, and sends data indicative of processed results and the document form to each system user. Therefore, when a work processing is sent to each system user in accordance with the workflow so that each system user executes the work, a document in which data processed in accordance with the method is written in a document form corresponding to the system user's own work is automatically displayed on the screen of the computer terminal.

The entire management part 424 is adapted to transfer data among the sections in accordance with the main workflow. The section management part 425 is adapted to transfer data to each system user within each section in accordance with the sub-workflow.

An operation of the workflow system according to this embodiment will be described below.

In the workflow system according to this embodiment, let us describe the manner in which the workflow system is operated when document data and document form are transferred to the system user. FIG. 24 is a diagram showing a flow of data processing.

Here, let us consider the case that there occurs a work for making an estimate concerning the construction of a heating furnace in the design section A. In such work, a work processing flows in accordance with the sub-workflow shown in FIG. 24. Initially, data is transmitted from a general manager B₀ to a system user T₁₁ of a machine field, a system user T₂₁ of an electric field and a system user T₃₁ of a civil engineering field. Then, data is transmitted from the system user T₁₁ of the machine field to a plurality of system users T₁₂, T₁₃, . . . , a senior staff K₁, in that order, thereby creating an estimate concerning a machine field. Here, the senior staff K₁ approves the estimate concerning the machine section. Similarly, data is transferred from a system user T₂₁ of an electric field to a plurality of system users T₂₂, T₂₃, . . . of an electric field to a senior staff K₂, in that order, thereby creating an estimate of an electric field. Also, data is transferred from a system user T₃₁ of a civil engineering field to a plurality of system users T₃₂, T₃₃, . . . of a civil engineering field to a senior staff K₃, in that order, thereby creating an estimate concerning the civil engineering field. Then, when data are transferred from the senior staffs K₁, K₂, K₃ to the general manager B₀, the general manager B₀ approves the whole of the respective estimates such as the estimate of the machine field, etc.

In this case, in the work processing of the system users T₁₁, T₁₂, T₁₃, . . . , the senior staff K₁ of the machine field, the estimate of the machine field shown in FIG. 22A is defined as the document form. In the work processing of the system users T₂₁, T₂₂, T₂₃, . . . , the senior staff K₂ of the electric field, the estimate of the electric field is defined as the document form. In the work processing of the senior staff T₃₁, T₃₂, T₃₃, . . . , the senior staff K₃ of the civil engineering field, the estimate of the civil engineering field is defined as the document form. Then, in the last work processing of the general manager B₀, the total estimate shown in FIG. 22B is defined as the document form. To the document form of the system user T₁₁, T₁₂, T₁₃, . . . of the machine field, there are related the method in which data of the preceding system user is written into the document form as it is and the method in which an amount of money of goods is calculated by multiplying the number and the unit price of the goods entered by the preceding system user. To the document form of the senior staff K₁, there is related, in addition to the above-mentioned methods, the method in which a total amount of money concerning the machine field is calculated by adding a total sum of money of the goods. Similar methods are also related to the document forms of the system user of the electric field and the system user of the civil engineering field. Also, to the last document form of the general manager B₀, there are related the method in which the total amounts of money from the respective estimates are written in the field F₁ and the method in which these total amounts are added and then written in the field F₂.

Let it now be assumed that a work flows to the general manager B₀ in accordance with the sub-workflow. Then, the general manager B₀ determines the kind of construction work necessary for manufacturing the heating furnace. For example, the general manager B₀ roughly determines the contents of construction work required when the heating furnace is constructed in such a manner that a walking beam or the like is required from a machine field standpoint, a motor or the like is required from an electric field standpoint and that a foundation work is required from a civil engineering standpoint. When the general manager B₀ finishes his own work processing, the general manager Bo enters a command indicating that his own work processing is ended, thereby resulting in the status being changed.

When receiving such command, the section management part 425 stores data entered by the general manager Bo in the third memory part 450. Then, the section management part 425 recognizes the next three system users T₁₁, T₂₁, T₃₁ to whom data should be transferred in accordance with the sub-workflow, and also recognizes the contents of the work processing in the three system users T₁₁, T₂₁, T₃₁. Subsequently, at every system user, the document form corresponding to the contents of the work processing is read out from the second memory part 440, and also the method related to the document form is read out from the fourth memory part 460. Then, data indicative of the results processed in accordance with the method and the document form are sent to the system users. Thereafter, when the work processing is moved to each of the system users T₁₁, T₂₁, T₃₁, the estimate of the machine field or the like is displayed on the screen of each computer terminal. At that time, the data processed in accordance with the method is imported to the estimate. Then, each of the system users T₁₁, T₂₁, T₃₁ executes, within the range of the system user, a work processing in which name of goods, the number and the unit price of goods are written in each estimate.

When the system user T₁₁ enters a command indicating that his own work processing is finished, the section management part 425 stores the data entered by the system user T₁₁ into the third memory part 450. Then, the section management part 425 reads out a predetermined document form from the second memory part 440 according to the contents of the work processing in the next system user T₁₂. Also, the section management part 425 reads out the method related to the document form from the fourth memory part 460, and executes the method thus read out. Specifically, the data entered by the system user T₁₁ is imported to the form of the estimate of the machine section as it is. Also, the amount of money of the goods is calculated by multiplying the number of the goods and the unit price of the goods entered by the system user T₁₁, and the amount of money thus calculated is written on the left-most column of the form of the estimate of the machine section shown in FIG. 22A. Thus, when the system user T₁₂ receives a work in accordance with the workflow, the estimate made by the system user T₁₁ is displayed on the screen of the computer terminal, and the value is automatically written in the column of the amount of money. Within the range in which the system user T₁₂ is in charge, the system user T₁₂ enters name of goods, the number of goods and new additional items.

Thereafter, similarly, data is transferred to the system users T₁₃, . . . , and the work processing is executed sequentially. Then, a final estimate of the machine section in which the total amount of money concerning the machine section also is written is sent to the senior staff K₁, and the senior staff K₁ approves the estimate of the machine section.

Also, similarly, the work processing is transmitted among the system users T₂₁, T₂₂, T₂₃, . . . , the senior staff K₂ of the electricity section to thereby complete the estimate of the electricity section, and the work processing is transferred among the system users T₃₁, T₃₂, T₃₃, . . . , the senior staff K₃ of the civil engineering section to thereby complete the estimate of the civil engineering section.

When the respective senior staffs K₁, K₂, K₃ enter the commands indicating that their work processing is ended, the section management part 425 stores the data entered by the senior staffs K₁, K₂, K₃ in the third memory part 450. Then, when receiving end commands from all the senior staffs K₁, K₂, K₃, the section management part 425 reads out the document form of the total estimate from the second memory part 440. Also, the section management part 425 reads out the method related to the document form from the fourth memory part 460 and executes the method thus read out. Specifically, the sum total of money written in the respective estimates of the sections such as the machine section is imported, and the details thereof are written in the field F₁ of the form of the total estimate shown in FIG. 22B. Furthermore, the sum totals of money are added and the added total amount of money is written in the field F₂. Thus, when the general manager Bo receives the work in accordance with the workflow, the total estimate is displayed on the screen of the computer terminal, and a predetermined amount of money is written in a predetermined column based on the data that the respective system users had written. Then, the general manager Bo executes an approval processing based on such total estimate.

In the workflow system according to this embodiment, when the section management part transfers data to the next system user in accordance with the sub-workflow, the document form corresponding to the contents of the work processing of the next system user and the methods related to the document form are read out. Also, the section management part processes the data in accordance with the methods thus read out, and sends data indicative of the processed results and the document form thus read out to the next system user, whereby documents of formats which are different according to the contents of the work processing can be sent to the respective system users. In addition, the data of the results processed in accordance with the methods can be imported to the document. Therefore, each system user need not make a new document by processing data of the preceding system user unlike the related-art system, and hence the work processing of each system user can be simplified.

When the workflow system according to this embodiment is connected to an external system, there may be defined such a method in which predetermined data is imported by activating the external system. Although the method is operated only within the workflow system in the workflow system according to the related art, by such method thus defined, data can be imported from database of other external system or data of processed results may be imported by activating the application of the external system. The following method may be used in order to realize the above-mentioned method. That is, this method is such one in which a normal method is used a method and a save destination of application which activates the external system is stored in the third memory part which stores therein data. In this case, when the save destination is described in the method, the section management part reads out and executes the application program for activation of external system to thereby fetch predetermined data. Thereafter, data is processed in a predetermined manner in accordance with the method.

While the workflow system includes the post office to transfer data to the post office at the section units as described above, the following variant also is possible: The post office may not be provided like the related-art system but one workflow may be defined to every section on the whole such that data may be transferred among the respective system users.

The program which executes the operation described in this embodiment is wholly or partly recorded or memorized in a portable medium such as a floppy disk or a memory apparatus such as a hard disk. The program thereof is read out by the computer and the whole of or a part of operation is executed.

As described above, according to this embodiment, when the management means transfers data to the next system user in accordance with the workflow, document format data corresponding to the contents of the work processing of the next system user and the procedure related to that document format data are read out, and data are processed in accordance with the procedure thus read out. Also, the data of the processed result and the above-mentioned document format data thus read out are sent to the next system user, whereby the documents of different formats can be sent to respective system users according to the contents of the work processing. Also, since the data of the results processed in accordance with the procedure can be imported to the above document, each system user need not make a new document by processing the data of the preceding system user. Thus, it is possible to provide a workflow system in which a work processing of each system user can be simplified.

A fifth embodiment of the present invention will be described with reference to the drawings.

Incidentally, elements and parts shown in FIG. 1 and FIGS. 3 through 11 in the first embodiment are the same as those of the fifth embodiment, and these sheets of drawings and their detailed description will be omitted. If necessary, with respect to these omitted sheets of drawings, the sheets of drawings of the aforementioned first through fourth embodiments will be referred to properly.

Furthermore, in this embodiment, elements and parts having functions similar to those of the first through fourth embodiments are marked with corresponding reference numerals, and therefore need not be described in detail.

The ISO (International Organization for Standardization) sets a standard in the document management field according to the standard of series 9000. According to the ISO standard, when a document is distributed to persons other than a specific person, for example, it is recommended that characters for clarifying that the document is a reference document, e.g. “REFERENCE” or the like should be attached to each page of such document. Moreover, when a version of a document is updated and a document of an old version is distributed, it is recommended that characters for clarifying that the document is obsolete, e.g. “VOID” or the like should be attached to each page of the document of the old version. The reason for this is to prevent a work standard book of an old version from being mistaken as one of a latest version in use when the work standard book is used in a factory, for example.

However, according to the related-art workflow system, if a document that was made in accordance with the workflow is handled according to the ISO standard, the document should be outputted once, and a user has to stamp the printout of the document with the characters such as “REFERENCE” or “VOID”, which work is cumbersome.

Therefore, according to this embodiment, it is possible to provide a workflow system in which documents can be managed by the specification conforming to the ISO standard.

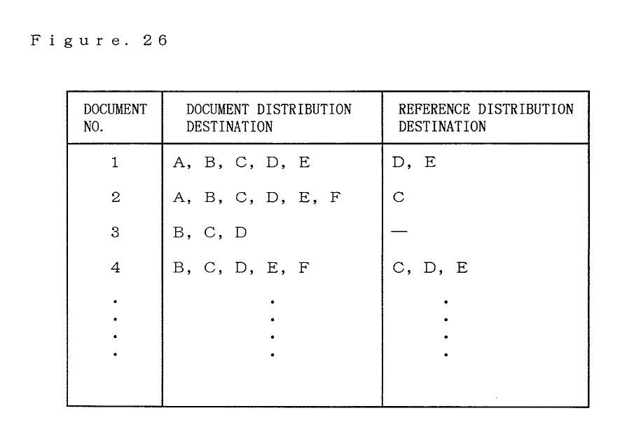

FIG. 25 is a schematic block diagram showing a server in a workflow system according to this embodiment. In this embodiment, let us consider the case in which document data is transferred among a plurality of system users over a plurality of sections in a certain company and a work processing such as signing and sanction is executed. Incidentally, in FIG. 25, a first memory part 530 and a second memory part 540 are disposed in the inside of the memory 3 shown in FIG. 1.

As shown in FIG. 25, a server 520 includes a main workflow define part 521, a sub-workflow define part 522, a post office 523, an entire management part 524, a section management part 525, a first information adding means 526 and a second information adding means 527. The main workflow define part 521 is adapted to define a main workflow which determines a section for executing a work processing at every work or according to the contents of work. The sub-workflow define part 522 is adapted to define a sub-workflow which determines a flow of a work processing within a section of each work. The main workflow and the sub-workflow are memorized in a first memory part 530. Incidentally, the respective define parts 521, 522, the post office 523, and the respective management parts 524, 525 may be memorized in the first memory part 530, and read out to the server 520 upon execution.

Also, in this embodiment, a document that was made in accordance with the workflow can be managed by the specification conforming to the standard of ISO 9000 series. Specifically, when a document is distributed to other person than a specific person, characters indicating that the document should not be handled by the specific person and that the document is a reference document can be added to the above-mentioned document. Moreover, when a version of a document is updated and a document of an old version is distributed, characters indicating that the document is obsolete can be added to the document of the old version. Here, as the characters for clarifying that the document is the reference document, there may be used “UNCONTROLLED AND/OR COPY” or “REFERENCE”, “REFERENCE MATERIAL”, “REFERENCE CHART”, “MATERIAL” or corresponding characters (these characters will hereinafter be simply referred to as “REFERENCE”). Also, as the characters for clarifying that a document is obsolete, there may be used “INVALID AND/OR OBSOLETE DOCUMENTS” or “VOID” or corresponding characters (these characters will hereinafter be simply referred to as “VOID”).

Documents needing processing are not limited to those that are finally created in accordance with the main workflow and the sub-workflow (hereinafter simply referred to as “workflow”) and may be documents approved in a predetermined manner although they are now being created. The reason for this is that the contents of these documents are allowed to be disclosed by the approval. Also, the processing for adding “VOID” is executed only for documents which conform to the ISO standard. The reason for this is that, since the workflow handles a variety of documents, the workflow can handle every document in a different manner. In this embodiment, when a workflow is defined, information indicating that a document conforming to the ISO standard is made is added to the workflow, whereby it can be judged based on the workflow by which the document is made whether or not the document conforms to the ISO standard. Incidentally, information indicating that the document conforms to the ISO standard may be added to the document as its attribute.

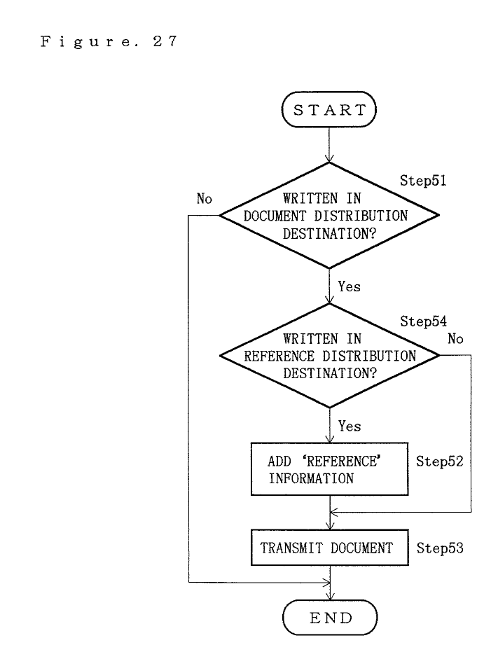

The document that was made in accordance with the workflow is memorized in the first memory part 530, for example, and distributed to a person who needs such document from a work standpoint. The transmission of this document is carried out by the section management part 525. The second memory part 540 stores therein a list in which there are listed document distribution destinations to which every document should be distributed and reference distribution destinations of the document distribution destinations to which documents with “REFERENCE” attached thereto should be distributed. Documents with “REFERENCE” attached thereto must always be distributed to persons who are not designated as the document distribution destination. FIG. 26 shows an example of a list memorized in the second memory part 540. As shown in FIG. 26, a document of a document No. 1 should be distributed to five persons of A, B, C, D, E. When the document of the document No. 1 is distributed to persons other than the above five persons, “REFERENCE” should be attached to the document of the document No. 1. Moreover, the document with “REFERENCE” attached thereto should be distributed to the persons D and E even though the persons D and E are listed on the document distribution destination list. When the document is distributed to the three persons A, B, C, “REFERENCE” need not be attached to the document. Incidentally, no document might not be distributed to persons who are not designated as the document distribution destination.

When receiving an instruction indicating that a document should be distributed to a system user, the first information adding means 526 is adapted to judge based on the list memorized in the second memory part 540 whether or not the system user is the person to which a document with “REFERENCE” attached thereto should be distributed. ID Nos. entered by the system users are used to determine whether or not the person to which a document with “REFERENCE” attached thereto should be distributed. If it is determined that the system user is the person to which the document with “REFERENCE” should be distributed, then character information representative of “REFERENCE” is added to the document. When the second information adding means 527 receives an instruction indicating that a document should be distributed, if it is determined that the document conforms to the ISO standard and that the document is the document of the old version, the second information adding means 527 adds the character information representing “VOID” to the document. In this embodiment, the version of the document is managed by version and revision. The version increases in an ascending order when the document is updated while the revision increases in an ascending order when the document is approved. It is determined by the second information adding means 527 based on the version and the revision whether or not a document is an old version.

Incidentally, when such document is outputted to the outside other than the workflow system, e.g. such document is displayed on a display, printed out as a hard copy, outputted as a floppy disk or downloaded, the first information adding means 526 and the second information adding means 527 add information representing “REFERENCE” and “VOID” to the document. In particular, in such case, the first information adding means 526 adds the information representing “REFERENCE” to persons who are designated as those to which “REFERENCE” should not be attached in the list memorized in the second memory part 540. The reason for this is to clearly display that the document is the reference document such that the document may be prevented from flowing to the outside and being misused.

An operation of the workflow system according to this embodiment will be described below.

The manner in which the workflow system is operated when a document with “REFERENCE” attached thereto is distributed will be described. If a work is executed on the workflow, then when the processing is ended at each cell, a work is instructed to the next system user in accordance with the procedure determined by the workflow. At that time, if there is a document that should be distributed, then such document also is distributed automatically. To be more concrete, if a system user a, for example, instructs the end of a predetermined processing, then a document X made therein is automatically distributed to the next system user β.

The distribution of documents is automatically carried out based on the list memorized in the second memory part 540. If a document is the document 1 as shown in FIG. 26, for example, the document 1 is distributed to the persons A, B, C, D, and E. However, the persons D and E are designated as the reference distribution destination so that the document with “REFERENCE” attached thereto is distributed to the persons D and E. When the persons D and E who received the document display and print out the received document, they can see that the character “REFERENCE” is attached to the document. As described above, the status that the character “REFERENCE” is attached to a document depends on the status of the person who receives such document.

Moreover, there occurs frequently that a document is distributed so as to be checked by other persons although a work is not yet finished on the workflow, e.g. during the document is still being created. At that time, the workflow system automatically inhibits the distribution of document. In such a case, in order to distribute a document, there is prepared a list similar to the list shown in FIG. 26 so that a distribution destination for distributing a document during the document is still being created is prepared separately. If only the reference distribution destination is designated in the list of the above-mentioned distribution destination, the character “REFERENCE” is attached to all the documents that are received at the reference distribution destination.

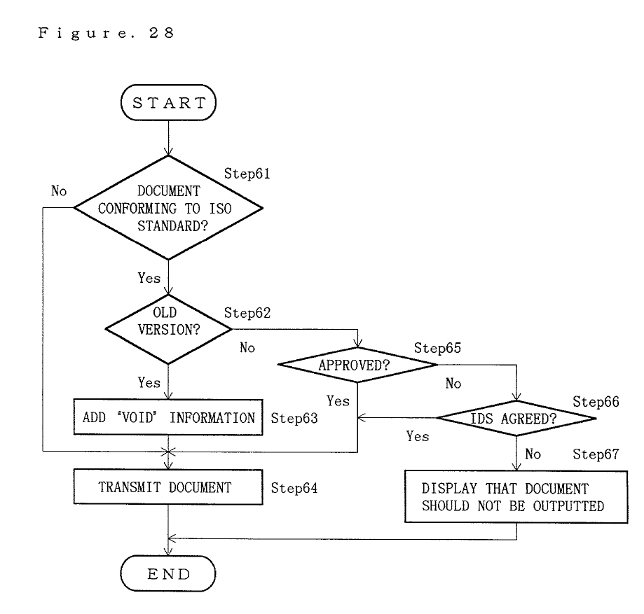

FIG. 27 is a flowchart to which reference will be made in explaining the processing executed when a document with “REFERENCE” attached thereto is distributed.

Referring to FIG. 27, and following the start of operation, when the first information adding means 526 receives a document distribution command, control goes to the next decision step 51. In the decision step 51, it is determined by the first information adding means 526 on the basis of the list stored in the second memory part 540 whether or not the system user is the person listed on the list of the document distribution destination. If the distribution destination is listed on the document distribution destination as represented by a YES at the decision step 51, then control goes to the next decision step 54, whereat it is determined by the first information adding means 526 whether or not the distribution destination is listed on the reference distribution destination. If the distribution destination is listed on the reference distribution destination as represented by a YES at the decision step 54, then control goes to a step 52, whereat character information representing “REFERENCE” is added to each page of the document. Thereafter, control goes to a step 53, whereat the first information adding means 526 sends a signal indicative of such character information to the section management part 525, and the section management part 525 transmits the document with such information added thereto to the distribution destination. If on the other hand the distribution destination is not listed on the reference distribution destination as represented by a NO at the decision step 54, then control goes to the step 53, whereat the first information adding means 526 sends a signal indicating that the distribution destination is not listed on the reference distribution destination to the section management part 525, and the section management part 525 transmits the document to the distribution destination as it is in response to the signal supplied thereto. Specifically, a document which is not attached with “REFERENCE” is displayed on the screen of the computer terminal of the person who received the document. If a NO is outputted at the decision step 51, then the distribution destination is not designated at all, and this flowchart is ended.

Therefore, as described above, when the work of the cell on the workflow is ended normally, if there is a document that should be distributed, then the first information adding means 526 determines on the basis of the list memorized in the second memory part 540 whether or not the distribution destination is the reference distribution destination, and then automatically distributes the document.

When the work of the cell on the workflow is not ended normally and a document is distributed for checking during the document is still being created, it is determined by the first information adding means 526 based on the distribution destination list of the documents being created stored in the second memory part 540 whether or not the distribution destination is the reference distribution destination. Then, based on the judged results, documents with “REFERENCE” attached thereto are distributed or are not distributed.

In the case of the documents which are still being created, if the person who transmits a document designates a person of a reference distribution destination when a document is distributed, without registering the distribution destination on the list, the reference distribution destination can be discriminated from the distribution destination by the same processing as that of FIG. 27, and hence documents can be distributed.

When a document is distributed according to the request from the reception side but not from the transmission side, if a person who wants to read the document is allowed to read the document, i.e. a person has a right to read a document, then a document with the character “REFERENCE” added thereto may be distributed. Initially, if a reading request is issued, then it is determined whether or not the person who requests to read a document has a right to read every document or that document. If the person has the right to read the document, then the document may be attached with the character “REFERENCE”, and distributed. A document with “REFERENCE” is distributed to the person who has the right to read.

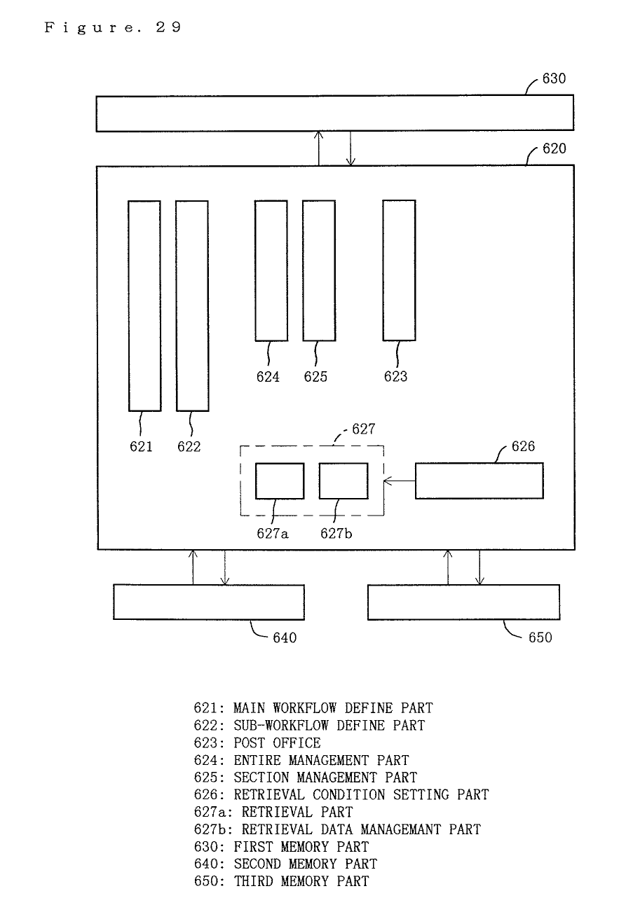

The manner in which the workflow is operated when a document with “VOID” attached thereto is distributed will be described next. FIG. 28 is a flowchart to which reference will be made in explaining the processing executed when a document with “VOID” attached thereto is distributed.

A system user enters his ID No., and enters a command for receiving a predetermined document by his own computer terminal. This is the case that the system user wants to read a specific document during working on a normal workflow or the system user wants to read a specific document during a period in which the system user is not working on the workflow.

Referring to FIG. 28, and the following the start of operation, when receiving a command, it is determined at the decision step 61 by the second information adding means 527 whether or not the document conforms to the ISO standard. In this case, it is determined whether or not the workflow that is used to create the document is a workflow used to create a document conforming to the ISO standard. If the document is not conforming to the ISO standard as represented by a NO at the decision step 61, then control goes to a step 64, whereat the second information adding means 527 sends a signal indicating that the created document is not conforming to the ISO standard to the section management part 525, and the section management part 525 transmits the document to the system user as it is. Then, a document without “VOID” attached thereto is displayed on the screen of the computer terminal of the system user.

If the document conforms to the ISO standard as represented by a YES at the decision step 61, then control goes to the next decision step 62. In the decision step 62, it is determined by the second information adding means 527 whether or not the document is a document of an old version. If the document is the document of the old version as represented by a YES at the decision step 62, then control goes to a step 63, whereat character information indicative of “VOID” is added to each page of the document. Then, control goes to a step 64, whereat the second information adding means 527 sends a signal indicating that the document is the document of the old version to the section management part 525, and the section management part 525 transmits a document with such character information added thereto to the system user. In this way, a document in which “VOID” is added to each page is displayed on the screen of the computer terminal of the system user.

If on the other hand the document is not the document of the old version but the document of the latest version as represented by a NO at the decision step 62, then control goes to the next decision step 65, whereat it is determined by the second information adding means 527 whether or not the document is approved on the workflow. In general, since a column of approval is prepared on the document, if this column is checked with a predetermine mark, then it can be easily understood that the document was already approved. If the column is not checked with the predetermined mark, then it can be easily understood that the document is not yet approved. If the document is approved as represented by a YES at the decision step 65, then control goes to the step 64, whereat the second information adding means 527 sends a signal indicating that the document is approved to the section management part 525, and the section management part 525 transmits the document to the system user as it is. Then, control is ended.

If on the other hand the document is not approved, i.e. the document is now being processed on the workflow as represented by a NO at the decision step 65, then control goes to the next decision step 66. In the decision step 66, it is determined by the second information adding means 527 whether or not the ID No. of the system user agrees with an ID No. of a person who is now processing the document. If the ID Nos. agree with each other as represented by a YES at the decision step 64, then the system user accesses the document in order to continue his own work processing, and control goes to a step 64, whereat the second information adding means 527 sends a signal indicating that the ID Nos. agree with each other to the section management part 525. Then, the section management part 525 transmits the document to the system user as it is. If the ID Nos. do not agree with each other as represented by a NO at the decision step 66, then control goes to a step 67, wherein the second information adding means 527 sends a signal indicating that the ID Nos. do not agree with each other to the section management part 525, and the section management part 525 causes the computer terminal of the system user to display such information suggesting that “Document should not be outputted because it is the document of latest version and not yet approved”.

Since the workflow system according to this embodiment includes the second memory part which stores therein the list in which the document distribution destinations to which the document should be distributed and the reference distribution destinations in the document distribution destinations to which documents with “REFERENCE” should be distributed are listed and the first information adding means for adding character information representing “REFERENCE” to the document if it is determined by the system user based on the list that “REFERENCE” should be added to the document and the document with “REFERENCE” should be distributed, when a document is distributed to persons other than a specific person, the character “REFERENCE” or the like which is used to clarify that the document is the reference document may be automatically added to each page of the document. Also, the workflow system according to this embodiment includes the second information adding means for adding the character information representing “VOID” to the document if the document conforms to the ISO standard and the document is the document of the old version, when the document of the old version is distributed, the character “VOID” which is used to clarify that the document is obsolete can be automatically added to each page of the document of the old version. Therefore, in the workflow system according to this embodiment, it is possible to manage the document reliably in the specification conforming to the ISO standard.

Furthermore, while the workflow system of this embodiment includes the post office to transfer data to the post office at the section units as described above, the present invention is not limited thereto, and it is possible for the workflow system to have no post office like the related art so that one workflow may be defined to every section on the whole to thereby transfer data among the system users.

As described above, according to this embodiment, since the workflow system includes the second memory means for storing therein the distribution destination information specifying the system user to which the document should be distributed and the information adding means for adding the information indicating that the document is not the document that should not be processed by the system user, e.g. “UNCONTROLLED AND/OR COPY” or “REFERENCE”, “REFERENCE MATERIAL”, “REFERENCE CHART”, “MATERIAL” or information representing corresponding characters to the document, when the document is distributed to the person other than the specific person, the character such as “REFERENCE” which is used to clarify that the document is the reference document can be automatically added to each page of the document. Thus, it is possible to provide the workflow system in which a document can be reliably managed according to the specification conforming to the ISO standard.

Furthermore, according to this embodiment, since the workflow system includes the memory means for memorizing the document created in accordance with the workflow at every version and the information adding means for adding information representing the old version, e.g. “INVALID AND/OR OBSOLETE DOCUMENTS” or “VOID” or the information representing corresponding characters to the document if the document is the document of the old version, when the document of the old version is distributed, the character such as “VOID” or the like which is used to clarify that the document is obsolete can be automatically added to each page of the document of the old version. Thus, it is possible to provide a workflow system in which a document can be reliably managed with the specification conforming to the ISO standard.

A sixth embodiment according to the present invention will be described with reference to the drawings.

Incidentally, elements and parts shown in FIG. 1 and FIGS. 3 through 11 of the first embodiment are the same as those of the sixth embodiment, and these sheets of drawings and their detailed description will be omitted. If necessary, with respect to these omitted sheets of drawings, the sheets of drawings of the aforementioned first to fifth embodiments will be referred to properly.

Furthermore, in this embodiment, elements and parts having functions similar to those of the first through fifth embodiments are marked with the same references, and therefore need not be described in detail.

According to the related-art system, a document name or the like of reference document (reference data) which is related to the work processing of the system user is instructed or displayed together with a document that should be sent to the system user. Therefore, the system user becomes able to effectively execute his own work processing by retrieving the reference document. However, the system user has to designate a retrieval condition which serves as a keyword of retrieval when the system user retrieves the reference document. However, in general, it is not so easy for the system user in the company to set the retrieval condition. There is then presented the problem that it takes plenty of time to retrieve the reference document. Also, although it is considered that the reference document itself is sent to each system user through the workflow system, in this case, there are required a huge amount of reference documents so that a load imposed upon the communication line network increases. As a consequence, it takes plenty of time to transmit reference documents to each system user through the communication line network.

Therefore, according to this embodiment, it is possible to provide a workflow system in which reference data can be retrieved easily and efficiently.

FIG. 29 is a schematic functional block diagram showing a server in the workflow system according to this embodiment. A first memory part 630, a second memory part 640 and a third memory part 650 in FIG. 29 are disposed in the inside of the memory 3 shown in FIG. 1.

In this embodiment, let us consider the case in which document data is transferred among a plurality of system users over a plurality of sections in a company and a work processing such as inquiry of estimate or the like is executed.

As shown in FIG. 29, the server 620 includes a main workflow define part 621, a sub-workflow define part 622, a post office 623, an entire management part 624, a section management part 625, a retrieval condition setting part 626, and a retrieval processing part 627. The main workflow define part 621 is adapted to define a main workflow which determines a section to execute a work processing at every work or according to the contents of work. The sub-workflow define part 622 is adapted to define a sub-workflow which determines a flow of work processing executed within the section of each work. The main workflow and the sub-workflow are memorized in the first memory part 630. Incidentally, the respective define parts 621, 622, the post office 623, and the respective management parts 624, 625, etc. are memorized in the first memory part 630, and may be read out to the server 620 upon execution.

When the system user finishes his own work processing and enters a command indicating that the work processing was ended, the section management part 625 transfers data to the next system user in accordance with the sub-workflow. The entire management part 624 transfers data among the sections in accordance with the main workflow. Also, the server 620 has a function to manage the progress situation of the work processing, and is able to manage the progress of the work processing at every matter.

According to this embodiment, when each system user executes his own work processing, it is possible to retrieve a reference document (reference data). The second memory part 640 stores therein a plurality of reference documents related to the work processing in the form of database. The third memory part 650 stores therein a retrieval condition that was used to retrieve a plurality of reference documents and its historical data. The reference document might be a list of purchased goods of each company, catalog, bill or the like. In this embodiment, a condition setting pattern used when a certain system user sets a retrieval condition is referred to as “retrieval pattern”. Each time the retrieval pattern is created, the retrieval patterns are numbered as “retrieval pattern 1”, “retrieval pattern 2” and so on. The retrieval condition setting part 626 is adapted to set the retrieval pattern used to retrieve necessary reference data from a plurality of reference documents memorized in the second memory part 640 with reference to historical data by the computer terminal. To be more concrete, when receiving an instruction indicating that the past retrieval patterns will be referred to from the computer terminal, the retrieval condition setting part 626 sets the picture of the computer terminal to the retrieval condition setting picture. Also, the retrieval condition setting part 626 reads out the latest retrieval pattern from the third memory part 650, and displays the latest retrieval pattern thus read out on the retrieval condition setting picture. In this case, the system user is able to correct the retrieval pattern on the retrieval condition setting picture. The retrieval pattern thus corrected increments the number of the version in an ascending order. When receiving such an instruction that the past retrieval patterns will not be referred to from the computer terminal, the retrieval condition setting part 626 sets the picture to a retrieval condition setting picture in which a retrieval condition setting column is blank. In this case, the system user sets new retrieval conditions on the retrieval condition setting picture. The retrieval condition setting part 626 sends information concerning the retrieval pattern thus set to the retrieval processing part 627.

The retrieval processing part 627 includes a retrieve part 627a and a retrieval data management part 627b. The retrieve part 627a retrieves necessary reference documents from a plurality of reference documents memorized in the second memory part 640 in accordance with the retrieval pattern set by the retrieval condition setting part 626, and displays a retrieved result on the computer terminal. The retrieve data management part 627b memorizes the retrieval data newly set by the retrieval condition setting part 626 and the corrected retrieval pattern in the third memory part 650 in association with the work processing. When the new retrieval pattern is set by the retrieval condition setting part 626, the retrieval data management part 627b determines whether or not the new retrieval pattern agrees with the retrieval pattern memorized in the third memory part 650, and memorizes only the retrieval pattern which does not agree with the memorized retrieval pattern in the third memory part 650. Each time the retrieval pattern is corrected and a new retrieval pattern is created, they are registered in the third memory part 650. Also, the retrieval management part 627 manages the numbering of the retrieval patterns and the number of versions.

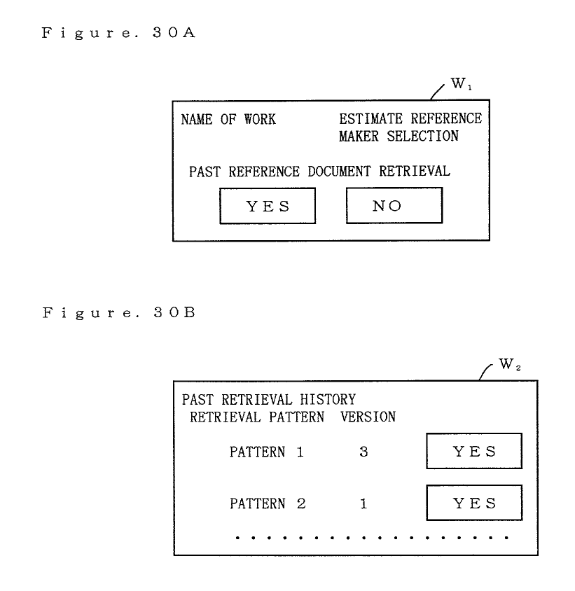

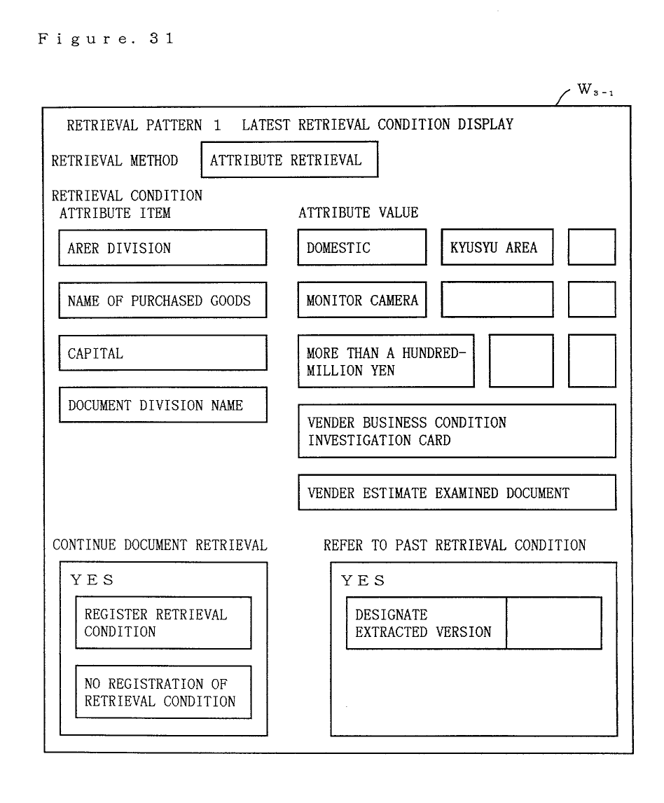

FIGS. 30A, 30B through FIG. 32 are diagrams showing examples of pictures which are displayed on the screen of the computer terminal when the retrieval is executed. FIG. 33 is a diagram showing a flow of work processing. By way of example, as shown in FIG. 33, let us consider the case in which the purchase section C selects a maker to which an inquiry is made about an estimate. Specifically, the system user Y has to select goods and a maker to which the goods will be ordered based on the estimate within an office sent in accordance with a sub-work flow. There is retrieved a reference document material such as a vendor business condition card or the like which is required when the goods and the maker are selected. FIG. 30A shows a picture W₁ that is used to designate whether or not the past retrieval patterns are referred to. In this picture W₁, there are displayed a work name on the upper side and an item of “PAST REFERENCE DOCUMENT RETRIEVAL” below the work name. In the picture W₁, “YES” represents that the past retrieval patterns will be referred to, and “NO” represents that a new retrieval pattern should be entered.

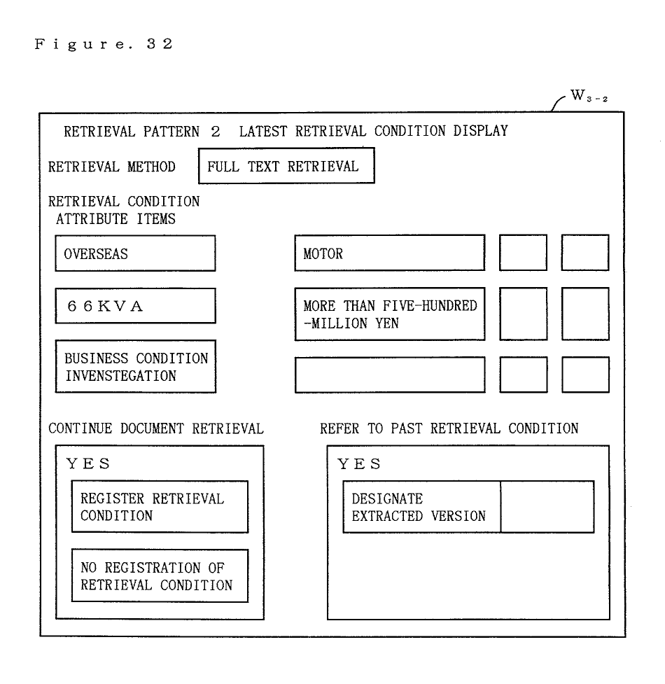

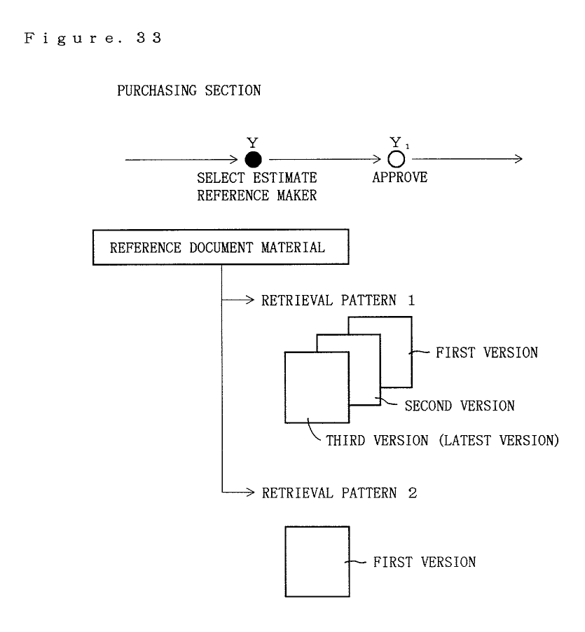

FIG. 30B shows a picture W₂ displayed on the screen of the computer terminal when the system user selects “YES” on the picture W₁. This picture W₂ is a picture which displays historical data. Here, as the historical data, there are displayed retrieval patterns which were used in the past and the number of version thereof. The number of version represents the number in which a certain retrieval pattern is corrected. When the number of version is large, this means that a retrieval pattern is a newer one. In the example of FIG. 30B, the retrieval pattern 1 has the number of version of “3”, and the retrieval pattern 2 has the number of version of “1”. When the user selects “YES” on the right-hand side of the retrieval pattern 1 on the picture W₂, as shown in FIG. 31, there is displayed a retrieval condition setting picture W₃₋₁ which displays the latest retrieval pattern 1 (of which the number of version is largest). When on the other hand the user selects “YES” on the right-hand side of the retrieval pattern 2 on the picture W₂, as shown in FIG. 32, there is displayed a retrieval condition setting picture W₃₋₂ which displays the latest retrieval pattern 2. Incidentally, a name of a user who created a document and a date in which the user created the document or the like may be displayed on the picture W₂ as historical data.

While the retrieval condition setting picture on which the latest retrieval pattern of the selected retrieval patterns is displayed is displayed when any one of the past retrieval patterns is selected on the picture W₁ as described above, the present invention is not limited thereto, and there may be displayed a retrieval condition setting picture on which the selected retrieval pattern with the highest frequency is displayed. The retrieval condition setting pictures W₃₋₁, W₃₋₂ shown in FIGS. 31 and 32 include entries of “retrieval method”, “retrieval condition”, “execute document retrieval” and “refer to past retrieval conditions”. In the entry of “retrieval method”, it is possible to designate attribute retrieval, full text retrieval or the like.

The attribute retrieval is to set an attribute value of every previously-set attribute entry for effecting a retrieval, and the full text retrieval is to set a retrieval entry used in retrieval for effecting a retrieval. In this example, the attribute retrieval is designated with respect to the retrieval pattern 1, and the full text retrieval is designated with respect to the retrieval pattern 2. When the full text retrieval is designated, as shown in FIG. 32, rectangular columns for designating retrieval entries appear in the entry of “retrieval condition”. When on the other hand the attribute retrieval is designated, as shown in FIG. 31, rectangular columns for designating attribute entries and attribute values appear in the entry of “retrieval condition”. In the attribute entry, for example, there are displayed “regional segment name”, “name of purchased goods”, “capital”, and “document segment name”. Here, “capital” refers to a capital of a maker, and “document segment name” refers to a segment name of a reference document needing retrieval. In this example, as the attribute values for “document segment name”, there are set a vender business condition investigating note and a vender estimate result compared examination document.

In the retrieval condition setting pictures W_{3-1, W}₃₋₂, if the system user enters a predetermined version number into a column of “extracted version number designation” in the entry of “refer to past retrieval condition”, the retrieval condition setting part 626 reads out the inputted version number retrieval pattern from the third memory part 650, and displays the version number retrieval pattern thus read out on the column of “retrieval condition”. Also, in the entry of “execute document retrieval”, when the system user selects “retrieval condition accession”, the retrieval condition setting part 626 sends information of the retrieval pattern set at the retrieval condition setting pictures W₃₋₁, W₃₋₂ to the retrieval processing part 627, whereby the retrieval processing part 627 registers the retrieval pattern thus sent in the third memory part 650, and executes the retrieval based on the retrieval pattern. At that time, the retrieval pattern registered in the third memory part 650 has a version number of “4”. When on the other hand the system user selects “no accession of retrieval condition”, the retrieval condition setting part 626 sends information of the retrieval pattern thus set to the retrieval processing part 627, and the retrieval processing part 627 executes a retrieval based on the retrieval pattern. At that time, the retrieval pattern is not registered. In general, when the retrieval condition of the retrieval condition setting picture is corrected, “retrieval condition accession” is selected, while when the retrieval condition of the retrieval condition setting picture is not corrected, “no accession of retrieval condition” is selected. Thereafter, when the retrieval is executed based on the retrieval pattern shown in FIG. 31, for example, the retrieval processing part 627 specifies a vender coincident with the retrieval pattern, and displays the business investigation note and the estimate result compared examination document on the screen of the computer terminal as retrieval results.

Incidentally, when “NO” is selected on the picture W₁ of FIG. 30A, a picture for designating a retrieval method is displayed on the screen of the computer terminal although not shown. For example, when the full text retrieval is designated as the retrieval method, a picture similar to the retrieval condition setting picture shown in FIG. 32 is displayed on the screen of the computer terminal. Also, when the attribute retrieval is designated as the retrieval method, a picture similar to the retrieval condition setting picture shown in FIG. 31 is displayed on the screen of the computer terminal. To be more concrete, the picture similar to the retrieval condition setting picture shown in FIG. 31 or 32 is such that the rectangular columns in the entry of “retrieval condition” are all blank, the entry of “refer to past retrieval condition” is not provided and that the system user can choose only “YES” in the entry of “execute document retrieval”.

An operation of the workflow system according to this embodiment will be described next.

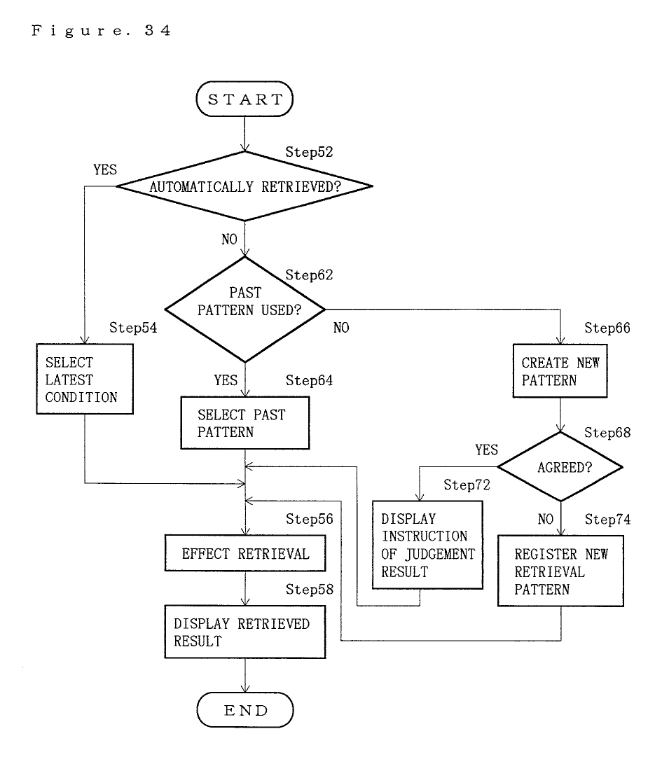

Let us consider the manner in which the retrieval is executed when a certain system user executes a work processing. FIG. 34 is a flowchart used to explain the processing executed when the retrieval is made. Let it now be considered that the system user Y belongs to the purchasing section C and selects a maker to which an estimate is referred as shown in FIG. 33.

The system user Y enters his own ID No. from his own computer terminal 10c₁ and executes a predetermined work processing. Then, the system user Y retrieves reference documents by checking an estimate within a company sent in accordance with a sub-workflow. On the screen of the computer terminal 10c₁, there are displayed “automatic retrieval” button and “manual retrieval” button. Referring to FIG. 34, and following the start of operation, control goes to the next decision step 52, whereat it is determined whether or not the system user Y presses the “automatic retrieval” button. If the “automatic retrieval” button is depressed as represented by a YES at the decision step 52, control goes to a step 54, whereat the retrieval condition setting part 626 sends information indicative of depression of the “automatic retrieval” button to the retrieval processing part 627, and the retrieval processing part 627 automatically reads out the latest retrieval condition that has been so far used and created in the same work processing from the third memory part 650. Then, control goes to the next step 56, whereat retrieval is executed by using this latest retrieval condition. Control goes to the next step 58, wherein the retrieved result is displayed on the screen of the computer terminal 10c₁.

If on the other hand the system user Y selects the “manual retrieval” button as represented by a NO at the decision step 52, then the retrieval condition setting part 626 displays the picture W₁ shown in FIG. 30A on the screen of the computer terminal 10c₁. In the decision step 62, if the system user Y selects “YES” from the entry of “past reference document retrieval” in the picture W₁ to refer to the past retrieval patterns, then the retrieval condition setting part 626 displays the picture W₂ shown in FIG. 30B on the screen of the computer terminal 10c₁. Then, when the system user Y selects a predetermined retrieval pattern from the picture W₂, the retrieval condition setting part 626 displays the retrieval condition setting picture on the screen of the computer terminal 10c₁, reads out the latest retrieval pattern of the selected retrieval patterns from the third memory part 650, and displays the latest retrieval pattern thus read out on the screen of the computer terminal 10c₁. Thus, as shown in FIG. 31 or 32, there is displayed the retrieval condition setting picture on which the latest retrieval pattern is displayed. In a step 64, the system user Y can select a desired retrieval pattern by designating the version number in the entry of “refer to past retrieval condition” displayed on the retrieval condition setting picture. Thereafter, with reference to respective retrieval conditions displayed on the retrieval condition setting picture, the system user corrects a retrieval condition by adding retrieval conditions, if necessary, and by narrowing the range of retrieval conditions. After the system user sets the optimum retrieval condition as described above, if the system user selects “retrieval condition accession”, for example, in the entry of “continue to execute document retrieval” displayed on the retrieval setting picture, then the retrieval condition setting part 626 sends information indicative of such selection of “retrieval condition accession” to the retrieval processing part 627. Then, in a step 56, the retrieval processing part 627 executes a retrieval based on the retrieval pattern set by the system user Y. Then, control goes to a step 58, whereat a retrieved result is displayed on the screen of the computer terminal 10c₁.

If the system user selects “NO” in the entry of “past reference document retrieval” in the picture W₁ at the step 62, then the retrieval condition setting part 626 displays a picture which designates a retrieval method. Then, if a predetermined retrieval method is designated, a retrieval condition setting picture corresponding to the retrieval method is displayed on the screen of the computer terminal 10c₁. In a step 66, the system user Y creates a new retrieval pattern by entering new retrieval conditions on the retrieval condition setting picture. Then, if the system user designates “YES” in “continue to execute document retrieval”, then the retrieval condition setting part 626 sends information indicative of designation of “YES” to the retrieval processing part 627. Then, it is determined by the retrieval processing part 627 at a decision step 68 whether or not the retrieval condition of the new retrieval pattern and that of the past retrieval pattern memorized in the third memory part 650 agree with each other. If the retrieval conditions of the two retrieval patterns agree with each other as represented by a YES at the decision step 68, then control goes to a step 72, whereat information indicating that the retrieval conditions of the two retrieval patterns agree with each other is displayed on the screen of the computer terminal 10c₁. Then, control goes to the step 56, whereat a retrieval is executed on the past coincident retrieval pattern. In the next step 58, the retrieved result is displayed on the screen of the computer terminal 10c₁. If on the other hand the retrieval conditions of the two retrieval patterns do not agree with each other as represented by a NO at the decision step 68, then control goes to a step 74, whereat a new retrieval pattern is registered on the third memory part 650. Then, control goes to the step 56, wherein a retrieval is executed based on the new retrieval pattern. Thereafter, control goes to the step 58, whereat the retrieved result is displayed on the picture screen of the computer terminal 10c₁. Then, control is ended.

As described above, after a retrieval with respect to reference document is executed, the system user Y selects a maker to which goods are ordered, and a work processing is ended. Then, as shown in FIG. 33, data is transmitted to the next system user Y₁ in accordance with the sub-workflow, and the system user Y₁ approves the maker selected by the system user Y.

In the workflow system according to this embodiment, when the system user enters the instruction indicating that the past retrieval pattern is referred to from the computer terminal to thereby display the historical data of the retrieval patterns and selects any one of the retrieval patterns, the retrieval condition setting part displays the retrieval condition setting picture on the screen of the computer terminal. Also, the retrieval condition setting part reads out the selected retrieval pattern from the third memory part and displays the selected retrieval pattern on the retrieval condition setting picture so that the system user can easily set the proper retrieval condition by referring to and using the past retrieval condition displayed on the retrieval condition setting picture. Thus, it is possible to execute a retrieval easily and efficiently. Moreover, when the retrieval condition pattern set on the retrieval condition setting picture is the corrected retrieval condition pattern, the retrieval processing part registers the corrected retrieval pattern in the third memory part, thereby making it possible to leave the retrieval patterns that had been used in retrieval. Thus, even when the system user is changed to a new system user, it is possible for the new system user to execute the retrieval of the same level by using the past retrieval condition patterns that had been accumulated so far.

While the retrieval condition setting part is disposed in the server as described above, the present invention is not limited thereto, and the retrieval condition setting part may be disposed at each computer terminal.

Furthermore, while the workflow system according to this embodiment includes the post office to transfer data to the post office at the section units as described above, the present invention is not limited thereto, and without the post office, one workflow may be defined to every section on the whole to thereby transfer data among respective system users.

As described above, according to this embodiment, since the workflow system includes the retrieval condition setting means for setting the retrieval condition to retrieve the necessary reference data from a plurality of reference data memorized in the first memory means from the computer terminal with reference to the historical data that had been used in the past, when the system user retrieves the reference data, the system user can refer to and use the past retrieval conditions with reference to the historical data. Thus, the system user can easily set a proper retrieval condition, and hence the system user can execute the retrieval easily and efficiently. To be more concrete, a know-how in the retrieval is accumulated, and it is possible to provide a workflow system in which even a new operator can execute a retrieval with ease.

A seventh embodiment according to the present invention will hereinafter be described with reference to the drawings.

Incidentally, elements and parts shown in FIG. 1 and FIGS. 3 through 11 of the first embodiment are the same as those of the seventh embodiment, and these sheets of drawings and their detailed description will be omitted. If necessary, with respect to these omitted sheets of drawings, the sheets of drawings of the aforementioned embodiments will be referred to properly.

Furthermore, in this embodiment, elements and parts having functions similar to those of the first through six embodiments are marked with the same references, and therefore need not be described in detail.

Electronic documents are archived systematically so that they are retrieved smoothly. As a method of archiving electronic documents, there are a method of archiving electronic documents hierarchically, a method of archiving electronic documents with attribute values, etc. As a method of giving an attribute value to a document which is archived by use of electronic media, a user has to input an attribute value at every entry or a user has to create a batch accession file, such as inputting an attribute value with respect to previously registered attribute entries of the contents of document to be archived or selecting an attribute entry from a predetermined entry list and inputting an attribute value.

When a document is archived, the user selects the attribute entry and inputs the attribute value in order to execute the retrieval smoothly. Specifically, when a user inputs an attribute entry and an attribute value for every document, the user selected the attribute entry listed on a small pop-up window or the like on the screen by scrolling or inputted the attribute value by inputting the attribute entry with a keyboard of a computer terminal.

In the workflow system, since almost all documents of the documents created on the system are retrieved by a large number of system users, when a document is archived, it is necessary to accurately input an attribute value at every attribute entry of each document.

However, it is cumbersome for the user who archives a document to give attribute values to documents to be archived. Also, there is an increasing demand that the number of entries to be inputted should be reduced as much as possible.

On the other hand, in order to execute a proper retrieval, those who execute a retrieval desire that all of attribute entries and attribute values should be given correctly.

Therefore, according to this embodiment, in order to realize conflicting demands, there is provided a workflow system and a document archiving method of a workflow system in which a document attribute entry of a document processed on a workflow can be designated automatically and an attribute value thereof can be inputted automatically.

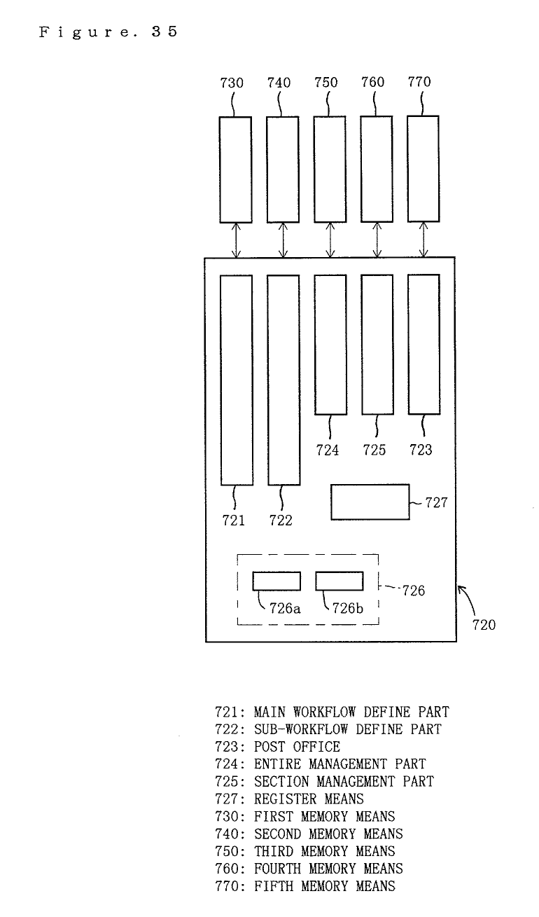

FIG. 35 is a schematic block diagram showing a server in such workflow system. In FIG. 35, a first memory part 730, a second memory part 740, a third memory part 750, a fourth memory part 760 and a fifth memory part 770 are disposed in the inside of the memory 3 shown in FIG. 1. In this embodiment, let us consider the case in which data is transferred among a plurality of system users over a plurality of sections in a company and a work processing such as creating an estimate is executed.

Also in this embodiment, similarly to the cases of the first through sixth embodiments, not substantial document data and document format data but data including job name (work processing identifier), job type information, destination name, status information, object information or the like are transmitted to each system user. Document data is memorized in the third memory part 750, and document format data is memorized in the second memory part 740. The third memory part 750 and the second memory part 740 are managed by a server 720. Only addresses of the document data and the document format data are transferred among the computer terminals, and document data and document format data required in the work processing are read out from the third memory part 750 and the second memory part 740. Thus, it seems to the system user as if his own computer terminal has document data or the like. Of information contained in data that are interchanged among computer terminals via a network, the job name represents a serial No. attached to a certain matter needing processing when such matter occurs. In general, enterprises has a predetermined rule for giving a serial NO. to the matter. Therefore, by this serial No., it is possible to know in advance a section to which the matter is transferred. The job type information represents the contents of the matter in each section. By this job type information, it becomes possible to identify the route and the sequential order in which data is transferred to a system user within the section. The destination name represents a section to which data is sent. The status information represents whether or not the work processing is executed normally. The object information represents an appended material or the like contained in the document.

As shown in FIG. 35, the server 720 includes a main workflow define part 721, a sub-workflow define part 722, a post office 723, an entire management part 724, a section management part 725, an extracting means 726 and a registering means 727. The main workflow define part 721 is adapted to define a main workflow which determines sections to execute the work processing at every work or according to the contents of the work. The sub-workflow define part 722 is adapted to define a sub-workflow which determines a workflow within the section of each work. The main workflow and the sub-workflow are memorized in the first memory part 730. Incidentally, the respective define parts 721, 722, the post office 723 and the respective management parts 724, 725 may be memorized in the first memory part 730, and read out to the server 720 upon execution.

The main workflow, the sub-workflow or the like are memorized in the first memory part 730. The main workflow determines the order of transferring data among the sections according to the job name contained in data.

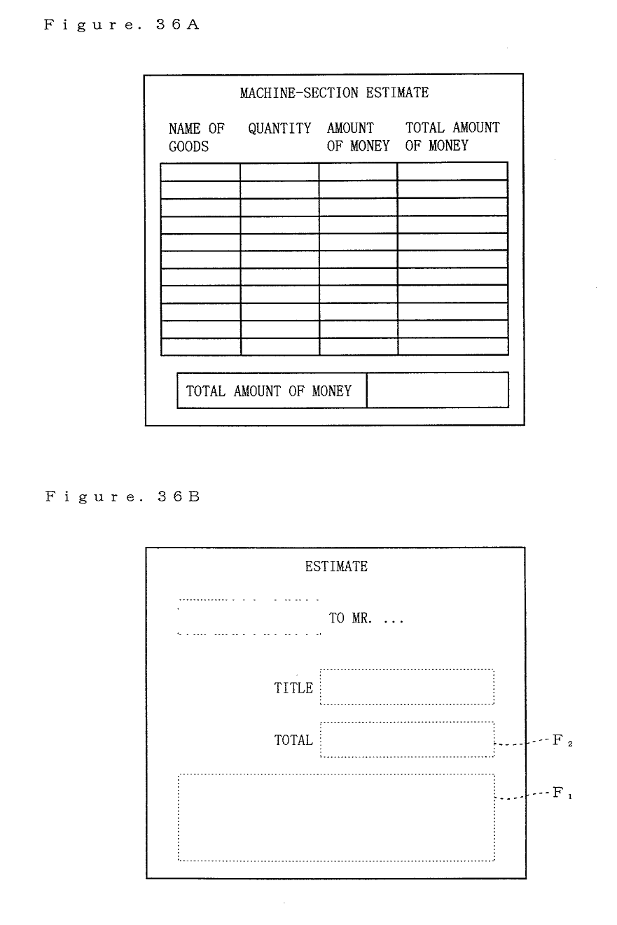

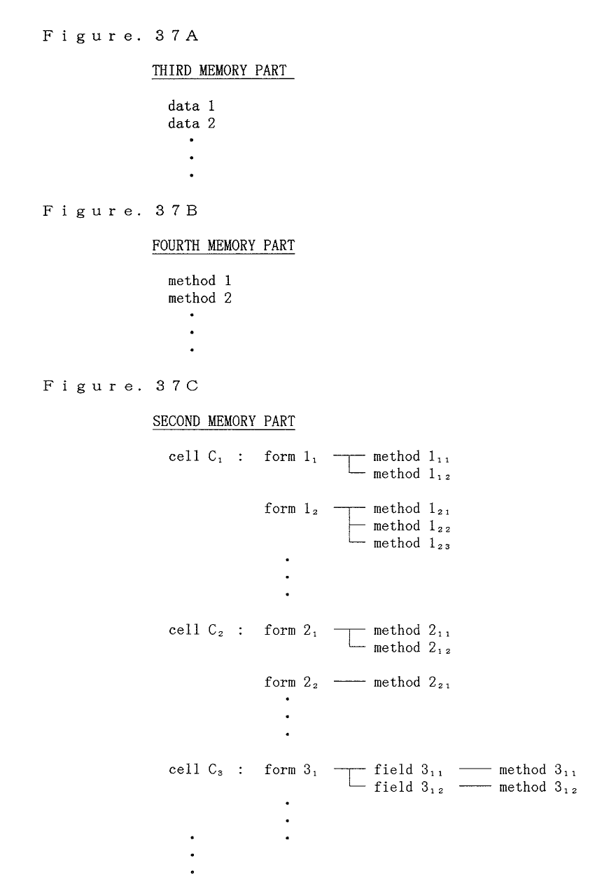

The second memory part 740 memorizes therein a variety of document forms (document format data) required according to the contents of a work processing at every work processing in the form of database. For example, when a work processing such as creating an estimate is executed, formats of estimates of a machine section, an electric section or a civil engineering section or the like and a format of an total estimate of the above-mentioned respective estimates are defined as the document forms. FIGS. 36A and 36B show examples of such document forms. The document form shown in FIG. 36A represents the format of the estimate concerning the machine section. This estimate concerning the machine section has columns in which name of goods, amount of goods, unit price, amount of money of each goods and a total amount of money are written. The formats of the estimates of the electricity and civil engineering sections are similar to that of the estimate of the machine section. Also, the document form shown in FIG. 36B is the format of an total estimate created in the collected form of the respective estimates of the machine sections, etc. This total estimate has a column (field) F₁ in which a total amount of money obtained from the respective estimates concerning the machine and electricity sections or the like are written and a column (field) F₂ in which a total sum of money of these sums of money is written. Incidentally, as the document form, there might be defined the cover of the estimate.

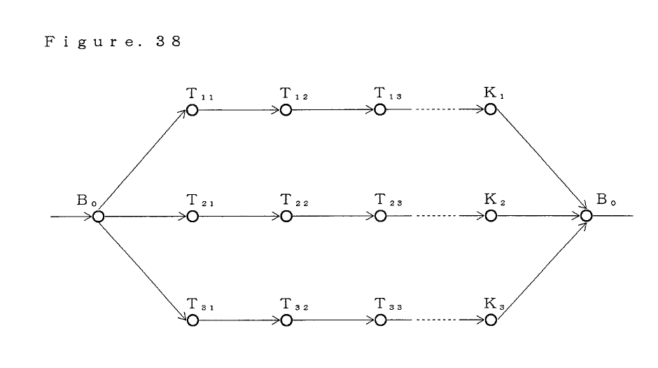

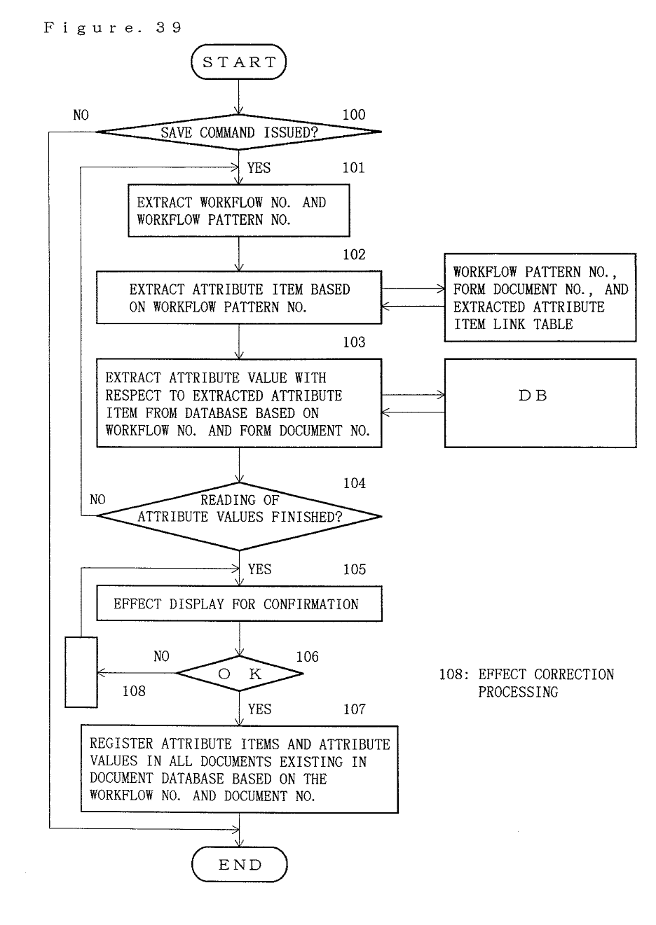

The third memory part 750 memorizes therein data entered by system users when they execute their work processing. These data are name of goods, amount of goods, amount of money, etc. written in the respective columns of the estimate of the machine section, for example, and memorized in the third memory part 750 as data 1, data 2, . . . , as shown in FIG. 37A. The fourth memory part 760 memorizes the processing procedures (methods) for processing data in a predetermined manner in the form of database. These methods are memorized in the fourth memory part 760 as method 1, method 2, . . . , as shown in FIG. 37B. The methods are programs by which data data 1, data 2, . . . , memorized in the predetermined addresses of the third memory part 750 are processed in a predetermined manner.

Moreover, the type of processing executed in the document form can be described in the method, and the method is defined at every document form or at every field in the document form. FIG. 37C shows a memory map of the second memory part 740. A plurality of document forms form kₙ (n=1, 2, . . . ) are memorized in the second memory part 740 at every cell Cₖ (k=1, 2, . . . ). The type of document form which will be sent to the system user is selected according to the contents of each work processing. Then, each document form form kₙ is related to one or a plurality of methods method kₙₘ (m=1, 2, . . . ). In the cell C₃, a field field 3ₙₘ in the document form form 3ₙ is related to one method method 3ₙₘ. The methods method kₙₘ, etc. shown in FIG. 37C are pointers which designate the methods memorized in the fourth memory part 760. As the pointers, there can be used the addresses of the fourth memory part 760 in which the methods are memorized.

The contents of the method will now be described concretely. For example, as a method related to the machine-section estimate shown in FIG. 36A, there is a method in which data entered on the same document form by the preceding system user is imported to the same column of the document as it is. Also, there is a method in which one or a plurality of data are calculated and the calculated result is imported to a predetermined column of the document form. Specifically, an amount of money of the goods is calculated by multiplying the number of goods and the unit price inputted into the estimate by the preceding system user or a total amount of money concerning the machine is calculated by adding all calculated amounts of money of the goods. As a method related to the total estimate shown in FIG. 36B, there is a method in which the total amounts of money described in the respective estimates concerning the machine, etc. are imported and these total amounts of money are written on the field F₁ of the total estimate in the format of “A SET OF MACHINE: ***” , “A SET OF ELECTRICITY: ***” or “A SET OF CIVIL ENGINEERING: ***”. Also, there is amethod inwhich these total amounts of money are added and a sum total thereof is written in the field F₂.

When the section management part 725 transfers data to the respective system users in accordance with the sub-workflow, the section management part 725 reads out a document form corresponding to the contents of the work processing of the next system user and a method related to that document form. Then, the section management part 725 processes data in accordance with the method thus read out, and sends data of the processed result and the document form to each system user. Accordingly, when a work processing is sent to each system user in accordance with the workflow in order for each system user to execute his own work, a document in which data that has been processed in accordance with the method is imported to the document form corresponding to his own work processing is automatically displayed on the screen of the computer terminal.

The entire management part 724 transfers data among the sections in accordance with the main workflow, and the section management part 725 transfers data to the respective system users within each section in accordance with the sub-workflow. When the system user finishes his own work processing, if the system user input a command indicating that his own work processing was ended, then the section management part 725 determines whether or not the work processing is ended, and then transfers data to the next system user. Also, the entire management part 724 has a function to manage the progress of the work processing based on the status of the cell, and is able to manage the progress of the work processing executed until now at every matter.

The fifth memory part 770 memorizes therein an attribute item link table in which attribute items to be extracted are defined at every document with respect to the documents defined by the main workflow and the sub-workflow (the main workflow and the sub-workflow will be simply referred together to as “workflow”). The extracting means 726 includes a first extracting means 726a and a second extracting means 726b. The first extracting means 726a is adapted to extract the attribute item with respect to each document based on the attribute item link table according to a document archive instruction of each document defined by the workflow. The second extracting means 726b is adapted to extract an attribute value of the attribute item extracted by the first extracting means 726b. The registering means 727 is adapted to register the attribute value extracted by the second extracting means 726a as attribute data of each document to be archived.

An operation of the workflow system according to this embodiment will be described below.

In this case, the manner in which document data and document form are transmitted to the respective system users in the workflow system according to this embodiment will be described. FIG. 38 is a schematic diagram showing a flow of data.

Let us consider the case in which there occurs a work for creating an estimate concerning a construction of a heating furnace in the design section A, for example. In such work, let it be assumed that a work processing flows in accordance with the sub-workflow shown in FIG. 38. Specifically, as shown in FIG. 38, initially, data is transferred from a general manager B₀ to a system user T₁₁ of a machine field, a system user T₂₁ of an electric field and a system user T₃₁ of a civil engineering field, Then, data is sequentially transferred from the system user T₁₁ of the machine field to a plurality of system users T₁₂, T₁₃, . . . , a senior staff K₁ of the machine field, thereby creating an estimate of machine section. The senior staff K₁ approves the estimate of the machine section. Similarly, a system user T₂₁ of an electric field sequentially transfers data to a plurality of system users T₂₂, T₂₃, . . . , a senior staff K₂ of the electric field, thereby creating an estimate of the electric field. Also, a system user T₃₁ of a civil engineering field sequentially transfer data to a plurality of system users T₃₂, T₃₃, . . . , a senior staff K₃ of the civil engineering section, thereby creating an estimate of the civil engineering section. Then, when data are transmitted to the general manager B₀ from the senior staffs K₁, K₂, K₃, the general manager B₀ approves the whole of the respective estimates of the machine section, etc.

In this case, in the work processing of the system users T₁₁, T₁₂, T₁₃, . . . , the senior staff K₁ of the machine field, the machine-section estimate shown in FIG. 36A is defined as the document form. In the work processing of the system users T₂₁, T₂₂, T₂₃, . . . , the senior staff K₂ of the electric field, the electric-section estimate is defined as the document form. In the work processing of the system user T₃₁, T₃₂, T₃₃, . . . , the senior staff K₃ of the civil engineering field, the civil-engineering estimate is defined as the document form. Then, in the last work processing of the general manager B₀, the total estimate shown in FIG. 36B is defined as the document form. To the document form of the system users T₁₁, T₁₂, T₁₃, . . . , are related the method in which data inputted by the preceding system user is imported as it is and the method in which an amount of money is calculated by multiplying the number of goods and the unit price inputted by the preceding system user, etc. To the document form of the senior staff K₁, there is related, in addition to the abovementioned methods, the method in which a total sum of money concerning the machine field is calculated by adding all total amounts of money of the goods. Similar methods are related to the document forms of the system users of the electricity field and the civil engineering field. Moreover, to the last document form of the general manager B₀, there are related the method in which total amounts of money are imported from the respective estimates and written in the field F₁ and the method in which these total amounts of money are added and then written in the field F₂, etc.

Let it now be assumed that a work flows to the general manager B₀ in accordance with the sub-workflow. Then, the general manager B₀ determines constructions necessary for manufacturing the heating furnace. When the heating furnace is built, for example, the general manager B₀ determines the contents of the construction roughly such that a waking beam, etc., are required from the standpoint of the machine section, a motor, etc., are required from the standpoint of the electricity section, and a base foundation, etc., are required from the civil engineering standpoint. Having finished his own work processing, the general manager B₀ enters a command indicating that his work processing was finished, whereby the status is changed.

When receiving such command, the section management part 725 stores the data inputted by the general manager Bo in the third memory part 750. Then, in accordance with the sub-workflow, the section management part 725 recognizes the three system users T₁₁, T₂₁, T₃₁ to which data should be transmitted next, and also recognizes the contents of the work processing in the three system users T₁₁, T₂₁, T₃₁. Subsequently, the section management part 725 reads out the document forms corresponding to the contents of the work processing at every system user from the second memory part 740, and also reads out the methods related to the document forms from the fourth memory part 760, thereby resulting in the methods being executed. Then, the section management part 725 sends data of the results processed in accordance with the methods and the document forms to the system users. Thereafter, when the work processing flows to the respective system users T₁₁, T₂₁, T₃₁ in accordance with the workflow, the estimates of the machine sections, etc., are displayed on the screens of their computer terminals. At that time, data that have been processed in accordance with the methods are imported to these estimates. Then, each of the system users T₁₁, T₂₁, T₃₁ executes a work processing in which a name of goods, the amount of goods and the unit price are written in his estimate within the range of his own work.

When the system user T₁₁ inputs the command indicating that his own work processing is ended, the section management part 725 stores data entered by the system user T₁₁ into the third memory part 750. Then, the section management part 725 reads out a predetermined document form from the second memory part 740 according to the contents of the work processing in the next system user T₁₂. Also, the section management part 725 reads out the method related to that document form from the fourth memory part 760, and executes the method thus read out. Specifically, the data that the system user T₁₁ has entered is imported to the form of the estimate of the machine section as it is. Also, the amount of money of the goods is calculated by multiplying the amount and the unit price of the goods inputted by the system user T₁₁, and the amount of money thus calculated is written in the leftmost column of the form of the machine-section estimate shown in FIG. 36A. Thus, when the system user T₁₂ receives a work in accordance with the workflow, the estimate created by the system user T₁₁ is displayed on the screen of the computer terminal, and the value is automatically written in the column of the amount of money. The system user T₁₂ inputs the name of goods, the amount of goods and new additional items within the range of his own work.

Thereafter, similarly, data is transferred to system users T₁₃, . . . , and a work processing is executed sequentially. Then, a final estimate of the machine section in which the total amount of money concerning the machine was written is sent to the senior staff K₁, and the senior staff K₁ approves the estimate of the machine section.

Also, in a like manner, a work processing is transferred among the system users T₂₁, T₂₂, T₂₃, . . . , the senior staff K₂ of the machine section, thereby resulting in the electricity-section estimate being completed, and a work processing is transferred among the system users T₃₁, T₃₂, T₃₃, . . . , the senior staff K₃ of the civil engineering section, thereby resulting in the civil engineering-section estimate being completed.

Subsequently, when the senior staffs K₁, K₂, K₃ input commands indicating that their own work processing was ended, the section management part 725 stores the data inputted by the senior staffs K₁, K₂, K₃ into the third memory part 750. Then, receiving the end command from all of the senior staffs K₁, K₂ and K₃, the section management part 725 reads out the document form of the total estimate according to the contents of the work processing at the general manager B₀ from the second memory part 740. Also, the section management part 725 reads out the method related to the document form from the fourth memory part 760, and executes the method form thus read out. Specifically, the section management part 725 reads out the total amounts of money from the respective estimates of the machine-section, etc., and writes the details of the total amounts of money in the field F₁ of the form of the total estimate shown in FIG. 36B, and also writes an added results of those amounts of money in the field F₂. Thus, when the general manager B₀ receives a work in accordance with the workflow, the total estimate is displayed on the screen of the computer terminal, and predetermined amounts of money are automatically written in the predetermined columns based on the data that have been written by the respective system users. Then, the general manager B₀ executes an approval processing based on such total estimate.

In the workflow system according to this embodiment, when the data is transferred to the next system user in accordance with the sub-workflow, the section management part reads out the document form corresponding to the work processing of the next system user and the method related to such document form and processes the data in accordance with the method thus read out. Then, the data of the processed result and the document form thus read out are sent to the next system user, whereby documents of different formats can be sent to the respective system users according to the contents of the work processing. In addition, the data of the results processed in accordance with the methods can be imported to the documents as it is. Therefore, it becomes unnecessary for the system users to create new documents by processing data inputted by the preceding system user unlike the related-art system. Hence, a work processing of each system user can be simplified.

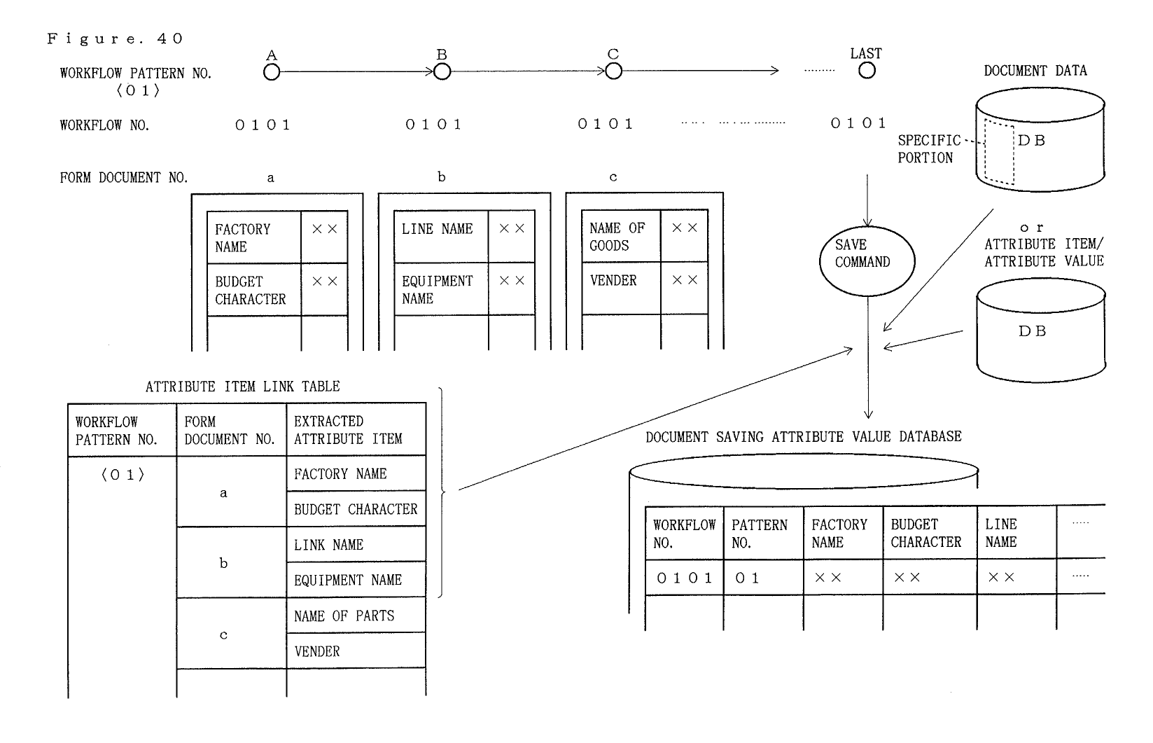

FIG. 39 is a flowchart to which reference will be made in explaining the manner in which the last system user saves a document that is processed by the workflow system.

Initially, referring to FIG. 39, and following the start of operation, control goes to the next decision step 100, whereat a specific work is ended, and it is determined whether or not the system user issued a command indicating that documents should be saved on the workflow. The documents to be saved are the whole or part of the documents processed by the workflow. If a No is outputted at the decision step 100, then control is ended. If a YES is outputted at the decision step 100, then control goes to a step 101, whereat a workflow pattern No. and a workflow No. are extracted. The workflow pattern No. is a pattern No. used when the workflow is defined and set. The workflow No. is a unique No. which is given when the workflow is used in a certain work. Incidentally, the decision at the step 100 and the extraction at the step 101 are carried out by the first extracting means 726a.

Subsequently, control goes to a step 102, the first extracting means 726a extracts the attribute item based on the workflow pattern No. In this case, the first extracting means 726a extracts the attribute item with reference to the extracted attribute item link table which is previously determined based on the relationship between the extracted workflow pattern No. and a form document No.

This link table defines a relationship among the workflow pattern No., the form document No., and the attribute item extracted from the form document. If there occurs the save command at the step 100, then the first extracting means 726a extracts the form document No. for extracting the attribute value and the attribute item based on the workflow pattern No. at the step 101. Incidentally, the form document No., together with the workflow pattern No. and the workflow No., has been extracted already.

Then, control goes to a step 103, whereat the second extracting means 726b extracts the attribute value concerning the extracted attribute item from the database based on the workflow No. and the form document No.

The manner in which the attribute value is extracted from the database is not limited to the above-mentioned manner, and the following variants also are possible. That is, of the document data in the document database, if the attribute item that is desired to be registered or that should be registered as the attribute value is partly set to the form format within the document format in advance, then the attribute value may be extracted by retrieving only a specific portion in the document data, i.e. the form format. Alternatively, attribute values concerning the attribute items that are desired to be registered or should be registered as the attribute values may be stored in another database in advance, and extracted from another database.

To be more concrete, as the method of retrieving the form format, there may be used such a method in which attribute values are extracted from a database that is made by a general-purpose spreadsheet software or the like. At that time, the attribute value is extracted from the data in that software.

In general, in the workflow, since the spreadsheet software is used a fixed format portion which is previously created at a specific area of the form document and data concerning the attribute item necessary for the retrieval in that area is inputted, the attribute value is extracted from that portion.

Moreover, as the method for storing the attribute value in another database, there may be used such a method that, when the processing at each cell is ended, only the attribute value concerning a predetermined attribute item is progressively stored in the database.

If documents to be saved are plans of a certain project, for example, then a person who checked the documents finally, or a person who confirmed the end of the project or the like registers and saves each document in the database. Although predetermined attribute items are previously determined such that the saved document can be retrieved later, the save document is processed on the workflow so that the attribute values, which are the contents of data such as a type of document, a kind of document, a budget No., or a budget segment were inputted already. Accordingly, it is possible to read out the attribute values of the attribute items from the specific portion within the document data of the database or another database.

Then, control goes to the next decision step 104, whereat it is determined whether or not the attribute values of all attribute items are read out. If a YES is outputted at the decision step 104, then control goes to a step 105, wherein the attribute values are displayed for confirmation. Then, control goes to the next decision step 106, whereat it is determined whether or not the attribute values are registered as they are. If a “YES” is outputted at the decision step 106, then control goes to a step 107, whereat the attribute values concerning the attribute items are registered on all documents existing in the document database, and the documents are archived. At that time, there are registered the attribute items and attribute values with respect to respective documents.

If the attribute values displayed for confirmation are not suitable as represented by a NO at the decision step 106, then control goes to a step 108, whereat the attribute values are corrected. Then, control goes back to the steps 105, 106, whereat the corrected attribute values are confirmed again.

If all the attribute items are not retrieved and all the attribute values are not read out as represented by a NO at the decision step 104, then control goes back to the step 101, and the step 101 and the following steps are repeated one more time.

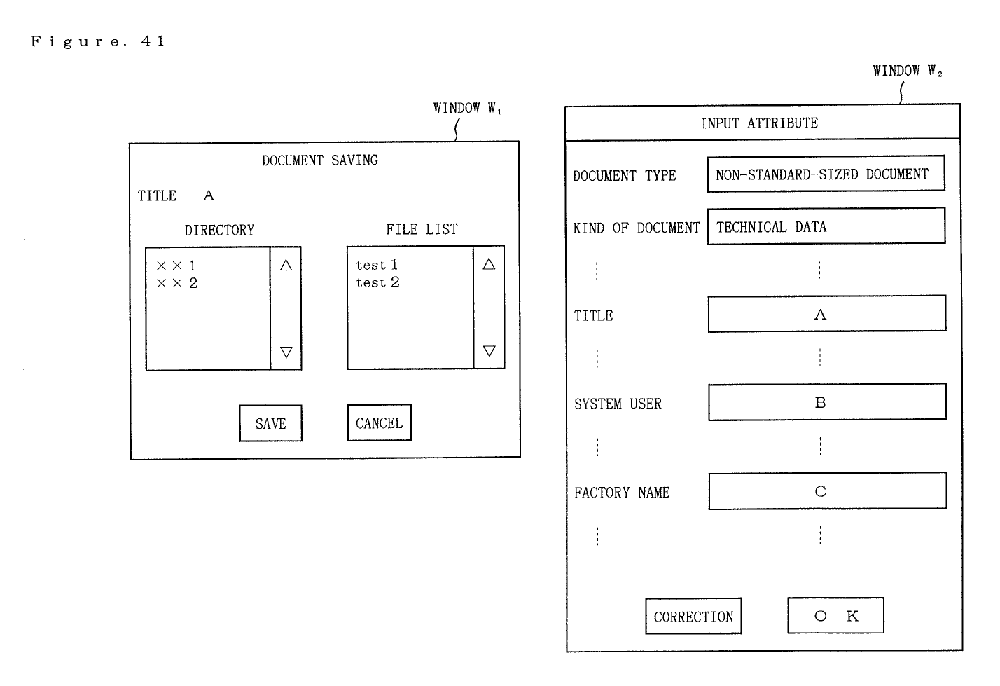

FIG. 40 is a diagram used to explain the abovementioned save work in the processing of the workflow. In FIG. 40, cells are shown in a simplified form in which there is no distinction between the main workflow and the sub-workflow. By way of example, let us consider the case in which various kinds of form documents of workflow No. 0101 with respect to a certain workflow pattern No. <01> are processed on the cell and saved finally.

In a cell A, a form document a is processed, and data concerning a plant name and a character of budget are determined and inputted as attribute items to be registered. In a cell B, a form document b is processed, and a line name and a name of equipment are determined and inputted. In a cell C, a form document c is processed, and names of parts and a company from which parts are purchased are determined and inputted. As described above, the workflow No. 0101 is processed on the system, and then saved in a certain cell finally.

The attribute items correspond to the fields defined as the document forms of each document, and the attribute values are inputted in the fields as data as shown in the example of the picture shown in FIG. 36B.

If the save command is issued in the last cell, then the attribute item link table is referred to. Most of the save command is issued as the last processing such as the end of project. In the attribute item link table that is referred to, the attribute items to be extracted with respect to the workflow pattern No. <01> are determined at every form document. The attribute items of each form document are extracted based on the attribute item link table. Then, when the attribute values of the attribute items thus extracted are extracted, the attribute values might be extracted from the document data database (DB) or another data base, i.e. attribute item/attribute value database (DB) as described above.

The reason that the attribute item is defined at every document No. in the attribute item link table is to enable the workflow system to obtain reliable attribute values with reference to a document that has substantially no possibility that the attribute value will be varied.

Then, the extracted attribute values are separately registered on the attribute value database (DB) for saving documents as data of attribute items and attribute values which are linked to the document saving database. The attribute value database is provided at each of the documents a, b, c of the same workflow No. or the like. Also, since the same attribute item and the same attribute value are given to each document, the document can be retrieved accurately. Accordingly, the attribute items and the attribute values thereof can be automatically given to the respective documents.

FIG. 41 shows examples of pictures displayed on the screen of the computer terminal when data concerning the document to be saved are displayed finally for confirmation.

A WINDOW 1 shows a picture instructing that a document is registered and saved, and a WINDOW 2 shows a picture on which the attribute item and the attribute value of the retrieved document are displayed. This display corresponds to the step 105 shown in FIG. 39.

If there are attribute values which are blank with respect to the attribute items on the picture, then such attribute values are not inputted.

In the WINDOW 1, when a case name A is saved and registered in a specific directory as a file, if a system user depresses a save button on the picture, then a register and save command is executed.

Since the attribute values are displayed with respect to a variety of attribute items on the WINDOW 2, the system user can easily confirm them. If there is an incorrect attribute value, then the system user can correct such incorrect attribute value by depressing a correct button. If the system user confirms that the attribute values are correct and clicks an OK button, then the attribute items and the attribute values are determined. Then, the document with the determined contents is registered when the system user clicks the save button on the WINDOW 1.

The attribute data concerning the document is extracted from the database by activating the document save command of the cell which automatically gives the attribute, the extracted attribute data is given as the attribute of each document, the status of the cell is varied, and the work processing is ended.

Incidentally, there is a demand of saving a document of paper or the like as image data. In this case, if the workflow No. which is desired to be related to the document data is employed as a key, then the attribute value of the attribute item of the related form document No. can be displayed in the form of a picture (picture is created in advance) by the workflow No., the form document No., and the attribute item link table. According to the above arrangement, attribute values of related documents that are desired to be inputted by a scanner and registered can be registered easily.

According to this embodiment, while the workflow system includes the post office to transfer data to the post office at the section units as described above, the present invention is not limited thereto, and without the post office, one workflow may be defined to every section on the whole to thereby transfer data among the system users.

As set forth above, according to this embodiment, since the attribute items for saving and registration and the attribute values of the attribute items are automatically given to each document processed by the workflow, the document can be quite easily saved and registered in the workflow system, and the attribute items and the attribute values can be registered accurately.

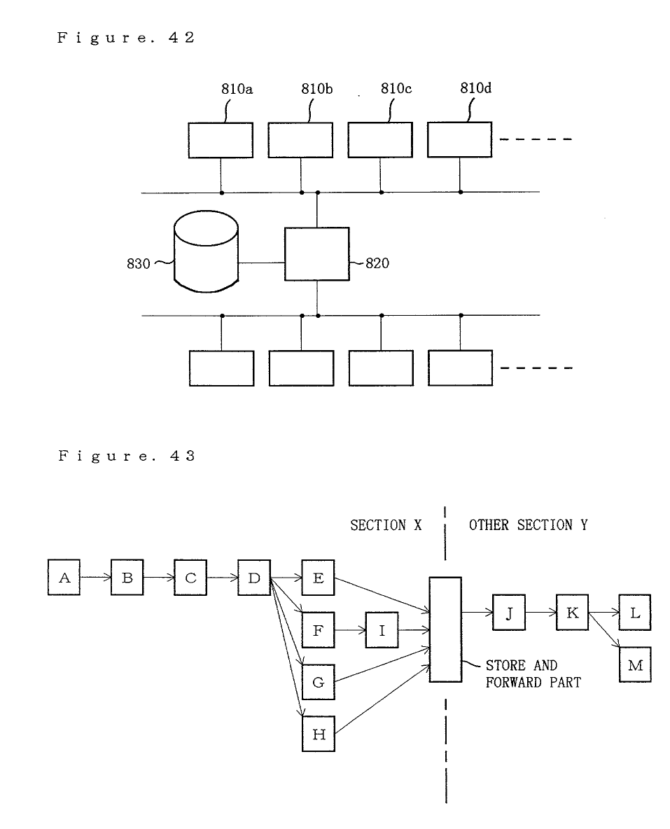

An eighth embodiment according to the present invention will hereinafter be described with reference to the drawings. FIG. 42 is a schematic block diagram showing a document transfer system according to this embodiment. In this embodiment, let us consider the case in which a document for sanction is circulated to a plurality of system users over a plurality of sections in a company.

In such a document transfer system, as shown in FIG. 42, a plurality of computer terminals 810a, 810b, 810c, 810d, . . . , a server 820 and a memory part 830 are connected, thereby resulting in a computer network being configured. By using a predetermined computer terminal, each system user inputs his own ID No., creates a new document, or displays a document sent to the system user on the screen of the computer terminal and processes the displayed document in a predetermined manner. At that time, the system user can execute an updation such as correction of document or addition of attached materials.

In the memory part 830, there are memorized a transfer destination description table in which a corresponding relationship among information concerning a document, a system user who processes the document this time and the next system user to which the data is transferred is described. The server 820 is included in the system user described in the transfer destination description table. It is possible to designate not only one system user to which the document is transferred but also a plurality of system users. As a consequence, it becomes possible to transfer document data to a plurality of system users respectively. The transfer destination description table is created such that it may be finally transferred to the server 820 without fail even though document data is initially transferred from any system user within one section, or document data is branched and transferred to a plurality of system users in somewhere of the processing. Information concerning a document might be information representing the contents of the document, such as a document of an electricity field or a document of a civil engineering field. Also, when an attached material is added to the document, information indicative of the presence or absence of the attached material also is included in the above-mentioned information.

When each system user enter a command indicating the transfer of document data by a predetermined computer terminal, the server 820 extracts information concerning a document and information concerning a system user of such document from the document data, decides a system user to which the document data is transferred based on the transfer destination description table, and sends the document data to the system user of the transfer destination by using the computer network. Here, the server 820 extracts the information concerning the system user based on the ID No. on the computer network of that system user. Also, when one document data is branched and transferred to a plurality of system users within one section, the server 820 gathers these finally collected document data into one data. Then, document data is interchanged among different sections via the server 820.

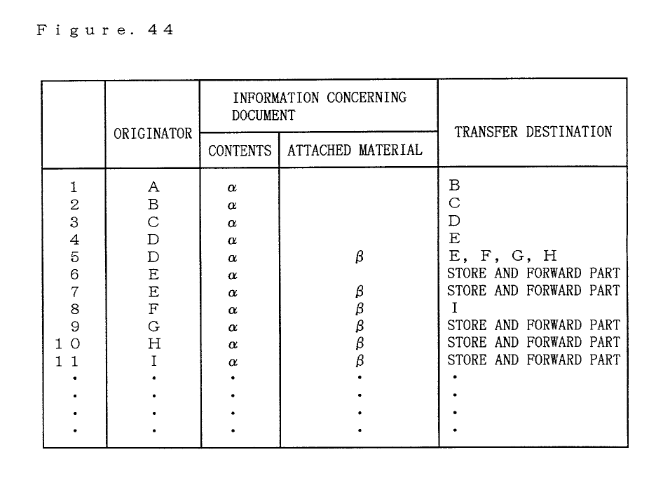

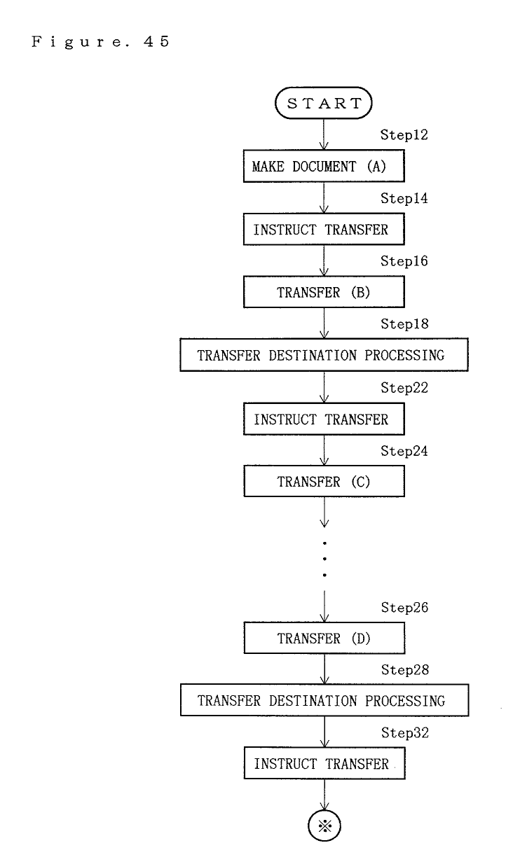

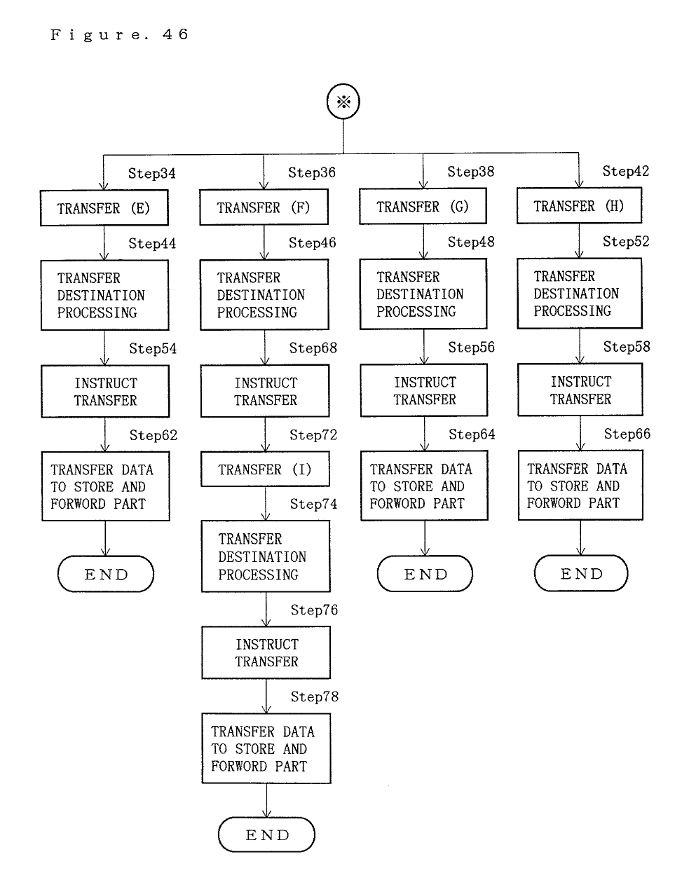

The manner in which document data is transferred in the document transfer system according to this embodiment will be described below concretely. FIG. 43 shows an example of an order for transmitting a document. FIG. 43 shows the case in which a document is circulated to a plurality of system users A through I in a certain section X and then transferred to system users of other section Y. FIG. 44 is a diagram showing an example of the transfer destination description table used in the case of FIG. 43. FIGS. 45 and 46 are flowcharts to which reference will be made in explaining the manner in which the document data is transferred in the section X.

In this case, there is prepared in advance the transfer destination description table shown in FIG. 44. For example, as shown in FIG. 44, when a system user who transmits document data is A and the content of the document is a, a system user B is designated as a system user to which document data is transferred. When a system user who transmits document data is D, the content of the document is a and an attached material β is added to the document, four system users E, F, G, H are designated as the system user to which document data is transferred. Also, when a system user who transmits document data is E, the content of the document is a and the attached material β is added to the document, the server 820, which serves as a store and forward unit, is designated as the transfer destination.

Initially, referring to FIG. 45, and following the start of operation, control goes to a step 12, whereat the system user A of the section X creates a document by inputting his own ID NO. with his own computer terminal 810a. At the time the system user A creates the document, a document name is inputted. Then, the input work of the document is ended, and control goes to a step 14, whereat the system user A inputs a transfer command. Then, the server 820 extracts information concerning the document from the document data based on the document name, and also extracts information concerning the system user A from the document data based on the ID No. Then, control goes to a step 16, whereat the server 820 determines based on the transfer destination description table memorized in the memory part 830 that the next system user to which document data is transferred is the system user B, and transfers the document data to the system user B via the computer network. Control goes to the next step 18, whereat the system user B enters his own ID No. from his own computer terminal 810b, displays the transferred document on the screen of the computer terminal 810b, and processes the displayed document in a predetermined manner. Then, when the system user B inputs a transfer command at a step 22, the server 820 extracts information concerning the document and information concerning the system user B from the document data. In the next step 24, the server 820 transfers the document data to the system user C which is determined based on the transfer destination description table. Then, control goes to the next step 26, whereat the system user C processes the document data similarly, and the document data is transferred to the system user D in accordance with the transfer destination description table.

Then, control goes to the next step 28, whereat let it be assumed that the system user D watches the transferred document, and adds the attached material to the transferred document. When the transfer command is inputted from the system user D at a step 32, the server 820 checks the inputted document data, and determines that the attached material is added to the document data. Then, the server 820 extracts information concerning the document from the document data based on the attached material name and the document name, and also extracts information concerning the system user D based on the ID No. from the document data. Thereafter, the server 820 determines based on the transfer destination description table that the system users of the transfer destination are the system users E, F, G and H, and transfers document data to the system users E, F, G and Hat steps 34, 36, 38, 42 shown in FIG. 46. Then the system users E, F, G and H process the document data respectively at steps 44, 46, 48 and 52. If the transfer commands are inputted at step 54, 56 and 58, then the document data processed by the system users E, G, H are transmitted to the server 820 serving as the store and forward unit in accordance with the transfer destination description table at steps 62, 64 and 66. On the other hand, if the transfer command is inputted at a step 68, then the document data processed by the system user F is transferred to a system user I in accordance with the transfer destination description table at a step 72. Thereafter, control goes to a step 74, whereat the system user I processes the document data. Then, when the transfer command is inputted at a step 76, control goes to the next step 78, whereat the document data is transferred to the server 820 serving as the store and forward unit in accordance with the transfer destination description table. In this manner, even when one document data is branched and transferred to a plurality of system users, these documents data are finally gathered to the server 820. The server 820 gathers these documents data into one data, and this data becomes a final document circulated within the section X.

Thereafter, the server 820 transfers the gathered one data to a system user J in other section Y in accordance with the transfer description table. Then, the document data is transferred from a system user K to system users L, Min accordance with the transfer destination description table.

When the system user B in the section X, for example, is transferred to other section due to personnel transfers or the like, of the transfer destination description table shown in FIG. 44, only the portion relating to the system user B is changed. In this case, on the transfer destination table shown in FIG. 44, the system user of the transfer destination written in the portion of the first line is changed to the system user C, and the portion of the second line is deleted.

The document transfer system according to this embodiment includes the transfer destination description table, and the server determines a system user of a proper transfer destination with reference to this transfer destination description table each time document data is transferred. Thus, even when updated document data has to be sent to a system user different from the system user to which document data should be sent after the document data transmitted from a certain system user was updated, if such situation is previously described in the transfer destination description table, the document transfer system according to this embodiment can cope with such situation with flexibility. Further, since the server has a store and forward function to gather document data, which are branched and transferred to a plurality of system users within different sections, into one data to thereby transfer the one data to a system user of the next section when document data is transferred among the different sections, document updated in all routes through which the document has been so far passed among the different sections can be reliably transmitted to the next section. Therefore, it becomes possible to reliably transmit a document, and also a transmission efficiency can be improved. Furthermore, when a system user in a certain section is changed due to personnel transfers or the like, only the portion concerning that section in the transfer destination description table is changed, and the portions concerning other sections need not be changed. There is then the advantage that the transfer destination description table can be set again with small labor.

As set forth above, according to this embodiment, it is possible to provide the document transfer system including the transfer destination description table and the transfer control means and in which each time a document is transferred, the transfer control means determines a proper transfer destination with reference to this transfer destination description table. Thus, even when the updated document has to be transmitted to the different system user unlike the ordinary route after the document transmitted from a certain system user was updated, if such situation is previously written in the transfer destination description table, then the document transfer system according to this embodiment can cope with such situation with flexibility.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A workflow system having a network connected with a plurality of computer terminals and in which a work processing is executed by transferring data among a plurality of system users in a plurality of sections through said network, comprising:
main workflow defining means for defining a main workflow which determines sections for executing a work processing;
sub-workflow defining means for defining a sub-workflow which determines a flow of work processing within a section with respect to the section for executing the work processing defined by said main workflow;
memory means for memorizing said main workflow and said sub-workflow;
section management means for transferring said data among said system users in accordance with said sub-workflow;
sub-workflow interface parts disposed at each said section and having a definition of a correspondence of sub-workflow used in response to said data; and
entire management means for transferring said data between said sub-workflow interface parts in accordance with said main workflow, wherein a sub-workflow is activated when said sub-workflow interface part receives said data.

2. A workflow processing method having a network connected with a plurality of computer terminals and in which a work processing is executed by transferring data among a plurality of system users in a plurality of sections through said network, comprising:
main workflow defining means for defining a main workflow which determines sections for executing a work processing;
sub-workflow defining means for defining a sub-workflow which determines a flow of work processing within a section with respect to the section for executing the work processing defined by said workflow;
section management means for transferring said data in accordance with said sub-workflow; and
sub-workflow interface parts disposed at each said section and having a work processing identifier and data/object pointer, wherein when a processing of said sub-workflow is ended, said work processing identifier and data/object pointer are transferred to said sub-workflow interface parts to thereby activate the next sub-workflow.

3. A workflow processing method as claimed in claim 2, wherein said activation is an activation of said sub-workflow made or selected by a system user who is informed of an end of a processing of said sub-work flow.

4. A workflow processing method as claimed in claim 2, wherein said sub-workflow interface parts further include sub-workflow status information, an end of a processing of said sub-workflow is recorded on said status information, and it is determined based on said recorded status information whether or not a processing of said sub-workflow is ended.

5. A workflow system having a network connected with a plurality of computer terminals and in which a work processing is executed by transferring data among a plurality of system users in a plurality of sections through said network, comprising:
main workflow define means for defining a main workflow which determines sections through which a work processing is executed;
sub-workflow define means for defining a sub-workflow which determines a flow of a work processing within said section with respect to the section for executing the work processing defined by said main workflow; and
a sub-workflow interface part having a definition of a correspondence between a sub-workflow used in said section and a sub-workflow of the next section according to said data.

6. A computer-readable storage medium, said storage medium being configured by storage of a program to realize a workflow system in which a work processing is executed by transferring data among a plurality of system users via a network to which a plurality of computer terminals are connected, and to direct one of the user terminals to
define a main workflow which determines sections to execute a work processing with respect to said data;
define a sub-workflow which determines a flow of a work processing within said section with respect to the section to execute a work processing defined by said main workflow; and
define a correspondence between a sub-workflow used in said section and a sub-workflow used in the next section according to said data.

7. A computer-readable storage medium, said storage medium being configured by storage of a program to realize a workflow system in which a work processing is executed by transferring data among a plurality of system users via a network to which a plurality of computer terminals are connected, and to direct one of the user terminals to
define a main workflow which determines sections to execute a work processing with respect to said data;
define a sub-workflow which determines a flow of a work processing within said section with respect to a section to execute a work processing defined by said main workflow;
transfer said data between said system users in accordance with said sub-workflow; and
transfer said data between said sections in accordance with said main workflow, and activate the next sub-workflow when a processing of said sub-workflow is ended.

8. A workflow system having a network connected with a plurality of computer terminals and in which a work processing is executed by transferring data among a plurality of system users through said network, comprising:
selecting means capable of selecting the next system user to receive said data from each system user from a plurality of selection items displayed on a screen; and
management means for transferring said data to a system user corresponding to the contents of said selected selection item when said selection item is selected by said selecting means, and transferring said data to a predetermined system user in accordance with said workflow when said selection means is not used.

9. A workflow system as claimed in claim 8, wherein said selection items include a reject processing item for returning data to a system user who transmitted said data, a skip processing item for transferring said data to a system user placed forward or backward by two or more system users in the processing order determined by said workflow, and a branch processing item for transferring data to a plurality of system users.

10. A workflow system as claimed in claim 9, wherein a list of system users to whom said data can be transferred is displayed on said screen based on said workflow when said skip processing item or said branch processing item is selected, and said management means transfers said data to a selected system user when a predetermined system user is selected from said list.

11. A workflow system as claimed in claim 8, wherein said selection items include a transfer processing item for transferring a right for executing a work processing to other system users, a list of all system users is displayed on said screen when said transfer processing item is selected, and said management means transfers said data to a selected system user when a predetermined system user is selected from said list.

12. A workflow system as claimed in claim 8, wherein said selection items include a stop processing item for stopping a work processing, and said management means informs all system users for executing said work processing of a stoppage of a work processing in accordance with said workflow.

13. A computer-readable storage medium, said storage medium being configured by storage of a program to realize a workflow system in which a work processing is executed by transferring data among a plurality of system users via a network to which a plurality of computer terminals are connected in accordance with a workflow which determines a work flow, and to direct one of the user terminals to
select a desired selection item from a plurality of selection items displayed on a screen so that the next system user to which each system user transfers said data is selected; and
transfer said data to a system user corresponding to the contents of said desired selection item when said desired selection item is selected, and transfer said data to a predetermined system user in accordance with said workflow when said desired selection item is not selected.

14. A workflow system having a network connected with a plurality of computer terminals, workflow defining means for defining a flow of a work processing, and first memory means for memorizing said workflow and in which a work processing is executed by transferring data among a plurality of system users through said network, comprising:
second memory means for storing extraneous data transmitted thereto from the outside;
detecting means for generating a detection signal by detecting that said extraneous data is stored in said second memory means; and
management means for executing said workflow by reading out said workflow from said first memory means based on said extraneous data stored in said second memory means in response to said detection signal from said detecting means.

15. A workflow system as claimed in claim 14, wherein said extraneous data is image data, and said workflow system further includes converting means for converting said image data into text data.

16. A workflow system having a network connected with a plurality of computer terminals, workflow defining means for defining a flow of a work processing corresponding to job type information and first memory means for storing said workflow, and in which a work processing is executed by transferring data among a plurality of system users through said network, comprising:
second memory means for storing image data transmitted thereto from the outside;
judgment means for reading out job type information from said image data stored in said second memory means; and
management means for executing said workflow by reading out said workflow corresponding to said job type information judged by said judgment means from said first memory means.

17. A workflow system as claimed in claim 16, wherein said judgment means includes converting means which converts said image data memorized in said second memory means into text data.

18. A computer-readable storage medium, said storage medium being configured by storage of a program to realize a workflow system in which a work processing is executed by transferring data among a plurality of system users via a network to which a plurality of computer terminals are connected in accordance with a workflow which determines a work flow, and to direct one of the user terminals to
define and memorize a workflow which defines said work flow;
accumulate external data transmitted from the outside;
generate a detection signal by detecting that said external data is accumulated; and
execute said workflow based on said external data in response to said detection signal.

19. A workflow system having a network connected with a plurality of computer terminals, and in which a work processing is executed by transferring data among a plurality of system users via said network in accordance with a workflow which determines a work flow, comprising:
first memory means for memorizing document format data required according to the contents of a work processing at every work processing;
second memory means for memorizing a procedure defined in association with said document format data, said procedure being used to effect a predetermined processing on said data; and
management means for reading out said document format data corresponding to the contents of a work processing of the next system user and said procedure related to said document format in accordance with said workflow, processing said data in accordance with said procedure thus read out, and transferring data of processed result and said document format data thus read out to said next system user.

20. A workflow system as claimed in claim 19, wherein said procedure includes a procedure defined in association with a part of said document format data.

21. A computer-readable storage medium, said storage medium being configured by storage of a program to realize a workflow system in which a work processing is executed by transferring data among a plurality of system users via a network connected with a plurality of computer terminals in accordance with a workflow which determines a work flow, and to direct one of the user terminals to
memorize document format data required according to a work processing at every work processing, and memorize a predetermined procedure for effecting a predetermined processing on said data defined in association with said document format data; and
read out said document format data corresponding to the contents of a work processing of said next system user and said procedure related to said document format data when said data is transferred to the next system user in accordance with said workflow, process said data in accordance with said procedure, and transfer data of processed result and said document format data thus read out to said next system user.
